(19) United States
(12) Patent Application Publication
(10) Pub. No.: US 2026/0101220 A1
(43) Pub. Date: Apr. 9, 2026

(54) TRIGGERING AND ACTIVATION OF CSI MEASUREMENT REPORTING IN MOBILITY

(71) Applicant: Samsung Electronics Co., Ltd., Suwon-si (KR)

(72) Inventors: Dalin Zhu, Allen, TX (US); Shiyang Leng, Little Elm, TX (US); Anil Agiwal, McKinney, TX (US); Kyeongin Jeong, Frisco, TX (US); Eko Onggosanusi, Coppell, TX (US)

(21) Appl. No.: 19/337,859

(22) Filed: Sep. 23, 2025

Related U.S. Application Data
(60) Provisional application No. 63/705,336, filed on Oct. 9, 2024.
(60) Provisional application No. 63/706,533, filed on Oct. 11, 2024.

(51) Int. Cl. H04W 24/10; H04W 36/08; H04W 72/1268; H04W 74/0833

(52) U.S. Cl. CPC H04W 24/10; H04W 36/08; H04W 72/1268; H04W 74/0833

(57) ABSTRACT

Methods and apparatuses for triggering and activation of channel state information (CSI) measurement reporting in mobility. A method performed by a user equipment (UE) includes receiving information related to a candidate cell, receiving a cell switching command (CSC) medium access control (MAC) control element (CE) indicating the candidate cell, and determining, based on the information, whether channel state information (CSI) acquisition is enabled for the candidate cell. The method further includes, when CSI acquisition is enabled for the candidate cell, measuring one or more reference signal (RS) resources configured for the candidate cell, determining, based on the measurement, a CSI report for the candidate cell, and transmitting the CSI report in an uplink (UL) resource.

### CROSS-REFERENCE TO RELATED AND CLAIM OF PRIORITY

The present application claims priority under 35 U.S.C. § 119(e) to U.S. Provisional Patent Application No. 63/705,336 filed on Oct. 9, 2024 and U.S. Provisional Patent Application No. 63/706,533 filed on Oct. 11, 2024, which are hereby incorporated by reference in their entirety.

### TECHNICAL FIELD

The present disclosure relates generally to wireless communication systems and, more specifically, the present disclosure relates to methods and apparatuses for triggering and activation of channel state information (CSI) measurement reporting in mobility.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to triggering and activation of channel state information (CSI) measurement reporting in mobility.

In one embodiment, a user equipment (UE) is provided. The UE includes a transceiver configured to receive information related to a candidate cell and receive a cell switching command (CSC) medium access control (MAC) control element (CE) indicating the candidate cell. The UE further includes a processor operably coupled with the transceiver. The processor is configured to determine, based on the information, whether channel state information (CSI) acquisition is enabled for the candidate cell, when CSI acquisition is enabled for the candidate cell, measure one or more reference signal (RS) resources configured for the candidate cell, and determine, based on the measurement, a CSI report for the candidate cell. The transceiver is further configured to transmit the CSI report in an uplink (UL) resource.

In another embodiment, a base station (BS) is provided. The BS includes a processor and a transceiver operably coupled with the processor. The transceiver is configured to transmit information related to a candidate cell, transmit a CSC MAC CE indicating the candidate cell, and receive the CSI report in an UL resource. The information indicates whether CSI acquisition is enabled for the candidate cell. CSI acquisition is enabled for the candidate cell. The CSI report is based on one or more RS resources configured for the candidate cell.

In yet another embodiment, a method performed by a UE is provided. The method includes receiving information related to a candidate cell, receiving a CSC MAC CE indicating the candidate cell, and determining, based on the information, whether CSI acquisition is enabled for the candidate cell. The method further includes, when CSI acquisition is enabled for the candidate cell, measuring one or more RS resources configured for the candidate cell, determining, based on the measurement, a CSI report for the candidate cell, and transmitting the CSI report in an UL resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10 illustrates a flowchart of an example procedure for layer-1/layer-2 (L1/L2) triggered mobility (LTM) according to embodiments of the present disclosure;

FIG. 11 illustrates an example medium access control (MAC) control element (CE) that sub-selects aperiodic CSI trigger states for CSI measurement reporting in LTM according to embodiments of the present disclosure;

FIGS. 12A and 12B illustrate signal flows of an example procedure for LTM cell switch according to embodiments of the present disclosure;

FIGS. 13A and 13B illustrate signal flows of an example procedure for LTM cell switch according to embodiments of the present disclosure; and

FIG. 14 illustrates an example method performed by a UE in a wireless communication system according to embodiments of the present disclosure.

### DETAILED DESCRIPTION

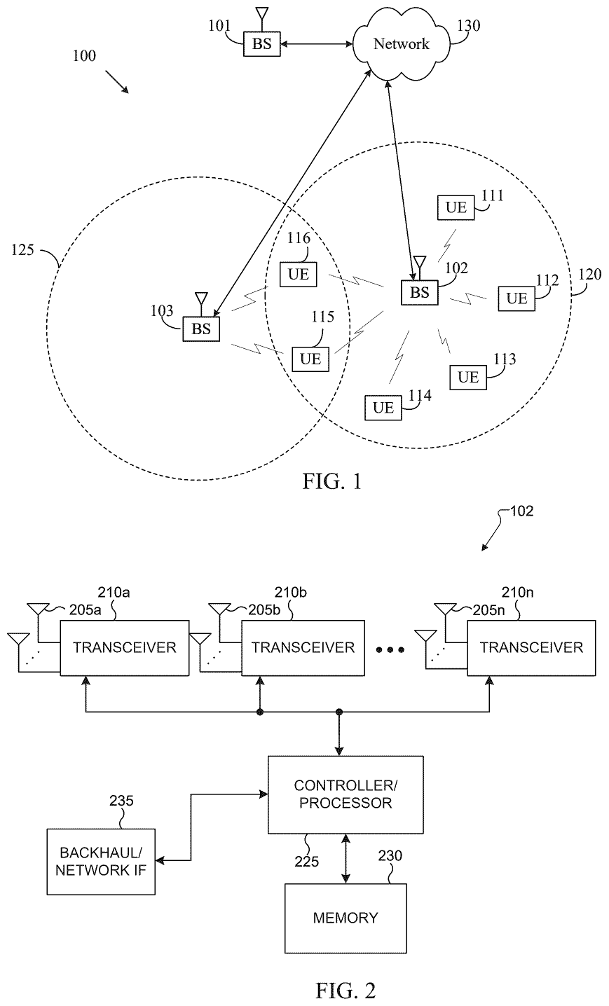

FIGS. 1-14, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for receiving or identifying the triggering and activation of CSI measurement reporting in mobility. In certain embodiments, one or more of the gNBs 101-103 include circuitry, programing, or a combination thereof to support triggering and activation of CSI measurement reporting in mobility.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting triggering and activation of CSI measurement reporting in mobility. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Hash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

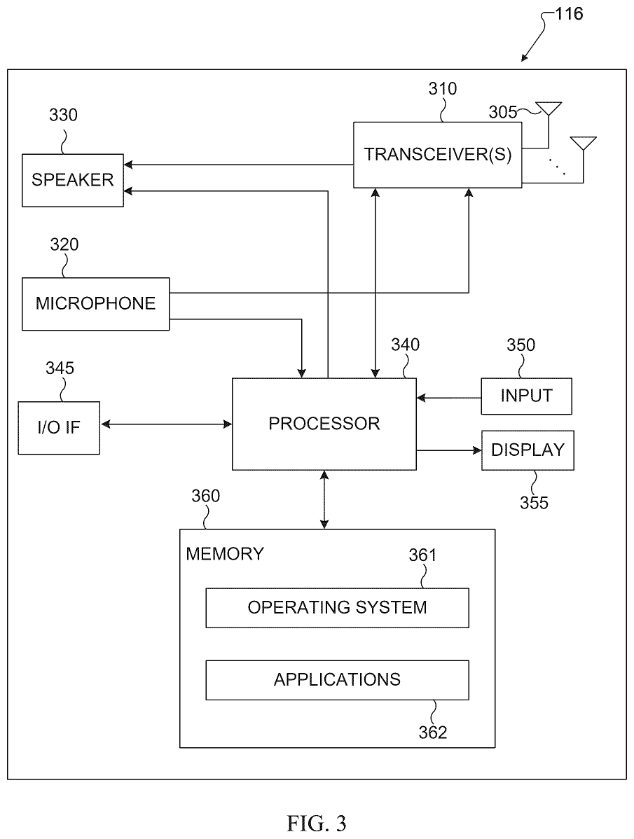

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320.

The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify triggering and activation of CSI measurement reporting in mobility as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

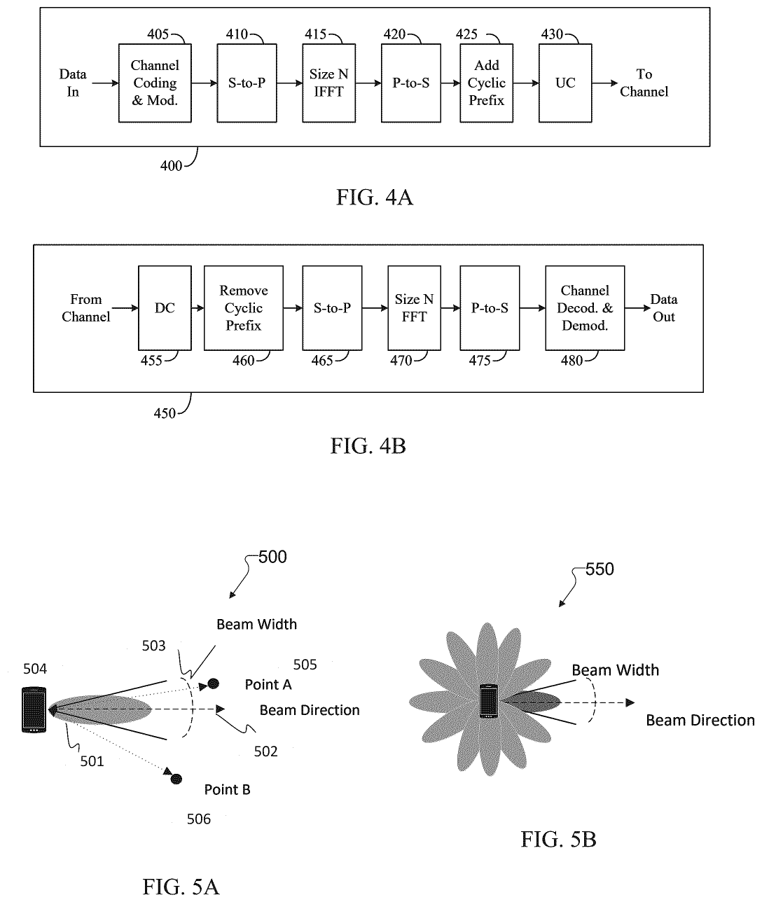

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured to perform actions for triggering and activation of CSI measurement reporting in mobility as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

In this disclosure, a beam is determined by either of;
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [[REF 4]—section 5.1.5]:

| | |
|---|---|
| - | Type A, {Doppler shift, Doppler spread, average delay, delay spread} |
| - | Type B, {Doppler shift, Doppler spread} |
| - | Type C, {Doppler shift, average delay} |
| - | Type D, {Spatial Rx parameter} |

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE (e.g., the UE 116) is indicated a TCI state by MAC CE when the CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

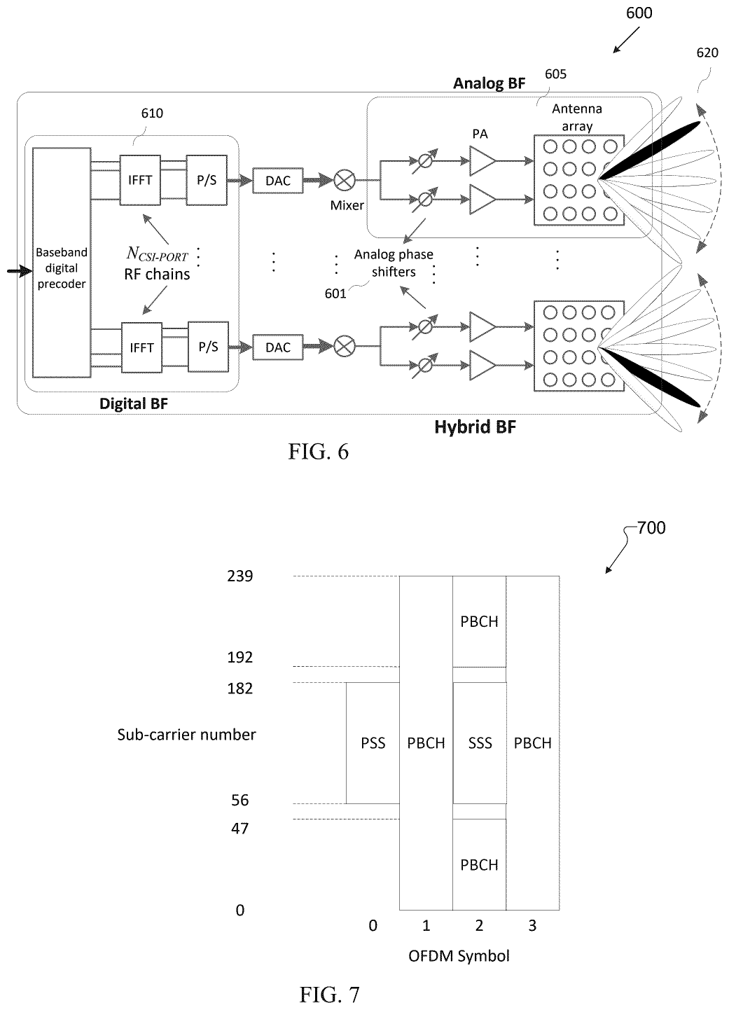

FIG. 7 illustrates an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 physical resource blocks (240 subcarriers), as illustrated in FIG. 7.

SSBs are organized in groups of N SSBs, transmitted within half a frame, each SSB within the group has an index i, where i=0, 1, . . . , N−1, within each group of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices transmitted are provided by ssb-PositionslnBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of physical resource blocks (PRBs)) and the resource allocated to an RO in the time domain (e.g., number of OFDMA symbols or number of slots), depend or the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1]v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8, 1/4, 1/2, 1, 2, 4, 8, 16}. When the number of SSBs per RO is less than 1, multiple ROs are associated with the same SSB index. SS/PBCH block indexes provided by ssb-PositionslnBurst in SIB1 or in ServingCellConfigCommon are mapped to valid PRACH occasions in the following order [[REF 3]v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

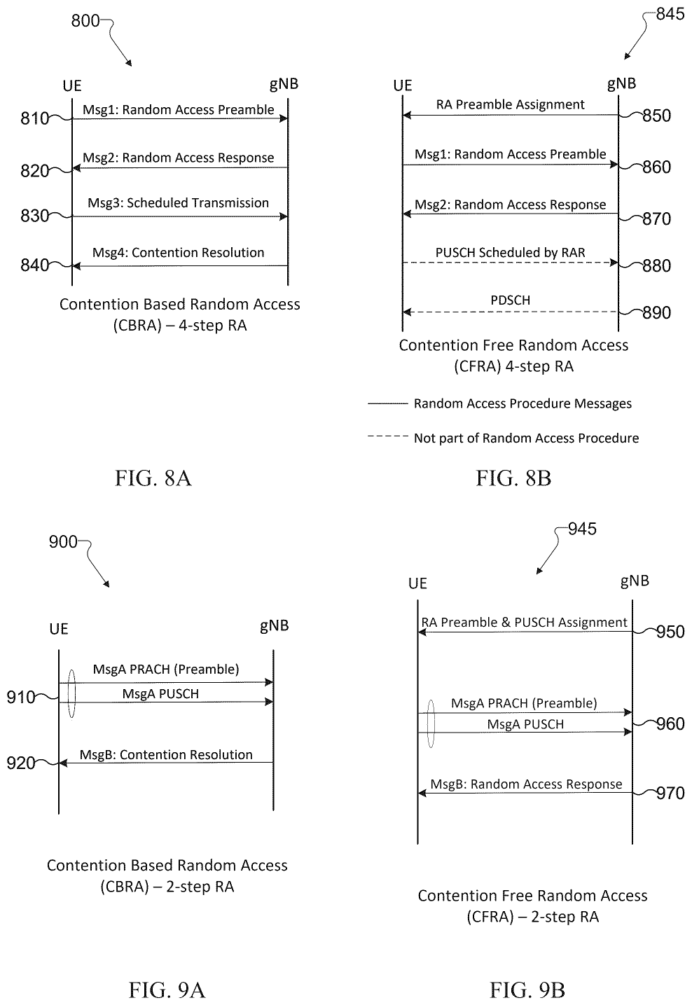

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIGS. 8A and 8B;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC reconfiguration complete message.
In step 4, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB.

In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Rel-16, introduced a new random access procedure; Type-2 random access procedure, also known as 2-step random access procedure (2-step RACH), is as illustrated in FIGS. 9A and 9B, that combines the preamble and PUSCH transmission into a single transmission from the UE to the gNB (e.g., the BS 102), which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with a reference signal received power (RSRP) that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with cyclic redundancy check (CRC) scrambled by a corresponding random access radio network temporary identifier (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a cell RNTI (C-RNTI), the UE attempts to detect a DCI format 1_0 with CRC scrambled by a corresponding temporary cell RNTI (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Channel state information reference signal is a downlink reference signal that is used for obtaining the downlink channel condition between the gNB and the UE. CSI-RS can be transmitted independent of data transmissions on the downlink. The CSI-RS usage can be CSI-RS of beam management, CSI-RS for tracking, CSI-RS for CSI and etc.

In NR, CSI-RS resources including SSB(s) and/or nonzero power (NZP) CSI-RS resource(s) are configured by the network for example as part of RRC setup or RRC reconfiguration. CSI-RS resources are configured in a CSI resource set provided/configured in a CSI resource setting, which could also be linked/associated/specific to a CSI reporting setting. The configuration of the CSI-RS resource includes at least the following: (1) information related to the time-frequency resource mapping of the CSI-RS resource, (2) information related to resource type of the CSI-RS resource including ‘periodic’, ‘aperiodic’, and ‘semi-persistent’, (3) information related to usage of the CSI-RS resource (e.g., for beam management, tracking, CSI and etc.), (4) information related to transmit power control parameter(s)/setting(s), (5) scrambling ID, and (7) information related to the TCI state.

This disclosure provides early triggering of CSI measurement/reporting for layer-1/layer-2 (L1/L2) triggered mobility (LTM). Early CSI measurement/reporting can assist in determining the channel conditions and better link adaptation and better precoding for downlink and uplink transmissions.

In NR, CSI-RS resources including SSB(s) and/or NZP CSI-RS resource(s) are configured by the network for example as part of RRC setup or RRC reconfiguration. CSI-RS resources are configured in a CSI resource set provided/configured in a CSI resource setting, which could also be linked/associated/specific to a CSI reporting setting. The configuration of the CSI-RS resource includes at least the following: (1) information related to the time-frequency resource mapping of the CSI-RS resource, (2) information related to resource type of the CSI-RS resource including ‘periodic’, ‘aperiodic’, and ‘semi-persistent’, (3) information related to usage of the CSI-RS resource (e.g., for beam management, tracking, CSI and etc.), (4) information related to transmit power control parameter(s)/setting(s), (5) scrambling ID, and (7) information related to the TCI state. Embodiments of the present disclosure recognize that CSI acquisition for layer-1/layer-2 (L1/L2) triggered mobility (LTM) needs to be specified.

This disclosure provides triggering of CSI measurement/reporting for layer-1/layer-2 (L1/L2) triggered mobility (LTM). Trigger of CSI measurement/reporting can assist in determining the channel conditions and better link adaptation and better precoding for downlink and uplink transmissions.

Throughout the present disclosure, aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings. Furthermore, both frequency division duplexing (FDD) and time division duplexing (TDD) are regarded as a duplex method for DL and UL signaling.

Although exemplary descriptions and embodiments to follow provide orthogonal frequency division multiplexing (OFDM) or orthogonal frequency division multiple access (OFDMA), this disclosure can be extended to other OFDM-based transmission waveforms or multiple access schemes such as filtered OFDM (F-OFDM). This disclosure provides several components that can be used in conjunction or in combination with one another, or can operate as standalone schemes.

In the present disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE or (3) UE-group RRC signaling. In addition, MAC CE signaling can be UE-specific e.g., to one UE and can be UE common (e.g., to a group of UEs). MAC CE signaling can be DL MAC CE signaling or UL MAC CE signaling. Furthermore, L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE and can be UE common (e.g., to a group of UEs).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used. A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-signal-to-interference-plus-noise ratio (SINR) accompanied by at least one CSI-RS resource indicator (CRI) or SSB resource indicator (SSBRI)). As the NW/gNB (e.g., the network 130/the BS 102) receives the beam report, the NW can be better equipped with information to assign a particular DL (and/or UL) TX beam to the UE. Optionally or alternatively, the source RS can be transmitted by the UE (e.g., the UE 116) (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In the present disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). Furthermore, a higher layer message (e.g., SIB-based or RRC-based or MAC CE-based) can be carried by a physical downlink shared channel (PDSCH). In one example, the PDSCH can be scheduled by a DCI format.

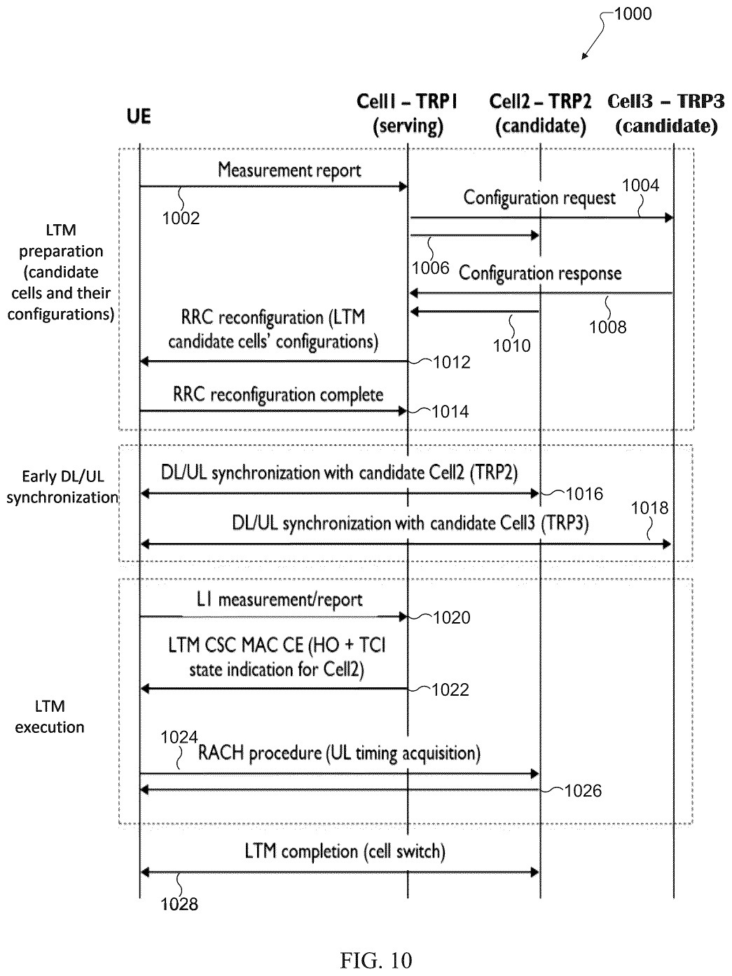

FIG. 10 illustrates a flowchart of an example procedure 1000 for LTM according to embodiments of the present disclosure. For example, procedure 1000 can be performed by the UE 116, the gNB 101 and/or the network 130, the gNB 102 and/or network 130, and the gNB 103 and/or the network 130 in the wireless network 100 of FIG. 1. For another example, procedure 1000 can be performed within the coverage area 120 of the gNB 102 and the coverage area 125 of the gNB 103 in the wireless network 100 of FIG. 1. These examples are for illustration only and other embodiments can be used without departing from the scope of the present disclosure.

The procedure begins in 1002, a UE transmits a measurement report to a (serving) Cell1/TRP1. In 1004, the (serving) Cell1/TRP1 transmits a configuration request to Cell3/TRP3. In 1006, the (serving) Cell1/TRP1 transmits a configuration request to a (candidate) Cell2/TRP2. In 1008, the Cell3/TRP3 transmits a configuration response to the (serving) Cell1/TRP1. In 1010, the (candidate) Cell2/TRP2 transmits a configuration response to the (serving) Cell1/TRP1. In 1012, the (serving) Cell1/TRP1 transmits a RRC reconfiguration (LTM candidate cells' configurations) to the UE. In 1014, the UE transmits a RRC reconfiguration complete to the (serving) Cell1/TRP1. In 1016, the UE performs DL/UL synchronization with (candidate) Cell2/TRP2. In 1018, the UE performs DL/UL synchronization with (candidate) Cell3/TRP3. In 1020, the UE transmits L1 measurement(s)/report to the (serving) Cell1/TRP1. In 1022, the (serving) Cell1/TRP1 transmits LTM cell switch command (CSC) MAC CE (HO+TCI state indication for Cell2) to the UE. In 1024, the UE transmits a RACH procedure(s) (UL timing acquisition) to (candidate) Cell2/TRP2. In 1026, the (candidate) Cell2/TRP2 transmits a RACH procedure(s) (UL timing acquisition) to the UE. In 1028, the UE and the (candidate) Cell2/TRP2 perform LTM completion (cell switch).

| | | |
|---|---|---|
| LTM-Candidate-r18 ::= | SEQUENCE { | |
| ltm-CandidateId-r18 | LTM-CandidateId-r18, | |
| ltm-CandidatePCI-r18 | PhysCellId | OPTIONAL, |
| | | --Need M |
| ltm-CsiAcquisition | ENUMERATED {true} | |
| OPTIONAL, --Need R | | |
| ... | | |
| } | | |

A UE could be first provided or configured by the network, e.g., via/in/by higher layer RRC signaling(s)/parameter(s) LTM-Config, LTM-Candidate, LTM-CSI-ReportConfig, LTM-CSI-ResourceConfig, LTM-TCI-Info and/or etc., a list/set/pool of one or more candidate cells or candidate cell IDs for LTM operation. The UE could determine or identify which of the one or more candidate cells/candidate cell IDs in the list/set/pool could be enabled or used for CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) according to or based on:
Fixed rule(s) in system specification(s) and/or per RRC (re-)configuration: for example, the candidate cell with the lowest (or highest) candidate cell ID among the configured/provided one or more candidate cells (candidate cell IDs) could be enabled or used for the CSI acquisition; for another example, the candidate cell (or candidate cell ID) corresponding to the first (or last) entry in/of the list/set/pool of the one or more candidate cells/candidate cell IDs could be enabled or used for acquiring or requesting CSI for the LTM operation (e.g., before and/or during and/or after the LTM cell switch)
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling. For example, the UE could be first provided or configured by the network, e.g., via/in/by higher layer RRC signaling(s)/parameter(s) LTM-Config, LTM-Candidate, LTM-CSI-ReportConfig, LTM-CSI-ResourceConfig, LTM-TCI-Info and/or etc., one or more indicators to indicate which of the one or more candidate cells/candidate cell IDs in the list/set/pool could be enabled or used for the CSI acquisition.
   In one example, the one or more indicators could indicate candidate cell ID(s); for this design example, the candidate cell(s) corresponding to the indicated candidate cell ID(s) could be enabled or used for acquiring and/or requesting CSI for the LTM operation (e.g., before and/or during and/or after the LTM cell switch).
   In another example, the one or more indicators could indicate index(es) of candidate cell(s)—e.g., among the configured or provided candidate cells/candidate cell IDs in the list/set/pool, and/or index(es) of entry(s) in/of the list/set/pool of candidate cell(s)/candidate cell ID(s); for this design example, the candidate cell(s) corresponding to the indicated index(es) of candidate cell(s) among the configured/provided candidate cell(s)/cell ID(s) in the list/set pool and/or entry(s) in/of the list/set/pool of candidate cell(s)/cell ID(s) could be enabled or used for acquiring and/or requesting CSI for the LTM operation (e.g., before and/or during and/or after the LTM cell switch). For instance, the one or more indicators could indicate a value/index k∈{0, . . . , Ncand−1} or {1, . . . , Ncand}, wherein Ncand is the number of configured/provided candidate cell(s)/cell ID(s) in the list/set/pool; in this case, the candidate cell (or candidate cell ID) corresponding to the k-th entry in/of the list/set/pool of the one or more candidate cells/candidate cell IDs could be enabled or used for acquiring or requesting CSI for the LTM operation (e.g., before and/or during and/or after the LTM cell switch).
   In another example, the one or more indicators could correspond to one or more one-bit flag indicators each associated to a candidate cell/candidate cell ID provided or configured in the list/set/pool. When/if a one-bit flag indicator is set to ‘1’ (or ‘0’) or ‘true’ (or ‘false’), the candidate cell/candidate cell ID associated to the one-bit flag indication, among the candidate cell(s)/candidate cell ID(s) in the list/set/pool, could be enabled or used for acquiring or requesting CSI for the LTM operation (e.g., before and/or during and/or after the LTM cell switch).
   In another example, the one or more indicators could correspond to a bitmap, e.g., having a/the same size/length as that of the list/set/pool of candidate cell(s)/candidate cell ID(s), or the number of entry(s)/bit position(s) in the bitmap could be the same as that of the candidate cell(s)/candidate cell ID(s) provided/configured in the list/set/pool. For this design example, each of the entry(s)/bit position(s) in the bitmap is mapped to a candidate cell/candidate cell ID provided/configured in the list/set/pool according to the order of the associated positions of the candidate cell(s)/candidate cell ID(s) in the list/set/pool with first entry/bit position of the bitmap mapped to the candidate cell/candidate cell ID in the first position of the candidate cell(s)/candidate cell ID(s) in the list/set/pool or the first entry in/of the list/set/pool of candidate cell(s)/candidate cell ID(s). In this case, when/if an entry/bit position of the bitmap is set to ‘1’ (or ‘0’) or ‘true’ (or ‘false’), the candidate cell (or candidate cell ID) in the list/set/pool of candidate cell(s)/candidate cell ID(s) corresponding to the entry/bit position could be enabled or used for acquiring or requesting CSI for the LTM operation (e.g., before and/or during and/or after the LTM cell switch).

The described/specified design examples herein could be applied to when the one or more indicators and the list/set/pool of candidate cell(s)/candidate cell ID(s)—e.g., provided by ltm-CandidateToAddModList-r18′—are provided or configured in a/the same higher layer RRC signaling/parameter e.g. LTM-Config common for candidate cell(s)/candidate cell ID(s). Alternatively, or optionally, the one or more indicators could be provided or configured in the higher layer RRC signaling(s)/parameter(s) that is specific to or dedicated for a particular or given candidate cell, e.g., LTM-Candidate and/or LTM-CandidateConfig. In this case, the one or more indicators could correspond to a one-bit flag indicator, e.g., provided by ltm-CsiAcquisition as in LTM-Candidate-r18 as shown in the present disclosure. When/if the one-bit flag indicator, e.g., ltm-CsiAcquisition provided or configured in LTM-Candidate and/or LTM-CandidateConfig, is set to ‘1’ (or ‘0’) or ‘true’ (or ‘false’), the corresponding candidate cell/candidate cell ID, e.g., provided by or associated/specific to the same LTM-Candidate and/or LTM-CandidateConfig, could be enabled or used for acquiring or requesting CSI for the LTM operation (e.g., before and/or during the LTM cell switch).
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

The one or more candidate cells/candidate cell IDs—determine or identified in/from the list/set/pool of configured candidate cells/candidate cell IDs—enabled or used for CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) according to or following those specified herein in the present disclosure could be denoted by or referred to as a subset of candidate cell(s)/candidate cell ID(s) in LTM operation(s) for CSI acquisition, e.g., before and/or during and/or after the LTM cell switch.

A UE (e.g., the UE 116) could receive from the network, in a cell switch command or cell switch MAC CE command or LTM cell switch command (CSC) MAC CE, at least a TCI state (e.g., a joint or DL or UL TCI state) and/or other necessary information/setting(s) indicated for a target cell. After the LTM cell switch or when the LTM cell switch is complete or upon completion of the LTM cell switch, the UE could switch or could be switched from the current serving cell to the target cell for downlink and/or uplink communications. Here, the target cell could be from the list/set/pool of configured candidate cells or the subset of candidate cell(s) in LTM operation(s) for CSI acquisition as specified/defined herein in the present disclosure. That is, the ID/index of the target cell associated or linked or specific or corresponding to the LTM CSC MAC CE (e.g., provided or indicated therein) could be selected or determined or identified or indicated or provided from the list/set/pool of configured candidate cell IDs or the subset of candidate cell ID(s) in LTM operation(s) for CSI acquisition as specified/defined herein in the present disclosure. That is, the bitwidth of the target cell ID here could be determined as ┌log₂(C+1)┐ or ┌log₂(C)┐ (bits), where C is the number of candidate cells in the list/set/pool of configured candidate cells/candidate cell IDs and/or in a/the subset of candidate cell(s)/candidate cell ID(s) for CSI acquisition in LTM operation(s) as specified/defined herein in the present disclosure.

In one example, a UE could receive from the network, in the cell switch command or cell switch MAC CE command or LTM cell switch command (CSC) MAC CE, a x-bit CSI request field/indicator, wherein x=0, 1, 2, 3, 4, 5, 6, . . . , and x could be less than or equal to x_max. For this design example, the UE could be provided or indicated by the network, e.g., via higher layer RRC signaling(s)/parameter(s) e.g. in/by LTM-Config, LTM-Candidate, LTM-CSI-ReportConfig, LTM-CSI-ResourceConfig, LTM-TCI-Info and/or etc., whether or not the x-bit CSI request field/indication is present in the LTM cell switch command MAC CE. For instance, when/if a higher layer parameter csiRequestInCSC is provided/configured, e.g., in LTM-Config, LTM-Candidate, LTM-CSI-ReportConfig, LTM-CSI-ResourceConfig, LTM-TCI-Info and/or etc., and/or is set to ‘enabled’, the UE could expect to receive in the LTM cell switch command MAC CE, e.g., for the corresponding candidate cell(s)/cell ID(s)—i.e. the target cell/target cell ID, the x-bit CSI request field with valid value(s), i.e., x would be greater than or equal to 1. Otherwise, i.e., when/if the higher layer parameter csiRequestInCSC is not present or provided/configured and/or is absent, e.g., in LTM-Config, LTM-Candidate, LTM-CSI-ReportConfig, LTM-CSI-ResourceConfig, LTM-TCI-Info and/or etc., and/or is present or provided/configured, e.g., in LTM-Config, LTM-Candidate, LTM-CSI-ReportConfig, LTM-CSI-ResourceConfig, LTM-TCI-Info and/or etc., and is set to ‘disabled’, the UE may not expect to receive in the LTM cell switch command MAC CE, e.g., for the corresponding candidate cell(s)/cell ID(s)—i.e. the target cell/target cell ID, a CSI request field with valid value(s), and/or the UE could expect that the CSI request field, if indicated or provided in the LTM CSC MAC CE for the corresponding candidate cell(s)/cell ID(s), is a 0-bit field, i.e., x=0, and/or the UE could expect that the CSI request field, if indicated or provided in the LTM CSC MAC CE for the corresponding candidate cell(s)/cell ID(s)—i.e., the target cell/target cell ID, has value 0 or zero value. In this case, when/if the UE does not receive in the LTM CSC MAC CE any CSI request field(s), and/or the UE receives in the LTM CSC MAC CE a 0-bit CSI request field and/or a zero-valued CSI request field, the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding candidate cell(s)/cell ID(s)—i.e. the target cell/target cell ID. The UE could determine or identify the value(s) of x and/or x_max according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's. For this design example, a trigger state could be initiated using the non-zero CSI request field in the CSC MAC CE command, and when the bits/codepoints of the CSI request field in the CSC MAC CE command are set to zero(s), no CSI for LTM operation (e.g., before and/or during and/or after the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding candidate cell(s)/cell ID(s)—i.e. the target cell or target cell ID. Alternatively or optionally, when/if the UE is not configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's, no CSI for LTM operation (e.g., before and/or during and/or after the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding candidate cell(s)/cell ID(s)—i.e. the target cell/target cell ID.

In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of 2^{M}^{_{TS}}−1 trigger states provided by CSI-AperiodicTriggerStateList each associated to one or more CSI-ReportConfig's and/or one or more LTM-CSI-ReportConfig's. For this design example, when/if a non-zero CSI request field is provided or indicated in a CSC MAC CE command, a trigger state could be initiated using the non-zero CSI request field in the CSC MAC CE command, and the CSI request field in the CSC MAC CE command can directly indicate the trigger state, e.g., out of the 2^{M}^{_{TS}}−1 configured/provided trigger states in the CSI-AperiodicTriggerStateList. That is, in this case, the number of bits of/in the CSI request field (i.e., the x-bit CSI request field in the LTM CSC MAC CE command as specified/defined herein in the present disclosure) is x=M_{TS}. The UE could determine or identify the value(s) of M_{TS} according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of M_{TS} trigger states provided by CSI-AperiodicTriggerStateList each associated to one or more CSI-ReportConfig's and/or one or more LTM-CSI-ReportConfig's. For this design example, when/if a non-zero CSI request field is provided or indicated in a CSC MAC CE command, a trigger state could be initiated using the non-zero CSI request field in the CSC MAC CE command. For this design example,
When the number of configured (CSI) trigger states in CSI-AperiodicTriggerStateList is greater than or equal to 2^{N}^{_{TS}}−1 (i.e., M_{TS}>2^{N}^{_{TS}}−1), where N_{TS} is the number of bits of/in the CSI request field, i.e., x=N_{TS} for the x-bit CSI request field in the LTM CSC MAC CE command as specified/defined herein in the present disclosure, the UE could receive a sub-selection MAC CE command/indication, used to map up to 2^{N}^{_{TS}}−1 trigger states to the bits/codepoints of the CSI request field in the LTM CSC MAC CE command. Here, N_{TS} could be provided or configured by a higher layer parameter reportTriggerSize where e.g. N_{TS}∈{0, 1, 2, 3, 4, 5, 6} or N_{TS}∈{1, 2, 3, 4, 5, 6} or N_{TS}∈{0, . . . , x_max} or N_{TS}∈{1, . . . , x_max}. When the UE would transmit a PUCCH with HARQ-ACK information in slot n corresponding to the PDSCH carrying the sub-selection MAC CE command/indication, UE assumption on the mapping of the selected CSI trigger state(s) to the codepoint(s)/bit(s) of the CSI request field in the LTM CSC MAC CE command according to or following those specified herein in the present disclosure could be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where μ is the subcarrier spacing (SCS) configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided.
When the number of configured (CSI) trigger states in CSI-AperiodicTriggerStateList is less than or equal to 2^{N}^{_{TS}}−1 (i.e., M_{TS}≤2^{N}^{_{TS}}−1), where N_{TS} is the number of bits of/in the CSI request field, i.e., x=N_{TS} for the x-bit CSI request field in the LTM CSC MAC CE command as specified/defined herein in the present disclosure, the CSI request field in the CSC MAC CE command can directly indicate the trigger state, e.g., out of the M_{TS} configured/provided trigger states in the CSI-AperiodicTriggerStateList.

In one example, a trigger state is initiated using the CSI request field in DCI.
When the bits/codepoints of CSI request field in DCI are set to zero, no CSI is requested.
When the number of configured (CSI) trigger states in CSI-AperiodicTriggerStateList is greater than or equal to 2^{N}^{_{TS}}−1, where N_{TS} is the number of bits of/in the DCI CSI request field, the UE could receive a sub-selection MAC CE command/indication, used to map up to 2^{N}^{_{TS}}−1 trigger states to the bits/codepoints of the CSI request field in the DCI. Here, N_{TS} could be provided or configured by a higher layer parameter reportTriggerSize where N_{TS}∈{1, 2, 3, 4, 5, 6}. When the UE would transmit a PUCCH with HARQ-ACK information in slot n corresponding to the PDSCH carrying the sub-selection MAC CE command/indication, the corresponding action in [10, [REF 5]] and UE assumption on the mapping of the selected CSI trigger state(s) to the codepoint(s)/bit(s) of the CSI request field in the DCI according to or following those specified herein in the present disclosure could be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided.
When the number of configured (CSI) trigger states in CSI-AperiodicTriggerStateList is less than or equal to 2^{N}^{_{TS}}−1, where N_{TS} is the number of bits of/in the CSI request field, the CSI request field in the DCI can directly indicate the trigger state.

The UE could be provided or configured or indicated by the network, e.g., via/by/in higher layer RRC signaling(s)/parameter(s) and/or MAC CE command(s) and/or dynamic DCI based L1 signaling(s) based on or according to a corresponding UE's capability or capability signaling, whether the LTM CSC MAC CE can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting, for/on the corresponding target cell.
For example, the UE could be configured or provided by the network, e.g., in LTM-Config, LTM-Candidate, LTM-CSI-ReportConfig, LTM-CSI-ResourceConfig, LTM-TCI-Info and/or etc., a higher layer parameter ltmMeasureReport. When/if the higher layer parameter ltmMeasureReport is provided, configured or present and/or set to ‘enabled’ and/or ‘measureOnly’, the UE could expect or assume that the LTM CSC MAC CE could activate/trigger only (SP/AP) CSI-RS(s) for measurement on the target cell/candidate cell(s); when/if the higher layer parameter ltmMeasureReport is provided, configured or present and/or set to ‘enabled’ and/or ‘reportOnly’, the UE could expect or assume that the LTM CSC MAC CE could activate/trigger only (SP/AP) CSI reporting on/for the target cell/candidate cell(s); and when/if the higher layer parameter ltmMeasureReport is provided, configured or present and/or set to ‘enabled’ and/or ‘bothMeasureReport’, the UE could expect or assume that the LTM CSC MAC CE could activate/trigger both (SP/AP) CSI-RS(s) for measurement on the target cell/candidate cell(s) and CSI reporting on/for the target cell/candidate cell(s). Optionally, when/if the higher layer parameter ltmMeasureReport is not provided or present or configured or is absent, or the higher layer parameter ltmMeasureReport is provided, configured or present but set to ‘disabled’, the UE could expect or assume that the LTM CSC MAC CE could activate/trigger (i) only (SP/AP) CSI-RS(s) for measurement on the target cell/candidate cell(s), (ii) only (SP/AP) CSI reporting on/for the target cell/candidate cell(s), or (iii) both (SP/AP) CSI-RS(s) for measurement on the target cell/candidate cell(s) and CSI reporting on/for the target cell/candidate cell(s), according to or based on (a) fixed value(s)/rule(s) in system specification(s) and/or per RRC (re-)configuration/setup, (b) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (c) UE's autonomous determination or selection, which could be further sent to the network via various UL channels/signals e.g. via/in part of beam/CSI report(s) and/or UE's capability signaling(s).
For another example, the LTM CSC MAC CE could comprise or provide or include or contain a one-bit indicator; in this case, when/if the one-bit indicator is set to ‘1’ (or ‘0’), (the UE could expect or assume that) the LTM CSC MAC CE could activate/trigger only (SP/AP) CSI-RS(s) for measurement on the target cell/candidate cell(s), otherwise, i.e., when/if the one-bit indicator is set to ‘0’ (‘1’), (the UE could assume or expect that) the LTM CSC MAC CE could activate/trigger both (SP/AP) CSI-RS(s) for measurement on the target cell/candidate cell(s) and CSI reporting on/for the target cell/candidate cell(s). Alternatively, when/if the one-bit indicator is set to ‘1’ (or ‘0’), (the UE could expect or assume that) the LTM CSC MAC CE could activate/trigger only (SP/AP) CSI reporting on/for the target cell/candidate cell(s), otherwise, i.e., when/if the one-bit indicator is set to ‘0’ (‘1’), (the UE could assume or expect that) the LTM CSC MAC CE could activate/trigger both (SP/AP) CSI-RS(s) for measurement on the target cell/candidate cell(s) and CSI reporting on/for the target cell/candidate cell(s). Optionally, when/if the one-bit indicator is set to ‘1’ (or ‘0’), (the UE could expect or assume that) the LTM CSC MAC CE could activate/trigger only (SP/AP) CSI-RS(s) for measurement on the target cell/candidate cell(s), otherwise, i.e., when/if the one-bit indicator is set to ‘0’ (‘1’), (the UE could assume or expect that) the LTM CSC MAC CE could activate/trigger only (SP/AP) CSI reporting on/for the target cell/candidate cell(s). Whether the one-bit indicator is present or not (absent) in the LTM CSC MAC CE could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one-bit indicator as specified/defined herein is present in the LTM CSC MAC CE; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one-bit indicator as specified/defined herein is not present or is absent in the LTM CSC MAC CE.
For another example, the LTM CSC MAC CE could comprise or provide or include or contain a two-bit indicator; in this case, when/if the two-bit indicator is set to ‘00’ (or ‘01’ or ‘10’ or ‘11’), (the UE could expect or assume that) the LTM CSC MAC CE could activate/trigger only (SP/AP) CSI-RS(s) for measurement on the target cell/candidate cell(s), when/if the two-bit indicator is set to ‘01’ (or ‘00’ or ‘10’ or ‘11’), (the UE could expect or assume that) the LTM CSC MAC CE could activate/trigger only (SP/AP) CSI reporting on/for the target cell/candidate cell(s), and when/if the two-bit indicator is set to ‘10’ (or ‘00’ or ‘01’ or ‘11’), (the UE could assume or expect that) the LTM CSC MAC CE could activate/trigger both (SP/AP) CSI-RS(s) for measurement on the target cell/candidate cell(s) and CSI reporting on/for the target cell/candidate cell(s). Whether the two-bit indicator is present or not (absent) in the LTM CSC MAC CE could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the two-bit indicator as specified/defined herein is present in the LTM CSC MAC CE; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the two-bit indicator as specified/defined herein is not present or is absent in the LTM CSC MAC CE.
For another example, when/if a LTM CSC MAC CE comprises a CSI request field according to or following those specified/defined herein in the present disclosure, and
   when/if the x-th codepoint of the CSI request field is indicated, (the UE could assume or expect that) the LTM CSC MAC CE could activate/trigger only (SP/AP) CSI-RS(s) for measurement on the target cell/candidate cell(s),
   when/if the y-th codepoint of the CSI request field is indicated, (the UE could assume or expect that) the LTM CSC MAC CE could activate/trigger only (SP/AP) CSI reporting on/for the target cell/candidate cell(s), and
   when/if the z-th codepoint of the CSI request field is indicated, (the UE could assume or expect that) the LTM CSC MAC CE could activate/trigger both (SP/AP) CSI-RS(s) for measurement on the target cell/candidate cell(s) and CSI reporting on/for the target cell/candidate cell(s).

In this case, the UE could determine or identify whether (some codepoint(s) of) the CSI request field can be used, applied or repurposed for indicating whether the LTM CSC MAC CE can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network (e.g., the network 130) via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).
For another example, take into account an existing field, e.g., used to indicate a TCI state for the target cell/candidate cell(s), in a LTM CSC MAC CE:
   when/if the x-th codepoint of the existing field is indicated, (the UE could assume or expect that) the LTM CSC MAC CE could activate/trigger only (SP/AP) CSI-RS(s) for measurement on the target cell/candidate cell(s),
   when/if the y-th codepoint of the existing field is indicated, (the UE could assume or expect that) the LTM CSC MAC CE could activate/trigger only (SP/AP) CSI reporting on/for the target cell/candidate cell(s), and
   when/if the z-th codepoint of the existing field is indicated, (the UE could assume or expect that) the LTM CSC MAC CE could activate/trigger both (SP/AP) CSI-RS(s) for measurement on the target cell/candidate cell(s) and CSI reporting on/for the target cell/candidate cell(s).

In this case, the UE could determine or identify whether (some codepoint(s) of) the existing field can be used, applied or repurposed for indicating whether the LTM CSC MAC CE can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).

In one example, when/if the LTM CSC MAC CE can trigger at least AP CSI-RS(s) for measurement on/for the corresponding target cell according to or following those specified herein in the present disclosure, and the LTM CSC MAC CE comprises a CSI request field according to or following those specified herein in the present disclosure,
the UE could first identify or determine a trigger state according to the indicated codepoint of the CSI request field, wherein the trigger state could be associated/specific/corresponding/linked to the corresponding target cell; e.g., the trigger state could be from the list of trigger state(s)—provided by CSI-AperiodicTriggerStateList—associated/corresponding/linked/specific to the target cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the target cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding target cell;
   Each of the identified or determined one or more CSI reporting settings/CSI report configurations associated to a reportConfigId could be associated or linked or corresponding to a resource set (e.g., a NZP CSI-RS resource set or a SSB resource set) index/ID;
   The resource set index/ID and the reportConfigId could be provided in a/the same higher layer RRC signaling/parameter, e.g., CSI-AssociatedReportConfigInfo/LTM-CSI-AssociatedReportConfigInfo;
   The resource set (e.g., the NZP CSI-RS resource set or the SSB resource set) and/or one or more RS resources (e.g., NZP CSI-RS resource(s) or SSB(s)) in the resource set could be associated/specific/corresponding/linked to the corresponding target cell;
the UE could identify or determine one or more CSI resource settings/CSI resource configurations—each provided by CSI-ResourceConfig or LTM-CSI-ResourceConfig—associated/specific/linked/corresponding to the identified or determined one or more CSI reporting settings/CSI report configurations, wherein the identified or determined one or more CSI resource settings/CSI resource configurations could be associated/specific/corresponding/linked to the corresponding target cell;
   The UE (e.g., the UE 116) could identify or determine a list of RS resource sets (e.g., a list of NZP CSI-RS resource set(s) or SSB resource set(s)) each comprising one or more RS resources including NZP CSI-RS resource(s) or SSB(s)—from or according to each of the identified or determined one or more CSI resource settings/CSI resource configurations;
   The identified or determined list or one or more RS resource sets in the list or one or more RS resources in one or more RS resource sets in the list could be associated/specific/corresponding/linked to the corresponding target cell;
for a CSI reporting setting/CSI report configuration associated/specific/corresponding/linked to the trigger state according to or following those specified herein in the present disclosure, the UE would identify or determine a resource set ID/index associated/specific/linked/corresponding to the CSI reporting setting/CSI reporting configuration according to or following those specified herein in the present disclosure, and a list of RS resource sets associated/specific/linked/corresponding to the CSI reporting setting/CSI reporting configuration according to or following those specified herein in the present disclosure. In this case, the resource set ID/index could point to an entry—hence, a measurement resource set—from/in the list of RS resource sets, wherein the measurement resource set could be or could correspond to a NZP CSI-RS resource set or a SSB resource set;
the UE could then measure the RS(s) including CSI-RS(s) corresponding to the RS resource(s) including NZP CSI-RS resource(s) in the measurement resource set on/for the target cell by assuming/applying a CSI-RS triggering offset X slot(s), wherein the X slot(s) could be specific to the measurement RS resource set. In particular, the aperiodic triggering offset X could be between the slot containing the LTM CSC MAC CE that triggers the measurement RS resource set on/for the target cell and the slot in which the corresponding measurement RS resource set is transmitted. Alternatively, the aperiodic trigger offset X could between the (first) slot that carries or conveys the LTM CSC MAC CE and/or when the LTM CSC MAC CE has become applicable (denoted by LTM CSC MAC CE application time) and/or the TCI state(s) indicated in/by the LTM CSC MAC CE command has become applicable (denoted by LTM beam application time) and the slot in which the corresponding measurement RS resource set is transmitted.

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by aperiodicTriggerOffset, e.g., in LTM-Config, LTM-Candidate, LTM-CSI-ReportConfig, LTM-CSI-ResourceConfig, LTM-TCI-Info and/or etc. The value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. When the field or the higher layer parameter aperiodicTriggerOffset is absent, the UE could apply the value 0 of X.
   For another example, the LTM CSC MAC CE could provide, contain, include or comprise one or more indicators to indicate the value(s) of X, e.g., via one or more new fields in the LTM CSC MAC CE. In one example, the value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. In another example, the value x of X could correspond to x slot(s). Whether the one or more indicators could be present or not (absent) in the LTM CSC MAC CE could be higher layer configured. For instance, when/if a higher layer parameter triggeringOffsetPresentInCSC is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the LTM CSC MAC CE; otherwise, i.e., when/if the higher layer parameter triggeringOffsetPresentInCSC is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter triggeringOffsetPresentInCSC is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the LTM CSC MAC CE. When the one or more indicators mentioned herein are absent from/in the LTM CSC MAC CE, the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

Furthermore, the LTM CSC MAC CE application time could correspond to T_{HARQ}+3 ms, wherein T_{HARQ} is the time between the last TTI containing the LTM CSC MAC CE and ACK for the PDSCH that provides the LTM CSC MAC CE. And the LTM beam application time could be no later than T_{LTM-RRC-processing}+T_{LTM-processing}+T_{first-RS}+T_{RS-proc}+3 ms after the last symbol of a PUCCH or PUSCH with HARQ-ACK information for the PDSCH providing the LTM CSC MAC CE, where T_{LTM-RRC-processing}, T_{LTM-processing}, T_{first-RS}, and T_{RS-proc} are defined in the TS 38.133. According to or following those specified herein in the present disclosure, in some case(s) or under certain setting(s), the value(s) of X could comprise the LTM CSC MAC CE application time and/or the LTM beam application as specified/defined herein in the present disclosure. Or the slot when the LTM CSC MAC CE has become applicable and/or the TCI state(s) indicated in/by the LTM CSC MAC CE command has become applicable could correspond to the first slot that is after slot

$$n + 3 {N}_{slot}^{frame , μ}$$

when the UE would transmit a PUCCH with HARQ-ACK information in slot n corresponding to the PDSCH carrying the LTM CSC MAC CE where μ is the SCS configuration for the PUSCH(s), and

$${N}_{slot}^{frame , μ}$$

is the number of slots in a frame.

In one example, when/if the LTM CSC MAC CE can activate at least SP CSI-RS(s) for measurement on/for the corresponding target cell according to or following those specified herein in the present disclosure, the LTM CSC MAC CE could provide, indicate, contain or include one or more fields each comprising a SP CSI-RS resource set ID and an A/D field. In particular, the A/D field could indicate whether to activate or deactivate the SP CSI-RS resource set(s) indicated therein for the corresponding target cell—i.e., the field is set to ‘1’ to indicate activation, otherwise (i.e., the field is set to ‘0’) it indicates deactivation. Each of the field(s) that comprises a SP CSI-RS resource set ID could contain an index of NZP-CSI-RS-ResourceSet, containing semi-persistent NZP CSI-RS resources, indicating the semi-persistent NZP CSI-RS resource set, which may need to be activated or deactivated (e.g., based on or according to the value of the A/D field), and the length of each of the field(s) could be of 6 bits. In this case, after the LTM CSC MAC CE has become applicable (denoted by LTM CSC MAC CE application time) or the TCI state(s) indicated in/by the LTM CSC MAC CE command has become applicable (denoted by LTM beam application time), the UE could assume that the activated SP CSI-RS(s) could be transmitted in slots satisfying

$$( {N}_{slot}^{frame , μ} {n}_{f} + {n}_{s , f}^{μ} - {T}_{offset} ) mod {T}_{CSI - RS} = 0$$

where the periodicity T_{CSI-RS} (in slots) and slot offset T_{offset} are obtained from the higher-layer parameter CSI-ResourcePeriodicityAndOffset or slotConfig, and

$${N}_{slot}^{frame , μ}$$

is the number of slots in a frame, n_{f} represents the frame number, and

$${n}_{s , f}^{μ}$$

is the slot number within a frame. The UE could assume that the semi-persistent CSI-RS(s) could be transmitted in a candidate slot as described in clause 11.1 of [5, [REF 3]]. Furthermore, the UE could assume that the SP CSI-RS(s)/SP CSI-RS resource set(s) could be deactivated after the LTM CSC MAC CE that deactivates the SP CSI-RS(s)/SP CSI-RS resource set(s) has become applicable (denoted by LTM CSC MAC CE application time) or the TCI state indicated in/by the LTM CSC MAC CE that deactivates the SP CSI-RS(s)/SP CSI-RS resource set(s) has become applicable (denoted by LTM beam application time). Here, the LTM CSC MAC CE application time could correspond to T_{HARQ}+3 ms, wherein T_{HARQ} is the time between the last TTI containing the LTM CSC MAC CE and ACK for the PDSCH that provides the LTM CSC MAC CE. And the LTM beam application time could be no later than T_{LTM-RRC-processing}+T_{LTM-processing}+T_{first-RS}+T_{RS-proc}+3 ms after the last symbol of a PUCCH or PUSCH with HARQ-ACK information for the PDSCH providing the LTM CSC MAC CE, where T_{LTM-RRC-processing}, T_{LTM-processing}, T_{first-RS}, and T_{RS-proc} are defined in the TS 38.133. Or the slot when the LTM CSC MAC CE has become applicable and/or the TCI state(s) indicated in/by the LTM CSC MAC CE command has become applicable could correspond to the first slot that is after slot

$$n + 3 {N}_{slot}^{frame , μ}$$

when the UE would transmit a PUCCH with HARQ-ACK information in slot n corresponding to the PDSCH carrying the LTM CSC MAC CE where μ is the SCS configuration for the PUSCH(s), and

$${N}_{slot}^{frame , μ}$$

is the number of slots in a frame.

In one example, when/if the LTM CSC MAC CE can at least trigger AP CSI reporting and/or activate SP CSI reporting over PUSCH(s) on/for the corresponding target cell according to or following those specified herein in the present disclosure, and the LTM CSC MAC CE comprises a CSI request field according to or following those specified herein in the present disclosure,
the UE could first identify or determine a trigger state according to the indicated codepoint of the CSI request field, wherein the trigger state could be associated/specific/corresponding/linked to the corresponding target cell; e.g., the trigger state could be from the list of trigger state(s)—provided by CSI-AperiodicTriggerStateList—associated/corresponding/linked/specific to the target cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the target cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding target cell; each of the identified or determined one or more CSI reporting settings/CSI report configurations associated to a reportConfigId could be associated or linked or corresponding to a list of report slot offset(s), e.g., provided by reportSlotOffsetList as specified/defined in [REF 6].

In this case, the UE could determine or identify the PUSCH resource(s) and the corresponding setting(s) for the PUSCH(s) to send or transmit or carry or convey the SP/AP CSI report(s) on/for the corresponding target cell according to the following procedure(s): when the UE could be scheduled to transmit a PUSCH with no transport block and/or with a CSI report(s) by a ‘CSI request’ field in the LTM CSC MAC CE for the corresponding target cell as specified/defined herein in the present disclosure, the UE could be provided or indicated or configured by the network, e.g., via/in/by higher layer RRC signaling(s)/parameter(s) including LTM-Config, LTM-Candidate, LTM-CSI-ReportConfig, LTM-CSI-ResourceConfig, LTM-TCI-Info and/or etc. and/or MAC CE command(s) and/or dynamic DCI based L1 signaling(s) based on or according to a corresponding UE's capability or capability signaling, a value m providing a row index m+1 to the allocated table as defined in Clause 6.1.2.1.1 of [REF 4]. The indexed row defines the start and length indicator SLIV, or directly the start symbol S and the allocation length L, and the PUSCH mapping type to be applied in the PUSCH transmission and the K₂ value could be determined as

$${K}_{2} = {max}_{j} {Y}_{j} ( m + 1 ) ,$$

where Yⱼ for j=0, . . . , N_{Rep}−1 are the corresponding list entries of the list of report slot offset(s), e.g., provided by reportSlotOffsetList or reportSlotOffsetList-r17, associated/linked/specific/corresponding to the N_{Rep} determined or identified or triggered CSI reporting settings/CSI report configurations—e.g., in the corresponding higher layer parameter(s) CSI-ReportConfig(s) or LTM-CSI-ReportConfig(s), and Yⱼ(m+1) could correspond to the (m+1)-th entry of Yⱼ including the omitted CSI reporting settings/CSI report configurations triggered for non-active DL BWPs, where the UE may not expect that (m+1) is larger than 16. Here, the LTM CSC MAC CE could comprise or provide or contain or include one or more fields to indicate the value m.
In one example, the value m could be provided or indicated by a new field introduced in the LTM CSC MAC CE dedicated for triggering AP CSI reporting and/or activating SP CSI reporting over PUSCH(s) on/for the target cell.
In another example, the value m could be provided or indicated by repurposing one or more codepoints of one or more existing fields in the LTM CSC MAC CE subject to network's configuration(s)/signaling(s) and/or UE's capability(s)/capability signaling(s).

In this case, the UE could start to apply or use the PUSCH resource(s) from or in (the first) slot(s) that is at least a number e.g., K₂ of slot(s) offset relative to or starting from or after the (first) slot that carries or conveys the LTM CSC MAC CE and/or when the LTM CSC MAC CE has become applicable (denoted by LTM CSC MAC CE application time) and/or the TCI state(s) indicated in/by the LTM CSC MAC CE command has become applicable (denoted by LTM beam application time) to carry or convey or send or transmit the SP/AP CSI report(s) for/on the corresponding target cell. The LTM CSC MAC CE application time could correspond to T_{HARQ}+3 ms, wherein T_{HARQ} is the time between the last TTI containing the LTM CSC MAC CE and ACK for the PDSCH that provides the LTM CSC MAC CE. And the LTM beam application time could be no later than T_{LTM-RRC-processing}+T_{LTM-processing}+T_{first-RS}+T_{RS-proc}+3 ms after the last symbol of a PUCCH or PUSCH with HARQ-ACK information for the PDSCH providing the LTM CSC MAC CE, where T_{LTM-RRC-processing}, T_{LTM-processing}, T_{first-RS}, and T_{RS-proc} are defined in the TS 38.133. Or, the UE could perform AP CSI reporting and/or SP CSI reporting on the PUSCH(s) on/for the corresponding target cell applied starting from the first slot that is after slot

$$n + 3 {N}_{slot}^{frame , μ}$$

when the UE would transmit a PUCCH with HARQ-ACK information in slot n corresponding to the PDSCH carrying the LTM CSC MAC CE, where μ is the SCS configuration for the PUSCH(s), and

$${N}_{slot}^{frame , μ}$$

is the number of slots in a frame.

In one example, when/if the LTM CSC MAC CE can activate at least SP CSI reporting over PUCCH(s) on/for the corresponding target cell according to or following those specified herein in the present disclosure, the LTM CSC MAC CE could comprise a bitmap with each entry/bit position of the bitmap corresponding to a field in the LTM CSC MAC CE. For instance, the bitmap could comprise I≥1 entries/bit positions, wherein the first entry/bit position of the bitmap could be represented by S₀ field in the LTM CSC MAC CE, the second entry/bit position of the bitmap could be represented by S₁ field in the LTM CSC MAC CE and so on. In this case, the Sᵢ field (i∈{0, 1, . . . , I−1}) could indicate the activation/deactivation status of the Semi-Persistent CSI report configuration within csi-ReportConfigToAddModList, as specified in [REF 6][5], wherein the Semi-Persistent CSI report configuration within csi-ReportConfigToAddModList could be associated/specific/corresponding/linked/mapped to the corresponding target cell. So refers to the report configuration which includes PUCCH resources for SP CSI reporting in the indicated BWP for/on the target cell and has the lowest CSI-ReportConfigId within the list with type set to semiPersistentOnPUCCH, S₁ to the report configuration which includes PUCCH resources for SP CSI reporting in the indicated BWP for/on the target cell and has the second lowest CSI-ReportConfigId and so on. If the number of report configurations within the list with type set to semiPersistentOnPUCCH in the indicated BWP is less than i+1, MAC entity shall ignore the Sᵢ field. The Sᵢ field is set to 1 to indicate that the corresponding Semi-Persistent CSI report configuration shall be activated. The Sᵢ field is set to 0 to indicate that the corresponding Semi-Persistent CSI report configuration i shall be deactivated. In this case, the UE could perform SP CSI reporting on the PUCCH(s) on/for the corresponding target cell applied starting from the first slot that is after slot

$$n + 3 {N}_{slot}^{frame , μ}$$

when the UE would transmit a PUCCH with HARQ-ACK information in slot n corresponding to the PDSCH carrying the LTM CSC MAC CE, where μ is the SCS configuration for the PUCCH(s), and

$${N}_{slot}^{frame , μ}$$

is the number of slots in a frame.

For the (aforementioned) design examples specified/described herein in the present disclosure, a non-zero codepoint/bit of the CSI request field in the LTM CSC MAC CE command and/or DCI could be mapped to a (CSI) triggering/trigger state according to the order of the associated positions of the (e.g., up to 2^{N}^{_{TS}}−1) trigger states in CSI-AperiodicTriggerStateList with codepoint/bit ‘1’ mapped to the trigger/triggering state in the first position.

For RACH-based LTM operation(s), after a UE has received and/or applied the LTM CSC MAC CE, the UE could initiate a RACH procedure towards the target cell provided/indicated by the LTM CSC MAC CE—e.g., to acquire the UL timing(s) of the target cell. In this case, the RACH procedure (and therefore, the corresponding steps/messages specified or provided therein) could be (or could be said to be) associated, specific, corresponding or linked to the target cell in the present disclosure. Here, the target cell could be from the list/set/pool of configured candidate cells or the subset of candidate cell(s) in LTM operation(s) for CSI acquisition as specified/defined herein in the present disclosure. That is, the ID/index of the target cell associated or linked or specific or corresponding to the RACH procedure could be selected or determined or identified or indicated or provided from the list/set/pool of configured candidate cell IDs or the subset of candidate cell ID(s) in LTM operation(s) for CSI acquisition as specified/defined herein in the present disclosure. That is, the bitwidth of the target cell ID here could be determined as ┌log₂(C+1)┐ or ┌log₂(C)┐ (bits), where C is the number of candidate cells in the list/set/pool of configured candidate cells/candidate cell IDs and/or in a/the subset of candidate cell(s)/candidate cell ID(s) for CSI acquisition in LTM operation(s) as specified/defined herein in the present disclosure.

TABLE 1
Random Access Response Grant Content field size

| RAR grant field | Number of bits |
|---|---|
| Frequency hopping flag | 1 |
| PUSCH frequency resource | 12, for operation with shared spectrum |
| allocation | channel access in FR1 or for FR2-2 when |
| | ChannelAccessMode2-r17 is provided 14, |
| | otherwise |
| PUSCH time resource | 4 |
| allocation | |
| MCS | 4 |
| TPC command for PUSCH | 3 |
| CSI request | x = 0, 1, 2, 3, 4, 5, 6 . . . , x_max |
| ChannelAccess-CPext | 2, for operation with shared spectrum |
| | channel access in FRI or for FR2-2 when |
| | ChannelAccessMode2-r17 is provided 0, |
| | otherwise |

A one-bit CSI request field is reserved in the RAR UL grant that can be used to schedule a PUSCH transmission from the UE, e.g., to or towards the target cell. For the RACH-based LTM operation, as illustrated in FIG. 10, the UE could receive, in the Msg2 RAR (and therefore, the RAR UL grant), a non-zero one-bit CSI request field, wherein the non-zero one-bit CSI request field could be used for enabling CSI acquisition including triggering of CSI/beam measurement/reporting, measurement of CSI-RS (for beam management, for CSI-RS and/or for mobility) and/or CSI/beam reporting before and/or during the LTM cell switch (for RACH-based and/or RACH-less LTM cell switch), e.g., for the corresponding candidate cell(s)/cell ID(s)—i.e., the target cell/target cell ID, according to or following those specified/defined herein in the present disclosure. In particular,
In one example, a UE could receive from the network, in the Msg2 RAR (and therefore, the RAR UL grant), a x-bit CSI request field/indicator, wherein x=0, 1, 2, 3, 4, 5, 6, . . . , and x could be less than or equal to x_max (as illustrated in TABLE 1). For this design example, the UE could be provided or indicated by the network, e.g., via higher layer RRC signaling(s)/parameter(s) e.g. in/by LTM-Config, LTM-Candidate, LTM-CSI-ReportConfig, LTM-CSI-ResourceConfig, LTM-TCI-Info and/or etc., whether or not the x-bit CSI request field/indication is present in the Msg2 RAR (and therefore, the RAR UL grant). For instance, when/if a higher layer parameter csiRequestInRAR is provided/configured, e.g., in LTM-Config, LTM-Candidate, LTM-CSI-ReportConfig, LTM-CSI-ResourceConfig, LTM-TCI-Info and/or etc., and/or is set to ‘enabled’, the UE could expect to receive in the Msg2 RAR (and therefore, the RAR UL grant), e.g., for the corresponding candidate cell(s)/cell ID(s)—i.e., the target cell/target cell ID, the x-bit CSI request field with valid value(s), i.e., x would be greater than or equal to 1. Otherwise, i.e., when/if the higher layer parameter csiRequestInRAR is not present or provided/configured and/or is absent, e.g., in LTM-Config, LTM-Candidate, LTM-CSI-ReportConfig, LTM-CSI-ResourceConfig, LTM-TCI-Info and/or etc., and/or is present or provided/configured, e.g., in LTM-Config, LTM-Candidate, LTM-CSI-ReportConfig, LTM-CSI-ResourceConfig, LTM-TCI-Info and/or etc., and is set to ‘disabled’, the UE may not expect to receive in the Msg2 RAR (and therefore, the RAR UL grant), e.g., for the corresponding candidate cell(s)/cell ID(s)—i.e., the target cell/target cell ID, a CSI request field with valid value(s), and/or the UE could expect that the CSI request field, if indicated or provided in the Msg2 RAR (and therefore, the RAR UL grant) for the corresponding candidate cell(s)/cell ID(s), is a 0-bit field, i.e., x=0, and/or the UE could expect that the CSI request field, if indicated or provided in the Msg2 RAR (and therefore, the RAR UL grant) for the corresponding candidate cell(s)/cell ID(s)—i.e., the target cell/target cell ID, has value 0 or zero value. In this case, when/if the UE does not receive in the Msg2 RAR (and therefore, the RAR UL grant) any CSI request field(s), and/or the UE receives in the Msg2 RAR (and therefore, the RAR UL grant) a 0-bit CSI request field and/or a zero-valued CSI request field, the UE could expect that CSI acquisition including triggering of CSI/beam measurement/reporting, measurement of CSI-RS (for beam management, for CSI-RS and/or for mobility) and/or CSI/beam reporting is not enabled or supported before and/or during the LTM cell switch (for RACH-based and/or RACH-less LTM cell switch), e.g., for the corresponding candidate cell(s)/cell ID(s)—i.e., the target cell or target cell ID. The UE could determine or identify the value(s) of x and/or x_max according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s).
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's. For this design example, a trigger state could be initiated using the non-zero CSI request field in the Msg2 RAR (and therefore, the RAR UL grant), and when the bits/codepoints of the CSI request field in the Msg2 RAR (and therefore, the RAR UL grant) are set to zero(s), no CSI for LTM operation (e.g., before and/or during the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during the LTM cell switch (for RACH-based and/or RACH-less LTM cell switch), e.g., for the corresponding candidate cell(s)/cell ID(s)—i.e., the target cell/target cell ID. Alternatively or optionally, when/if the UE is not configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's, no CSI for LTM operation (e.g., before and/or during the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during the LTM cell switch (for RACH-based and/or RACH-less LTM cell switch), e.g., for the corresponding candidate cell(s)/cell ID(s)—i.e., the target cell/target cell ID.
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of 2^{M}^{_{TS}}−1 trigger states provided by CSI-AperiodicTriggerStateList each associated to one or more CSI-ReportConfig's and/or one or more LTM-CSI-ReportConfig's. For this design example, when/if a non-zero CSI request field is provided or indicated in a Msg2 RAR (and therefore, the RAR UL grant), a trigger state could be initiated using the non-zero CSI request field in the Msg2 RAR (and therefore, the RAR UL grant), and the CSI request field in the Msg2 RAR (and therefore, the RAR UL grant) can directly indicate the trigger state, e.g., out of the 2^{M}^{_{TS}}−1 configured/provided trigger states in the CSI-AperiodicTriggerStateList. That is, in this case, the number of bits of/in the CSI request field (i.e., the x-bit CSI request field in the Msg2 RAR (and therefore, the RAR UL grant) as specified/defined herein in the present disclosure) is x=M_{TS}. The UE could determine or identify the value(s) of M_{TS} according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In one example, the UE (e.g., the UE 116) could be first configured or provided by the network, e.g., in LTM-Config, LTM-Candidate, LTM-CSI-ReportConfig, LTM-CSI-ResourceConfig, LTM-TCI-Info and/or etc., a list of M_{TS} trigger states provided by CSI-AperiodicTriggerStateList each associated to one or more CSI-ReportConfig's and/or one or more LTM-CSI-ReportConfig's. For this design example, when/if a non-zero CSI request field is provided or indicated in a Msg2 RAR (and therefore, the RAR UL grant), a trigger state could be initiated using the non-zero CSI request field in the Msg2 RAR (and therefore, the RAR UL grant). For this design example,
   When the number of configured (CSI) trigger states in CSI-AperiodicTriggerStateList is greater than or equal to 2^{N}^{_{TS}}−1 (i.e., M_{TS}>2^{N}^{_{TS}}−1), where N_{TS} is the number of bits of/in the CSI request field, i.e., x=N_{TS} for the x-bit CSI request field in the Msg2 RAR (and therefore, the RAR UL grant) as specified/defined herein in the present disclosure, the UE could receive a sub-selection MAC CE command/indication, used to map up to 2^{N}^{_{TS}}−1 trigger states to the bits/codepoints of the CSI request field in the Msg2 RAR (and therefore, the RAR UL grant). Here, N_{TS} could be provided or configured by a higher layer parameter reportTriggerSize where e.g. N_{TS}∈{0, 1, 2, 3, 4, 5, 6} or N_{TS}∈{1, 2, 3, 4, 5, 6} or N_{TS}∈{0, . . . , x_max} or N_{TS}∈{1, . . . , x_max}. When the UE would transmit a PUCCH with HARQ-ACK information in slot n corresponding to the PDSCH carrying the sub-selection MAC CE command/indication, UE assumption on the mapping of the selected CSI trigger state(s) to the codepoint(s)/bit(s) of the CSI request field in the Msg2 RAR (and therefore, the RAR UL grant) according to or following those specified herein in the present disclosure could be applied starting from the first slot that is after slot

$$n + 3 {N}_{slot}^{subframe , μ} + \frac{{2}^{μ}}{{2}^{{μ}_{K}} mac} \cdot {k}_{mac}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided.
When the number of configured (CSI) trigger states in CSI-AperiodicTriggerStateList is less than or equal to 2^{N}^{_{TS}}−1 (i.e., M_{TS}≤2^{N}^{_{TS}}−1), where N_{TS} is the number of bits of/in the CSI request field, i.e., x=N_{TS} for the x-bit CSI request field in the Msg2 RAR (and therefore, the RAR UL grant) as specified/defined herein in the present disclosure, the CSI request field in the Msg2 RAR (and therefore, the RAR UL grant) can directly indicate the trigger state, e.g., out of the M_{TS} configured/provided trigger states in the CSI-AperiodicTriggerStateList.

The UE could be provided or configured or indicated by the network, e.g., via/by/in higher layer RRC signaling(s)/parameter(s) and/or MAC CE command(s) and/or dynamic DCI based L1 signaling(s) based on or according to a corresponding UE's capability or capability signaling, whether the Msg2 RAR can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting, for/on the corresponding target cell.
For example, the UE could be configured or provided by the network, e.g., in LTM-Config, LTM-Candidate, LTM-CSI-ReportConfig, LTM-CSI-ResourceConfig, LTM-TCI-Info and/or etc., a higher layer parameter ltmMeasureReport. When/if the higher layer parameter ltmMeasureReport is provided, configured or present and/or set to ‘enabled’ and/or ‘measureOnly’, the UE could expect or assume that the Msg2 RAR could activate/trigger only (SP/AP) CSI-RS(s) for measurement on the target cell/candidate cell(s); when/if the higher layer parameter ltmMeasureReport is provided, configured or present and/or set to ‘enabled’ and/or ‘reportOnly’, the UE could expect or assume that the Msg2 RAR could activate/trigger only (SP/AP) CSI reporting on/for the target cell/candidate cell(s); and when/if the higher layer parameter ltmMeasureReport is provided, configured or present and/or set to ‘enabled’ and/or ‘bothMeasureReport’, the UE could expect or assume that the Msg2 RAR could activate/trigger both (SP/AP) CSI-RS(s) for measurement on the target cell/candidate cell(s) and CSI reporting on/for the target cell/candidate cell(s). Optionally, when/if the higher layer parameter ltmMeasureReport is not provided or present or configured or is absent, or the higher layer parameter ltmMeasureReport is provided, configured or present but set to ‘disabled’, the UE could expect or assume that the Msg2 RAR could activate/trigger (i) only (SP/AP) CSI-RS(s) for measurement on the target cell/candidate cell(s), (ii) only (SP/AP) CSI reporting on/for the target cell/candidate cell(s), or (iii) both (SP/AP) CSI-RS(s) for measurement on the target cell/candidate cell(s) and CSI reporting on/for the target cell/candidate cell(s), according to or based on (a) fixed value(s)/rule(s) in system specification(s) and/or per RRC (re-)configuration/setup, (b) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (c) UE's autonomous determination or selection, which could be further sent to the network via various UL channels/signals e.g. via/in part of beam/CSI report(s) and/or UE's capability signaling(s).
For another example, the Msg2 RAR could comprise or provide or include or contain a one-bit indicator; in this case, when/if the one-bit indicator is set to ‘1’ (or ‘0’), (the UE could expect or assume that) the Msg2 RAR could activate/trigger only (SP/AP) CSI-RS(s) for measurement on the target cell/candidate cell(s), otherwise, i.e., when/if the one-bit indicator is set to ‘0’ (‘1’), (the UE could assume or expect that) the Msg2 RAR could activate/trigger both (SP/AP) CSI-RS(s) for measurement on the target cell/candidate cell(s) and CSI reporting on/for the target cell/candidate cell(s). Alternatively, when/if the one-bit indicator is set to ‘1’ (or ‘0’), (the UE could expect or assume that) the Msg2 RAR could activate/trigger only (SP/AP) CSI reporting on/for the target cell/candidate cell(s), otherwise, i.e., when/if the one-bit indicator is set to ‘0’ (‘1’), (the UE could assume or expect that) the Msg2 RAR could activate/trigger both (SP/AP) CSI-RS(s) for measurement on the target cell/candidate cell(s) and CSI reporting on/for the target cell/candidate cell(s). Optionally, when/if the one-bit indicator is set to ‘1’ (or ‘0’), (the UE could expect or assume that) the Msg2 RAR could activate/trigger only (SP/AP) CSI-RS(s) for measurement on the target cell/candidate cell(s), otherwise, i.e., when/if the one-bit indicator is set to ‘0’ (‘1’), (the UE could assume or expect that) the Msg2 RAR could activate/trigger only (SP/AP) CSI reporting on/for the target cell/candidate cell(s). Whether the one-bit indicator is present or not (absent) in the Msg2 RAR could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one-bit indicator as specified/defined herein is present in the Msg2 RAR; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one-bit indicator as specified/defined herein is not present or is absent in the Msg2 RAR.
For another example, the Msg2 RAR could comprise or provide or include or contain a two-bit indicator; in this case, when/if the two-bit indicator is set to ‘00’ (or ‘01’ or ‘10’ or ‘11’), (the UE could expect or assume that) the Msg2 RAR could activate/trigger only (SP/AP) CSI-RS(s) for measurement on the target cell/candidate cell(s), when/if the two-bit indicator is set to ‘01’ (or ‘00’ or ‘10’ or ‘11’), (the UE could expect or assume that) the Msg2 RAR could activate/trigger only (SP/AP) CSI reporting on/for the target cell/candidate cell(s), and when/if the two-bit indicator is set to ‘10’ (or ‘00’ or ‘01’ or ‘11’), (the UE could assume or expect that) the Msg2 RAR could activate/trigger both (SP/AP) CSI-RS(s) for measurement on the target cell/candidate cell(s) and CSI reporting on/for the target cell/candidate cell(s). Whether the two-bit indicator is present or not (absent) in the Msg2 RAR could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the two-bit indicator as specified/defined herein is present in the Msg2 RAR; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the two-bit indicator as specified/defined herein is not present or is absent in the Msg2 RAR.
For another example, when/if a Msg2 RAR comprises a CSI request field according to or following those specified/defined herein in the present disclosure, and
   when/if the x-th codepoint of the CSI request field is indicated, (the UE could assume or expect that) the Msg2 RAR could activate/trigger only (SP/AP) CSI-RS(s) for measurement on the target cell/candidate cell(s),
   when/if the y-th codepoint of the CSI request field is indicated, (the UE could assume or expect that) the Msg2 RAR could activate/trigger only (SP/AP) CSI reporting on/for the target cell/candidate cell(s), and
   when/if the z-th codepoint of the CSI request field is indicated, (the UE could assume or expect that) the Msg2 RAR could activate/trigger both (SP/AP) CSI-RS(s) for measurement on the target cell/candidate cell(s) and CSI reporting on/for the target cell/candidate cell(s).

In this case, the UE could determine or identify whether (some codepoint(s) of) the CSI request field can be used, applied or repurposed for indicating whether the Msg2 RAR can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).
For another example, take into account an existing field in a Msg2 RAR:
   when/if the x-th codepoint of the existing field is indicated, (the UE could assume or expect that) the Msg2 RAR could activate/trigger only (SP/AP) CSI-RS(s) for measurement on the target cell/candidate cell(s),
   when/if the y-th codepoint of the existing field is indicated, (the UE could assume or expect that) the Msg2 RAR could activate/trigger only (SP/AP) CSI reporting on/for the target cell/candidate cell(s), and
   when/if the z-th codepoint of the existing field is indicated, (the UE could assume or expect that) the Msg2 RAR could activate/trigger both (SP/AP) CSI-RS(s) for measurement on the target cell/candidate cell(s) and CSI reporting on/for the target cell/candidate cell(s).

In this case, the UE could determine or identify whether (some codepoint(s) of) the existing field can be used, applied or repurposed for indicating whether the Msg2 RAR can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).

In one example, when/if the Msg2 RAR can trigger at least AP CSI-RS(s) for measurement on/for the corresponding target cell according to or following those specified herein in the present disclosure, and the Msg2 RAR comprises a CSI request field according to or following those specified herein in the present disclosure,
the UE could first identify or determine a trigger state according to the indicated codepoint of the CSI request field, wherein the trigger state could be associated/specific/corresponding/linked to the corresponding target cell; e.g., the trigger state could be from the list of trigger state(s)—provided by CSI-AperiodicTriggerStateList—associated/corresponding/linked/specific to the target cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the target cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding target cell;
   Each of the identified or determined one or more CSI reporting settings/CSI report configurations associated to a reportConfigId could be associated or linked or corresponding to a resource set (e.g., a NZP CSI-RS resource set or a SSB resource set) index/ID;
   The resource set index/ID and the reportConfigId could be provided in a/the same higher layer RRC signaling/parameter, e.g., CSI-AssociatedReportConfigInfo/LTM-CSI-AssociatedReportConfigInfo;
   The resource set (e.g., the NZP CSI-RS resource set or the SSB resource set) and/or one or more RS resources (e.g., NZP CSI-RS resource(s) or SSB(s)) in the resource set could be associated/specific/corresponding/linked to the corresponding target cell;
the UE could identify or determine one or more CSI resource settings/CSI resource configurations—each provided by CSI-ResourceConfig or LTM-CSI-ResourceConfig—associated/specific/linked/corresponding to the identified or determined one or more CSI reporting settings/CSI report configurations, wherein the identified or determined one or more CSI resource settings/CSI resource configurations could be associated/specific/corresponding/linked to the corresponding target cell;
   The UE could identify or determine a list of RS resource sets (e.g., a list of NZP CSI-RS resource set(s) or SSB resource set(s)) each comprising one or more RS resources including NZP CSI-RS resource(s) or SSB(s)—from or according to each of the identified or determined one or more CSI resource settings/CSI resource configurations;
   The identified or determined list or one or more RS resource sets in the list or one or more RS resources in one or more RS resource sets in the list could be associated/specific/corresponding/linked to the corresponding target cell;
for a CSI reporting setting/CSI report configuration associated/specific/corresponding/linked to the trigger state according to or following those specified herein in the present disclosure, the UE would identify or determine a resource set ID/index associated/specific/linked/corresponding to the CSI reporting setting/CSI reporting configuration according to or following those specified herein in the present disclosure, and a list of RS resource sets associated/specific/linked/corresponding to the CSI reporting setting/CSI reporting configuration according to or following those specified herein in the present disclosure. In this case, the resource set ID/index could point to an entry—hence, a measurement resource set—from/in the list of RS resource sets, wherein the measurement resource set could be or could correspond to a NZP CSI-RS resource set or a SSB resource set;
the UE could then measure the RS(s) including CSI-RS(s) corresponding to the RS resource(s) including NZP CSI-RS resource(s) in the measurement resource set on/for the target cell by assuming/applying a CSI-RS triggering offset X slot(s), wherein the X slot(s) could be specific to the measurement RS resource set. In particular, the aperiodic triggering offset X could be between the slot containing the Msg2 RAR that triggers the measurement RS resource set on/for the target cell and the slot in which the corresponding measurement RS resource set is transmitted. Alternatively, the aperiodic trigger offset X could between the (first) slot that carries or conveys the Msg2 RAR and/or when the Msg2 RAR has become applicable (denoted by Msg2 RAR application time) and the slot in which the corresponding measurement RS resource set is transmitted.

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by aperiodicTriggerOffset, e.g., in LTM-Config, LTM-Candidate, LTM-CSI-ReportConfig, LTM-CSI-ResourceConfig, LTM-TCI-Info and/or etc. The value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. When the field or the higher layer parameter aperiodicTriggerOffset is absent, the UE could apply the value 0 of X.
   For another example, the Msg2 RAR could provide, contain, include or comprise one or more indicators to indicate the value(s) of X, e.g., via one or more new fields in the Msg2 RAR. In one example, the value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. In another example, the value x of X could correspond to x slot(s). Whether the one or more indicators could be present or not (absent) in the Msg2 RAR could be higher layer configured. For instance, when/if a higher layer parameter triggeringOffsetPresentInRAR is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the Msg2 RAR; otherwise, i.e., when/if the higher layer parameter triggeringOffsetPresentInRAR is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter triggeringOffsetPresentInRAR is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the Msg2 RAR. When the one or more indicators mentioned herein are absent from/in the Msg2 RAR, the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

Furthermore, the Msg2 RAR application time could correspond to T_{HARQ}+3 ms, wherein T_{HARQ} is the time between the last transmission time interval (TTI) containing the Msg2 RAR and ACK for the PDSCH that provides the Msg2 RAR. According to or following those specified herein in the present disclosure, in some case(s) or under certain setting(s), the value(s) of X could comprise the Msg2 RAR application time as specified/defined herein in the present disclosure. Or the slot when the Msg2 RAR has become applicable could correspond to the first slot that is after slot

$$n + 3 {N}_{slot}^{frame , μ}$$

when the UE would transmit a PUCCH with HARQ-ACK information in slot n corresponding to the PDSCH carrying the Msg2 RAR where μ is the SCS configuration for the PUSCH(s), and

$${N}_{slot}^{frame , μ}$$

is the number of slots in a frame.

In one example, when/if the Msg2 RAR can activate at least SP CSI-RS(s) for measurement on/for the corresponding target cell according to or following those specified herein in the present disclosure, the Msg2 RAR could provide, indicate, contain or include one or more fields each comprising a SP CSI-RS resource set ID and an A/D field. In particular, the A/D field could indicate whether to activate or deactivate the SP CSI-RS resource set(s) indicated therein for the corresponding target cell—i.e., the field is set to ‘1’ to indicate activation, otherwise (i.e., the field is set to ‘0’) it indicates deactivation. Each of the field(s) that comprises a SP CSI-RS resource set ID could contain an index of NZP-CSI-RS-ResourceSet, containing semi-persistent NZP CSI-RS resources, indicating the semi-persistent NZP CSI-RS resource set, which may need to be activated or deactivated (e.g., based on or according to the value of the A/D field), and the length of each of the field(s) could be of 6 bits. In this case, after the Msg2 RAR has become applicable (denoted by Msg2 RAR application time), the UE could assume that the activated SP CSI-RS(s) could be transmitted in slots satisfying

$$( {N}_{slot}^{frame , μ} {n}_{f} + {n}_{s , f}^{μ} - {T}_{offset} ) mod {T}_{CSI - RS} = 0$$

where the periodicity T_{CSI-RS} (in slots) and slot offset T_{offset} are obtained from the higher-layer parameter CSI-ResourcePeriodityAndOffset or slotConfig, and

$${N}_{slot}^{frame , μ}$$

is the number of slots in a frame, n_{f} represents the frame number, and

$${n}_{s , f}^{μ}$$

is the slot number within a frame. The UE could assume that the semi-persistent CSI-RS(s) could be transmitted in a candidate slot as described in clause 11.1 of [5, [REF 3]]. Furthermore, the UE could assume that the SP CSI-RS(s)/SP CSI-RS resource set(s) could be deactivated after the Msg2 RAR that deactivates the SP CSI-RS(s)/SP CSI-RS resource set(s) has become applicable (denoted by Msg2 RAR application time). Here, the Msg2 RAR application time could correspond to T_{HARQ}+3 ms, wherein T_{HARQ} is the time between the last TTI containing the Msg2 RAR and ACK for the PDSCH that provides the Msg2 RAR. Or the slot when the Msg2 RAR has become applicable could correspond to the first slot that is after slot

$$n + 3 {N}_{slot}^{frame , μ}$$

when the UE would transmit a PUCCH with HARQ-ACK information in slot n corresponding to the PDSCH carrying the Msg2 RAR where μ is the SCS configuration for the PUSCH(s), and

$${N}_{slot}^{frame , μ}$$

is the number of slots in a frame.

In one example, when/if the Msg2 RAR can at least trigger AP CSI reporting and/or activate SP CSI reporting over PUSCH(s) on/for the corresponding target cell according to or following those specified herein in the present disclosure, and the Msg2 RAR comprises a CSI request field according to or following those specified herein in the present disclosure,
the UE could first identify or determine a trigger state according to the indicated codepoint of the CSI request field, wherein the trigger state could be associated/specific/corresponding/linked to the corresponding target cell; e.g., the trigger state could be from the list of trigger state(s)—provided by CSI-AperiodicTriggerStateList—associated/corresponding/linked/specific to the target cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the target cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding target cell; each of the identified or determined one or more CSI reporting settings/CSI report configurations associated to a reportConfigId could be associated or linked or corresponding to a list of report slot offset(s), e.g., provided by reportSlotOffsetList as specified/defined in [REF 6].

In this case, the UE (e.g., the UE 116) could determine or identify the PUSCH resource(s) and the corresponding setting(s) for the PUSCH(s) to send or transmit or carry or convey the SP/AP CSI report(s) on/for the corresponding target cell according to the following procedure(s): when the UE could be scheduled to transmit a PUSCH with no transport block and/or with a CSI report(s) by a ‘CSI request’ field in the Msg2 RAR for the corresponding target cell as specified/defined herein in the present disclosure, the UE could be provided or indicated or configured by the network, e.g., via/in/by higher layer RRC signaling(s)/parameter(s) including LTM-Config, LTM-Candidate, LTM-CSI-ReportConfig, LTM-CSI-ResourceConfig, LTM-TCI-Info and/or etc. and/or MAC CE command(s) and/or dynamic DCI based L1 signaling(s) based on or according to a corresponding UE's capability or capability signaling, a value m providing a row index m+1 to the allocated table as defined in Clause 6.1.2.1.1 of [REF 4]. The indexed row defines the start and length indicator SLIV, or directly the start symbol S and the allocation length L, and the PUSCH mapping type to be applied in the PUSCH transmission and the K₂ value could be determined as

$${K}_{2} = {max}_{j} {Y}_{j} ( m + 1 ) ,$$

where Yⱼ for j=0, . . . , N_{Rep}−1 are the corresponding list entries of the list of report slot offset(s), e.g., provided by reportSlotOffsetList or reportSlotOffsetList-r17, associated/linked/specific/corresponding to the N_{Rep} determined or identified or triggered CSI reporting settings/CSI report configurations—e.g., in the corresponding higher layer parameter(s) CSI-ReportConfig(s) or LTM-CSI-ReportConfig(s), and Yⱼ(m+1) could correspond to the (m+1)-th entry of Yⱼ including the omitted CSI reporting settings/CSI report configurations triggered for non-active DL BWPs, where the UE may not expect that (m+1) is larger than 16. Here, the Msg2 RAR could comprise or provide or contain or include one or more fields to indicate the value m.
In one example, the value m could be provided or indicated by the PUSCH time resource allocation field in the Msg2 RAR (e.g., in the RAR grant).
In another example, the value m could be provided or indicated by a new field introduced in the Msg2 RAR (e.g., in the RAR grant) dedicated for triggering AP CSI reporting and/or activating SP CSI reporting over PUSCH(s) on/for the target cell.
In another example, the value m could be provided or indicated by repurposing one or more codepoints of one or more existing fields in the Msg2 RAR (e.g., in the RAR grant) subject to network's configuration(s)/signaling(s) and/or UE's capability(s)/capability signaling(s).

In this case, the UE could start to apply or use the PUSCH resource(s) from or in (the first) slot(s) that is at least a number e.g., K₂ of slot(s) offset relative to or starting from or after the (first) slot that carries or conveys the Msg2 RAR and/or when the Msg2 RAR has become applicable (denoted by Msg2 RAR application time) to carry or convey or send or transmit the SP/AP CSI report(s) for/on the corresponding target cell. The Msg2 RAR application time could correspond to T_{HARQ}+3 ms, wherein T_{HARQ} is the time between the last TTI containing the Msg2 RAR and ACK for the PDSCH that provides the Msg2 RAR. In this case, the UE could perform AP/SP CSI reporting on the PUSCH(s) on/for the corresponding target cell applied starting from the first slot that is after slot

$$n + 3 {N}_{slot}^{frame , μ}$$

when the UE would transmit a PUCCH with HARQ-ACK information in slot n corresponding to the PDSCH carrying the Msg2 RAR, or a Msg3 in slot n, e.g., whichever comes later (or earlier), where μ is the SCS configuration for the PUSCH(s), and

$${N}_{slot}^{frame , μ}$$

is the number of slots in a frame.

In one example, for RACH-based LTM operation(s), when/if the LTM CSC MAC CE can at least trigger AP CSI reporting and/or activate SP CSI reporting over PUSCH(s) on/for the corresponding target cell according to or following those specified herein in the present disclosure, and the LTM CSC MAC CE comprises a CSI request field according to or following those specified herein in the present disclosure,
the UE could first identify or determine a trigger state according to the indicated codepoint of the CSI request field, wherein the trigger state could be associated/specific/corresponding/linked to the corresponding target cell; e.g., the trigger state could be from the list of trigger state(s)—provided by CSI-AperiodicTriggerStateList—associated/corresponding/linked/specific to the target cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the target cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding target cell; each of the identified or determined one or more CSI reporting settings/CSI report configurations associated to a reportConfigId could be associated or linked or corresponding to a list of report slot offset(s), e.g., provided by reportSlotOffsetList as specified/defined in [REF 6].

In this case, the UE could determine or identify the PUSCH resource(s) and the corresponding setting(s) for the PUSCH(s) to send or transmit or carry or convey the SP/AP CSI report(s) on/for the corresponding target cell according to the following procedure(s): when the UE could be scheduled to transmit a PUSCH with no transport block and/or with a CSI report(s) by a ‘CSI request’ field in the LTM CSC MAC CE for the corresponding target cell as specified/defined herein in the present disclosure, the UE could be provided or indicated or configured by the network, e.g., via/in/by higher layer RRC signaling(s)/parameter(s) including LTM-Config, LTM-Candidate, LTM-CSI-ReportConfig, LTM-CSI-ResourceConfig, LTM-TCI-Info and/or etc. and/or MAC CE command(s) and/or dynamic DCI based L1 signaling(s) based on or according to a corresponding UE's capability or capability signaling, a value m providing a row index m+1 to the allocated table as defined in Clause 6.1.2.1.1 of [REF 4]. The indexed row defines the start and length indicator SLIV, or directly the start symbol S and the allocation length L, and the PUSCH mapping type to be applied in the PUSCH transmission and the K₂ value could be determined as

$${K}_{2} = {max}_{j} {Y}_{j} ( m + 1 ) ,$$

where Yⱼ for j=0, . . . , N_{Rep}−1 are the corresponding list entries of the list of report slot offset(s), e.g., provided by reportSlotOffsetList or reportSlotOffsetList-r17, associated/linked/specific/corresponding to the N_{Rep} determined or identified or triggered CSI reporting settings/CSI report configurations—e.g., in the corresponding higher layer parameter(s) CSI-ReportConfig(s) or LTM-CSI-ReportConfig(s), and Yⱼ(m+1) could correspond to the (m+1)-th entry of Yⱼ including the omitted CSI reporting settings/CSI report configurations triggered for non-active DL BWPs, where the UE may not expect that (m+1) is larger than 16. Here, the Msg2 RAR could comprise or provide or contain or include one or more fields to indicate the value m.
In one example, the value m could be provided or indicated by the PUSCH time resource allocation field in the Msg2 RAR (e.g., in the RAR grant).
In another example, the value m could be provided or indicated by a new field introduced in the Msg2 RAR (e.g., in the RAR grant) dedicated for triggering AP CSI reporting and/or activating SP CSI reporting over PUSCH(s) on/for the target cell.
In another example, the value m could be provided or indicated by repurposing one or more codepoints of one or more existing fields in the Msg2 RAR (e.g., in the RAR grant) subject to network's configuration(s)/signaling(s) and/or UE's capability(s)/capability signaling(s).

In this case, the UE could start to apply or use the PUSCH resource(s) from or in (the first) slot(s) that is at least a number e.g., K₂ of slot(s) offset relative to or starting from or after the (first) slot that carries or conveys the LTM CSC MAC CE and/or when the LTM CSC MAC CE has become applicable (denoted by LTM CSC MAC CE application time) and/or the TCI state(s) indicated in/by the LTM CSC MAC CE command has become applicable (denoted by LTM beam application time) and/or that carriers or conveys the Msg2 RAR and/or when the Msg2 RAR has become applicable (denoted by Msg2 RAR application time) to carry or convey or send or transmit the SP/AP CSI report(s) for/on the corresponding target cell. The LTM CSC MAC CE application time could correspond to T_{HARQ}+3 ms, wherein T_{HARQ} is the time between the last TTI containing the LTM CSC MAC CE and ACK for the PDSCH that provides the LTM CSC MAC CE. And the LTM beam application time could be no later than T_{LTM-RRC-processing}+T_{LTM-processing}+T_{first-RS}+T_{RS-proc}+3 ms after the last symbol of a PUCCH or PUSCH with HARQ-ACK information for the PDSCH providing the LTM CSC MAC CE, where T_{LTM-RRC-processing}, T_{LTM-processing}, T_{first-RS}, and T_{RS-proc} are defined in the TS 38.133. The Msg2 RAR application time could correspond to T_{HARQ}+3 ms, wherein T_{HARQ} is the time between the last TTI containing the Msg2 RAR and ACK for the PDSCH that provides the Msg2 RAR. In this case, the UE could perform AP/SP CSI reporting on the PUSCH(s) on/for the corresponding target cell applied starting from the first slot that is after slot

$$n + 3 {N}_{slot}^{frame , μ}$$

when the UE would transmit a PUCCH with HARQ-ACK information in slot n corresponding to the PDSCH carrying the Msg2 RAR or the LTM CSC MAC CE, or a Msg3 in slot n, e.g., whichever comes later (or earlier), where μ is the SCS configuration for the PUSCH(s),

$${N}_{slot}^{frame , μ}$$

is the number of slots in a frame.

In one example, when/if the Msg2 RAR can activate at least SP CSI reporting over PUCCH(s) on/for the corresponding target cell according to or following those specified herein in the present disclosure, the Msg2 RAR could comprise a bitmap with each entry/bit position of the bitmap corresponding to a field in the Msg2 RAR. For instance, the bitmap could comprise I≥1 entries/bit positions, wherein the first entry/bit position of the bitmap could be represented by S₀ field in the Msg2 RAR, the second entry/bit position of the bitmap could be represented by S₁ field in the Msg2 RAR and so on. In this case, the Sᵢ field (i∈{0, 1, . . . , I−1}) could indicate the activation/deactivation status of the Semi-Persistent CSI report configuration within csi-ReportConfigToAddModList, as specified in [REF 6][5], wherein the Semi-Persistent CSI report configuration within csi-ReportConfigToAddModList could be associated/specific/corresponding/linked/mapped to the corresponding target cell. So refers to the report configuration which includes PUCCH resources for SP CSI reporting in the indicated BWP for/on the target cell and has the lowest CSI-ReportConfigId within the list with type set to semiPersistentOnPUCCH, S₁ to the report configuration which includes PUCCH resources for SP CSI reporting in the indicated BWP for/on the target cell and has the second lowest CSI-ReportConfigId and so on. If the number of report configurations within the list with type set to semiPersistentOnPUCCH in the indicated BWP is less than i+1, MAC entity shall ignore the Sᵢ field. The Sᵢ field is set to 1 to indicate that the corresponding Semi-Persistent CSI report configuration shall be activated. The Sᵢ field is set to 0 to indicate that the corresponding Semi-Persistent CSI report configuration i shall be deactivated. In this case, the UE could perform SP CSI reporting on the PUCCH(s) on/for the corresponding target cell applied starting from the first slot that is after slot

$$n + 3 {N}_{slot}^{frame , μ}$$

when the UE would transmit a PUCCH with HARQ-ACK information in slot n corresponding to the PDSCH carrying the Msg2 RAR, or a Msg3 in slot n, where μ is the SCS configuration for the PUCCH(s), and

$${N}_{slot}^{frame , μ}$$

is the number of slots in a frame.

For the (aforementioned) design examples specified/described herein in the present disclosure, a non-zero codepoint/bit of the CSI request field in the Msg2 RAR (and therefore, the RAR UL grant) could be mapped to a (CSI) triggering/trigger state according to the order of the associated positions of the (e.g., up to 2^{N}^{_{TS}}−1) trigger states in CSI-AperiodicTriggerStateList with codepoint/bit ‘1’ mapped to the trigger/triggering state in the first position. Throughout the present disclosure, a Msg2 RAR could also be referred to as a RAR grant or RAR UL grant such that they could be equivalent and used in an exchangeable manner. According to or following those specified/described herein in the present disclosure, the Msg2 RAR based design examples/procedures for activating/triggering SP/AP CSI-RS measurement(s) and/or CSI reporting(s) on/for the corresponding target cell could be applied or applicable for the RACH-based LTM operation(s).

A UE can be triggered a PRACH transmission on a candidate cell by a PDCCH order that the UE receives on a serving cell and includes an indication of the candidate cell for the PRACH transmission. In particular, if the CRC of the DCI format 1_0 is scrambled by C-RNTI and the “Frequency domain resource assignment” field are of ones, the DCI format 1_0 is for random access procedure initiated by a PDCCH order, with a cell indicator field set to ┌log₂(C+1)┐ or ┌log₂(C)┐ bits indicating the cell for the corresponding PRACH transmission if the UE is configured with higher layer parameter Early UlSyncConfig, where C is the number of candidate cells configured with higher layer parameter EarlyUlSyncConfig and/or in a/the subset of candidate cell(s)/candidate cell ID(s) for CSI acquisition in LTM operation(s) as specified/defined herein in the present disclosure; 0 bit otherwise. The bit field index 0 of the cell indicator field is mapped to the serving cell, and other bit field indexes are mapped to the candidate cells configured with higher layer parameter Early UlSyncConfig and/or in a/the subset of candidate cell(s)/candidate cell ID(s) for CSI acquisition in LTM operation(s) as specified/defined herein in the present disclosure according to an ascending order of a candidate identity configured by ltm-CandidateId, with the bit field index 1 mapped to the candidate cell with the smallest candidate identity.

A UE could be triggered a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a candidate cell by a PDCCH order that the UE receives on a serving cell and includes an indication of the candidate cell for the PRACH transmission and/or the CSI acquisition, and a CSI request field for requesting CSI/CSI acquisition of the candidate cell. In particular, if the CRC of the DCI format 1_0 is scrambled by C-RNTI and the “Frequency domain resource assignment” field are of ones, the DCI format 1_0 is for random access procedure initiated by a PDCCH order, and with the following two fields set as follows:
Cell indicator: ┌log₂(C+1)┐ or ┌log₂(C)┐ bits indicating the cell for the corresponding PRACH transmission if the UE is configured with higher layer parameter Early UlSyncConfig, where C is the number of candidate cells configured with higher layer parameter EarlyUlSyncConfig and/or in a/the subset of candidate cell(s)/candidate cell ID(s) for CSI acquisition in LTM operation(s) as specified/defined herein in the present disclosure; 0 bit otherwise. The bit field index 0 of the cell indicator field is mapped to the serving cell, and other bit field indexes are mapped to the candidate cells configured with higher layer parameter EarlyUlSyncConfig and/or in a/the subset of candidate cell(s)/candidate cell ID(s) for CSI acquisition in LTM operation(s) as specified/defined herein in the present disclosure according to an ascending order of a candidate identity configured by ltm-CandidateId, with the bit field index 1 mapped to the candidate cell with the smallest candidate identity.
CSI request: x bit(s), e.g., x=0, 1, 2, 3, 4, 5 or 6 bits determined by higher layer parameter reportTriggerSize. If the cell indicated by the Cell indicator field is a candidate cell, this field could be applied to the candidate cell. If the cell indicated by the Cell indicator field is a serving cell but not a candidate cell, in one example, this field could be reserved; in another example, this field could be applied to the serving cell.

In this case, a UE could receive a PDCCH order (e.g., in DCI format 1_0) on a serving cell that includes a Cell indicator and a x-bit CSI request field/indicator, wherein x=0, 1, 2, 3, 4, 5, 6, . . . , and x could be less than or equal to x_max. For this design example, the UE could be provided or indicated by the network, e.g., via higher layer RRC signaling(s)/parameter(s) e.g. in/by LTM-Config, LTM-Candidate, LTM-CSI-ReportConfig, LTM-CSI-ResourceConfig, LTM-TCI-Info and/or etc., whether or not the x-bit CSI request field/indication is present in the PDCCH order (and therefore, the corresponding DCI format, e.g., 1_0). For instance, when/if a higher layer parameter csiRequestInPDCCHorder is provided/configured, e.g., in LTM-Config, LTM-Candidate, LTM-CSI-ReportConfig, LTM-CSI-ResourceConfig, LTM-TCI-Info and/or etc., and/or is set to ‘enabled’, the UE could expect to receive in the PDCCH order (and therefore, the corresponding DCI format e.g. 1_0) that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a candidate cell—e.g., indicated by the Cell indicator field, the x-bit CSI request field with valid value(s), i.e., x would be greater than or equal to 1. Otherwise, i.e., when/if the higher layer parameter csiRequestInPDCCHorder is not present or provided/configured and/or is absent, e.g., in LTM-Config, LTM-Candidate, LTM-CSI-ReportConfig, LTM-CSI-ResourceConfig, LTM-TCI-Info and/or etc., and/or is present or provided/configured, e.g., in LTM-Config, LTM-Candidate, LTM-CSI-ReportConfig, LTM-CSI-ResourceConfig, LTM-TCI-Info and/or etc., and is set to ‘disabled’, the UE may not expect to receive in the PDCCH order that triggers a PRACH transmission and/or CSI acquisition on a candidate cell—e.g., indicated by the Cell indicator field, a CSI request field with valid value(s), and/or the UE could expect that the CSI request field, if indicated or provided in the PDCCH order (and therefore, the corresponding DCI format, e.g., 1_0), is a 0-bit field, i.e., x=0, and/or the UE could expect that the CSI request field, if indicated or provided in the PDCCH order (and therefore, the corresponding DCI format 10), has value 0 or zero value. In this case, when/if the UE does not receive in the PDCCH order any CSI request field(s), and/or the UE receives in the PDCCH order a 0-bit CSI request field and/or a zero-valued CSI request field, the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for/on the corresponding candidate cell, e.g., indicated by the Cell indicator field. The UE could determine or identify the value(s) of x and/or x_max according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s).
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's. For this design example, a trigger state could be initiated using the non-zero CSI request field in the PDCCH order (and therefore, the corresponding DCI format e.g. 1_0) received on a serving cell that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a candidate cell—e.g., indicated by the Cell indicator field, and when the bits/codepoints of the CSI request field in the PDCCH order (and therefore, the corresponding DCI format e.g. 1_0) are set to zero(s), no CSI for LTM operation (e.g., before and/or during and/or after the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding candidate cell—e.g., indicated by the Cell indicator field. Alternatively or optionally, when/if the UE is not configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's, no CSI for LTM operation (e.g., before and/or during and/or after the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding candidate cell indicated by the Cell indicator field.
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of 2^{M}^{_{TS}}−1 trigger states provided by CSI-AperiodicTriggerStateList each associated to one or more CSI-ReportConfig's and/or one or more LTM-CSI-ReportConfig's. For this design example, when/if a non-zero CSI request field is provided or indicated in PDCCH order (and therefore the corresponding DCI format e.g. 1_0) that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a candidate cell—e.g., indicated by the Cell indicator field, a trigger state could be initiated using the non-zero CSI request field in the PDCCH order (and therefore, the corresponding DCI format e.g. 1_0), and the CSI request field in the PDCCH order can directly indicate the trigger state, e.g., out of the 2^{M}^{_{TS}}−1 configured/provided trigger states in the CSI-AperiodicTriggerStateList. That is, in this case, the number of bits of/in the CSI request field (i.e., the x-bit CSI request field in the PDCCH order as specified/defined herein in the present disclosure) is x=M_{TS}. The UE could determine or identify the value(s) of M_{TS} according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of M_{TS} trigger states provided by CSI-AperiodicTriggerStateList each associated to one or more CSI-ReportConfig's and/or one or more LTM-CSI-ReportConfig's. For this design example, when/if a non-zero CSI request field is provided or indicated in a PDCCH order (and therefore, the corresponding DCI format e.g. 1_0) that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch, on a candidate cell—e.g., indicated by the Cell indicator field, a trigger state could be initiated using the non-zero CSI request field in the PDCCH order. For this design example,
   When the number of configured (CSI) trigger states in CSI-AperiodicTriggerStateList is greater than or equal to 2^{N}^{_{TS}}−1 (i.e., M_{TS}>2^{N}^{_{TS}}−1), where N_{TS} is the number of bits of/in the CSI request field, i.e., x=N_{TS} for the x-bit CSI request field in the PDCCH order (and therefore, the corresponding DCI format e.g. 1_0) as specified/defined herein in the present disclosure, the UE could receive a sub-selection MAC CE command/indication, used to map up to 2^{N}^{_{TS}}−1 trigger states to the bits/codepoints of the CSI request field in the PDCCH order (and therefore, the corresponding DCI format e.g. 1_0). Here, N_{TS} could be provided or configured by a higher layer parameter reportTriggerSize where e.g. N_{TS}∈{0, 1, 2, 3, 4, 5, 6} or N_{TS}∈{1, 2, 3, 4, 5, 6} or N_{TS}∈{0, . . . , x_max}or N_{TS}∈{1, . . . , x_max}. When the UE would transmit a PUCCH with HARQ-ACK information in slot n corresponding to the PDSCH carrying the sub-selection MAC CE command/indication, UE assumption on the mapping of the selected CSI trigger state(s) to the codepoint(s)/bit(s) of the CSI request field in the PDCCH order according to or following those specified herein in the present disclosure could be applied starting from the first slot that is after slot

$$n + 3 {N}_{slot}^{subframe , μ} + \frac{{2}^{μ}}{{2}^{{μ}_{K}} mac} \cdot {k}_{mac}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided.
   When the number of configured (CSI) trigger states in CSI-AperiodicTriggerStateList is less than or equal to 2^{N}^{_{TS}}−1 (i.e., M_{TS}≤2^{N}^{_{TS}}−1), where N_{TS} is the number of bits of/in the CSI request field, i.e., x=N_{TS} for the x-bit CSI request field in the PDCCH order (and therefore, the corresponding DCI format e.g. 1_0) as specified/defined herein in the present disclosure, the CSI request field in the PDCCH order can directly indicate the trigger state, e.g., out of the M_{TS} configured/provided trigger states in the CSI-AperiodicTriggerStateList.

According to or following those specified herein in the present disclosure, a UE (e.g., the UE 116) could be triggered PRACH transmission(s) and/or CSI acquisition(s)—including triggering(s) of CSI/beam measurement(s)/reporting(s), measurement(s) of CSI-RS(s) e.g. for beam management, for CSI-RS and/or for mobility and/or CSI/beam reporting(s) for the LTM operation(s), e.g., before and/or during and/or after LTM cell switch—on one or more candidate cells (referred to as one or more reference candidate cells in the present disclosure) by one or more PDCCH orders that the UE receives on a serving cell, wherein each of the one or more PDCCH orders could include an indication of a candidate cell for a corresponding PRACH transmission and/or CSI acquisition, and a CSI request field for requesting CSI/CSI acquisition of the candidate cell according to or following those specified herein in the present disclosure. For each of the one or more PDCCH orders mentioned herein—denoted by a/the PDCCH order thereafter—and therefore, a corresponding candidate cell, the UE could be provided or configured or indicated by the network, e.g., via/by/in higher layer RRC signaling(s)/parameter(s) and/or MAC CE command(s) and/or dynamic DCI based L1 signaling(s) based on or according to a corresponding UE's capability or capability signaling, whether the PDCCH order (and therefore, the corresponding DCI format 1_0) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting, for/on the corresponding candidate cell.
For example, the UE could be configured or provided by the network, e.g., in LTM-Config, LTM-Candidate, LTM-CSI-ReportConfig, LTM-CSI-ResourceConfig, LTM-TCI-Info and/or etc., a higher layer parameter ltmMeasureReport. When/if the higher layer parameter ltmMeasureReport is provided, configured or present and/or set to ‘enabled’ and/or ‘measure Only’, the UE could expect or assume that the PDCCH order (and therefore, the corresponding DCI format 1_0) could activate/trigger only (SP/AP) CSI-RS(s) for measurement on the corresponding candidate cell; when/if the higher layer parameter ltmMeasureReport is provided, configured or present and/or set to ‘enabled’ and/or ‘reportOnly’, the UE could expect or assume that the PDCCH order (and therefore, the corresponding DCI format 1_0) could activate/trigger only (SP/AP) CSI reporting on/for the corresponding candidate cell; and when/if the higher layer parameter ltmMeasureReport is provided, configured or present and/or set to ‘enabled’ and/or ‘bothMeasureReport’, the UE could expect or assume that the PDCCH order (and therefore, the corresponding DCI format 1_0) could activate/trigger both (SP/AP) CSI-RS(s) for measurement on the corresponding candidate cell and CSI reporting on/for the corresponding candidate cell. Optionally, when/if the higher layer parameter ltmMeasureReport is not provided or present or configured or is absent, or the higher layer parameter ltmMeasureReport is provided, configured or present but set to ‘disabled’, the UE could expect or assume that the PDCCH order (and therefore, the corresponding DCI format 10) could activate/trigger (i) only (SP/AP) CSI-RS(s) for measurement on the corresponding candidate cell, (ii) only (SP/AP) CSI reporting on/for the corresponding candidate cell, or (iii) both (SP/AP) CSI-RS(s) for measurement on the corresponding candidate cell and CSI reporting on/for the corresponding candidate cell, according to or based on (a) fixed value(s)/rule(s) in system specification(s) and/or per RRC (re-)configuration/setup, (b) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (c) UE's autonomous determination or selection, which could be further sent to the network via various UL channels/signals e.g. via/in part of beam/CSI report(s) and/or UE's capability signaling(s).
For another example, the PDCCH order (and therefore, the corresponding DCI format 1_0) could comprise or provide or include or contain a one-bit indicator; in this case, when/if the one-bit indicator is set to ‘1’ (or ‘0’), (the UE could expect or assume that) the PDCCH order (and therefore, the corresponding DCI format 1_0) could activate/trigger only (SP/AP) CSI-RS(s) for measurement on the corresponding candidate cell, otherwise, i.e., when/if the one-bit indicator is set to ‘0’ (‘1’), (the UE could assume or expect that) the PDCCH order (and therefore, the corresponding DCI format 1_0) could activate/trigger both (SP/AP) CSI-RS(s) for measurement on the corresponding candidate cell and CSI reporting on/for the corresponding candidate cell. Alternatively, when/if the one-bit indicator is set to ‘1’ (or ‘0’), (the UE could expect or assume that) the PDCCH order (and therefore, the corresponding DCI format 1_0) could activate/trigger only (SP/AP) CSI reporting on/for the corresponding candidate cell, otherwise, i.e., when/if the one-bit indicator is set to ‘0’ (‘1’), (the UE could assume or expect that) the PDCCH order (and therefore, the corresponding DCI format 1_0) could activate/trigger both (SP/AP) CSI-RS(s) for measurement on the corresponding candidate cell and CSI reporting on/for the corresponding candidate cell. Optionally, when/if the one-bit indicator is set to ‘1’ (or ‘0’), (the UE could expect or assume that) the PDCCH order (and therefore, the corresponding DCI format 1_0) could activate/trigger only (SP/AP) CSI-RS(s) for measurement on the corresponding candidate cell, otherwise, i.e., when/if the one-bit indicator is set to ‘0’ (‘1’), (the UE could assume or expect that) the PDCCH order (and therefore, the corresponding DCI format 1_0) could activate/trigger only (SP/AP) CSI reporting on/for the corresponding candidate cell. Whether the one-bit indicator is present or not (absent) in the PDCCH order (and therefore, the corresponding DCI format 1_0) could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one-bit indicator as specified/defined herein is present in the PDCCH order (and therefore, the corresponding DCI format 1_0); otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one-bit indicator as specified/defined herein is not present or is absent in the PDCCH order (and therefore, the corresponding DCI format 1_0).
For another example, the PDCCH order (and therefore, the corresponding DCI format 1_0) could comprise or provide or include or contain a two-bit indicator; in this case, when/if the two-bit indicator is set to ‘00’ (or ‘01’ or ‘10’ or ‘11’), (the UE could expect or assume that) the PDCCH order (and therefore, the corresponding DCI format 1_0) could activate/trigger only (SP/AP) CSI-RS(s) for measurement on the corresponding candidate cell, when/if the two-bit indicator is set to ‘01’ (or ‘00’ or ‘10’ or ‘11’), (the UE could expect or assume that) the PDCCH order (and therefore, the corresponding DCI format 1_0) could activate/trigger only (SP/AP) CSI reporting on/for the corresponding candidate cell, and when/if the two-bit indicator is set to ‘10’ (or ‘00’ or ‘01’ or ‘11’), (the UE could assume or expect that) the PDCCH order (and therefore, the corresponding DCI format 1_0) could activate/trigger both (SP/AP) CSI-RS(s) for measurement on the corresponding candidate cell and CSI reporting on/for the corresponding candidate cell. Whether the two-bit indicator is present or not (absent) in the PDCCH order (and therefore, the corresponding DCI format 1_0) could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the two-bit indicator as specified/defined herein is present in the PDCCH order (and therefore, the corresponding DCI format 10); otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the two-bit indicator as specified/defined herein is not present or is absent in the PDCCH order (and therefore, the corresponding DCI format 1_0).
For another example, when/if a PDCCH order (and therefore, the corresponding DCI format 1_0) comprises a CSI request field according to or following those specified/defined herein in the present disclosure, and
   when/if the x-th codepoint of the CSI request field is indicated, (the UE could assume or expect that) the PDCCH order (and therefore, the corresponding DCI format 1_0) could activate/trigger only (SP/AP) CSI-RS(s) for measurement on the corresponding candidate cell,
   when/if the y-th codepoint of the CSI request field is indicated, (the UE could assume or expect that) the PDCCH order (and therefore, the corresponding DCI format 1_0) could activate/trigger only (SP/AP) CSI reporting on/for the corresponding candidate cell, and
   when/if the z-th codepoint of the CSI request field is indicated, (the UE could assume or expect that) the PDCCH order (and therefore, the corresponding DCI format 1_0) could activate/trigger both (SP/AP) CSI-RS(s) for measurement on the corresponding candidate cell and CSI reporting on/for the corresponding candidate cell.

In this case, the UE could determine or identify whether (some codepoint(s) of) the CSI request field can be used, applied or repurposed for indicating whether the PDCCH order (and therefore, the corresponding DCI format 1_0) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting for/on the corresponding candidate cell according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).
For another example, take into account an existing field in a PDCCH order (and therefore, the corresponding DCI format 1_0):
   when/if the x-th codepoint of the existing field is indicated, (the UE could assume or expect that) the PDCCH order (and therefore, the corresponding DCI format 1_0) could activate/trigger only (SP/AP) CSI-RS(s) for measurement on the corresponding candidate cell,
   when/if the y-th codepoint of the existing field is indicated, (the UE could assume or expect that) the PDCCH order (and therefore, the corresponding DCI format 1_0) could activate/trigger only (SP/AP) CSI reporting on/for the corresponding candidate cell, and
   when/if the z-th codepoint of the existing field is indicated, (the UE could assume or expect that) the PDCCH order (and therefore, the corresponding DCI format 1_0) could activate/trigger both (SP/AP) CSI-RS(s) for measurement on the corresponding candidate cell and CSI reporting on/for the corresponding candidate cell.

In this case, the UE could determine or identify whether (some codepoint(s) of) the existing field can be used, applied or repurposed for indicating whether the PDCCH order (and therefore, the corresponding DCI format 1_0) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting on/for the corresponding candidate cell according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).

In one example, when/if the PDCCH order (and therefore, the corresponding DCI format 1_0) can trigger at least AP CSI-RS(s) for measurement on/for the corresponding candidate cell according to or following those specified herein in the present disclosure, and the PDCCH order (and therefore, the corresponding DCI format 1_0) comprises a CSI request field according to or following those specified herein in the present disclosure,
the UE could first identify or determine a trigger state according to the indicated codepoint of the CSI request field, wherein the trigger state could be associated/specific/corresponding/linked to the corresponding candidate cell; e.g., the trigger state could be from the list of trigger state(s)—provided by CSI-AperiodicTriggerStateList—associated/corresponding/linked/specific to the corresponding candidate cell, and/or selected based on or according to the aperiodic trigger state(s) sub-selection MAC CE command/indication according to or based on those specified herein in the present disclosure (e.g., the LTM CSC MAC CE and/or the Msg2 RAR) could also provide or indicate the trigger state(s) for sub-selection, i.e., they could act as or provide same functionalities as the aperiodic trigger state(s) sub-selection MAC CE) associated/corresponding/linked/specific to the corresponding candidate cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding candidate cell;
   Each of the identified or determined one or more CSI reporting settings/CSI report configurations associated to a reportConfigId could be associated or linked or corresponding to a resource set (e.g., a NZP CSI-RS resource set or a SSB resource set) index/ID;
   The resource set index/ID and the reportConfigId could be provided in a/the same higher layer RRC signaling/parameter, e.g., CSI-AssociatedReportConfigInfo/LTM-CSI-AssociatedReportConfigInfo;
   The resource set (e.g., the NZP CSI-RS resource set or the SSB resource set) and/or one or more RS resources (e.g., NZP CSI-RS resource(s) or SSB(s)) in the resource set could be associated/specific/corresponding/linked to the corresponding candidate cell;
the UE could identify or determine one or more CSI resource settings/CSI resource configurations—each provided by CSI-ResourceConfig or LTM-CSI-ResourceConfig—associated/specific/linked/corresponding to the identified or determined one or more CSI reporting settings/CSI report configurations, wherein the identified or determined one or more CSI resource settings/CSI resource configurations could be associated/specific/corresponding/linked to the corresponding candidate cell;
   The UE could identify or determine a list of RS resource sets (e.g., a list of NZP CSI-RS resource set(s) or SSB resource set(s)) each comprising one or more RS resources including NZP CSI-RS resource(s) or SSB(s)—from or according to each of the identified or determined one or more CSI resource settings/CSI resource configurations;
   The identified or determined list or one or more RS resource sets in the list or one or more RS resources in one or more RS resource sets in the list could be associated/specific/corresponding/linked to the corresponding candidate cell;
for a CSI reporting setting/CSI report configuration associated/specific/corresponding/linked to the trigger state according to or following those specified herein in the present disclosure, the UE would identify or determine a resource set ID/index associated/specific/linked/corresponding to the CSI reporting setting/CSI reporting configuration according to or following those specified herein in the present disclosure, and a list of RS resource sets associated/specific/linked/corresponding to the CSI reporting setting/CSI reporting configuration according to or following those specified herein in the present disclosure. In this case, the resource set ID/index could point to an entry—hence, a measurement resource set—from/in the list of RS resource sets, wherein the measurement resource set could be or could correspond to a NZP CSI-RS resource set or a SSB resource set;
the UE could then measure the RS(s) including CSI-RS(s) corresponding to the RS resource(s) including NZP CSI-RS resource(s) in the measurement resource set on/for the corresponding candidate cell by assuming/applying a CSI-RS triggering offset X slot(s), wherein the X slot(s) could be specific to the measurement RS resource set. In particular, the aperiodic triggering offset X could be between the slot containing the PDCCH order (and therefore, the corresponding DCI format 1_0) that triggers the measurement RS resource set on/for the corresponding candidate cell and the slot in which the corresponding measurement RS resource set is transmitted.

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by aperiodicTriggerOffset, e.g., in LTM-Config, LTM-Candidate, LTM-CSI-ReportConfig, LTM-CSI-ResourceConfig, LTM-TCI-Info and/or etc. The value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. When the field or the higher layer parameter aperiodicTriggerOffset is absent, the UE could apply the value 0 of X.
   For another example, the PDCCH order (and therefore, the corresponding DCI format 1_0) could provide, contain, include or comprise one or more indicators to indicate the value(s) of X, e.g., via one or more new fields in the PDCCH order (and therefore, the corresponding DCI format 1_0). In one example, the value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. In another example, the value x of X could correspond to x slot(s). Whether the one or more indicators could be present or not (absent) in the PDCCH order (and therefore, the corresponding DCI format 1_0) could be higher layer configured. For instance, when/if a higher layer parameter triggeringOffsetPresentInPDCCHorder is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the PDCCH order (and therefore, the corresponding DCI format 10); otherwise, i.e., when/if the higher layer parameter triggeringOffsetPresentInPDCCHorder is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter triggeringOffsetPresentInPDCCHorder is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the PDCCH order (and therefore, the corresponding DCI format 1_0). When the one or more indicators mentioned herein are absent from/in the PDCCH order (and therefore, the corresponding DCI format 10), the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

In one example, when/if the PDCCH order (and therefore, the corresponding DCI format 1_0) can at least trigger AP CSI reporting and/or activate SP CSI reporting over PUSCH(s) on/for the corresponding candidate cell according to or following those specified herein in the present disclosure, and the PDCCH order (and therefore, the corresponding DCI format 1_0) comprises a CSI request field according to or following those specified herein in the present disclosure,
the UE could first identify or determine a trigger state according to the indicated codepoint of the CSI request field, wherein the trigger state could be associated/specific/corresponding/linked to the corresponding candidate cell; e.g., the trigger state could be from the list of trigger state(s)—provided by CSI-AperiodicTriggerStateList—associated/corresponding/linked/specific to the corresponding candidate cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the corresponding candidate cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding candidate cell; each of the identified or determined one or more CSI reporting settings/CSI report configurations associated to a reportConfigId could be associated or linked or corresponding to a list of report slot offset(s), e.g., provided by reportSlotOffsetList as specified/defined in [REF 6];

In this case, the UE could determine or identify the PUSCH resource(s) and the corresponding setting(s) for the PUSCH(s) to send or transmit or carry or convey the AP/SP CSI report(s) on/for the corresponding candidate cell according to the following procedure(s): when the UE could be scheduled to transmit a PUSCH with no transport block and/or with a CSI report(s) by a ‘CSI request’ field in the PDCCH order (and therefore, the corresponding DCI format 1_0) for the corresponding candidate cell as specified/defined herein in the present disclosure, the UE could be provided or indicated or configured by the network, e.g., via/in/by higher layer RRC signaling(s)/parameter(s) including LTM-Config, LTM-Candidate, LTM-CSI-ReportConfig, LTM-CSI-ResourceConfig, LTM-TCI-Info and/or etc. and/or MAC CE command(s) and/or dynamic DCI based L1 signaling(s) based on or according to a corresponding UE's capability or capability signaling, a value m providing a row index m+1 to the allocated table as defined in Clause 6.1.2.1.1 of [REF 4]. The indexed row defines the start and length indicator SLIV, or directly the start symbol S and the allocation length L, and the PUSCH mapping type to be applied in the PUSCH transmission and the K₂ value could be determined as

$${K}_{2} = {max}_{j} {Y}_{j} ( m + 1 ) ,$$

where Yⱼ for j=0, . . . , N_{Rep}−1 are the corresponding list entries of the list of report slot offset(s), e.g., provided by reportSlotOffsetList or reportSlotOffsetList-r17, associated/linked/specific/corresponding to the N_{Rep} determined or identified or triggered CSI reporting settings/CSI report configurations—e.g., in the corresponding higher layer parameter(s) CSI-ReportConfig(s) or LTM-CSI-ReportConfig(s), and Yⱼ(m+1) could correspond to the (m+1)-th entry of Y including the omitted CSI reporting settings/CSI report configurations triggered for non-active DL BWPs, where the UE may not expect that (m+1) is larger than 16. Here, the PDCCH order (and therefore, the corresponding DCI format 1_0) could comprise or provide or contain or include one or more fields to indicate the value m.
In one example, the value m could be provided or indicated by the time domain resource assignment (TDRA) field in the PDCCH order (and therefore, the corresponding DCI format 1_0).
In another example, the value m could be provided or indicated by a new field introduced in the PDCCH order (and therefore, the corresponding DCI format 1_0) dedicated for triggering AP CSI reporting and/or activating SP CSI reporting on/for the corresponding candidate cell.
In another example, the value m could be provided or indicated by repurposing one or more codepoints of one or more existing fields in the PDCCH order (and therefore, the corresponding DCI format 1_0) subject to network's configuration(s)/signaling(s) and/or UE's capability(s)/capability signaling(s).

In this case, the UE could start to apply or use the PUSCH resource(s) from or in (the first) slot(s) that is at least a number e.g., K₂ of slot(s) offset relative to or starting from or after the (first) slot that carries or provides or conveys the PDCCH order (and therefore, the corresponding DCI format 1_0) to carry or convey or send or transmit the SP/AP CSI report(s) for/on the corresponding candidate cell.

A UE (e.g., the UE 116) can be triggered a PRACH transmission on a candidate cell by a PDCCH order that the UE receives on a serving cell and includes an indication of the candidate cell for the PRACH transmission. In particular, if the CRC of the DCI format 1_0 is scrambled by C-RNTI and the “Frequency domain resource assignment” field are of ones, the DCI format 1_0 is for random access procedure initiated by a PDCCH order, with at least one cell indicator and/or cell indicator field set to ┌log₂(C+1)┐ or ┌log₂(C)┐ bits indicating the cell for the corresponding PRACH transmission if the UE is configured with higher layer parameter Early UlSyncConfig, where C is the number of candidate cells configured with higher layer parameter Early UlSyncConfig and/or in a/the subset of candidate cell(s)/candidate cell ID(s) for CSI acquisition in LTM operation(s) as specified/defined herein in the present disclosure; 0 bit otherwise. The bit index 0 of the cell indicator or the bit field index 0 of the cell indicator field is mapped to the serving cell, and other bit indexes or bit field indexes are mapped to the candidate cells configured with higher layer parameter Early UlSyncConfig and/or in a/the subset of candidate cell(s)/candidate cell ID(s) for CSI acquisition in LTM operation(s) as specified/defined herein in the present disclosure according to an ascending order of a candidate identity configured by ltm-CandidateId, with the bit index or bit field index 1 mapped to the candidate cell with the smallest candidate identity. According to or following those specified herein in the present disclosure, a UE could be triggered PRACH transmission(s) and/or CSI acquisition(s)—including triggering(s) of CSI/beam measurement(s)/reporting(s), measurement(s) of CSI-RS(s) e.g. for beam management, for CSI-RS and/or for mobility and/or CSI/beam reporting(s) for the LTM operation(s), e.g., before and/or during and/or after LTM cell switch—on one or more candidate cells (referred to as one or more reference candidate cells in the present disclosure) according to or provided by one or more cell indicators and/or cell indicator fields in a PDCCH order that the UE receives on a serving cell, wherein each of the one or more cell indicators/cell indicator fields could provide an indication of a candidate cell for a corresponding PRACH transmission and/or CSI acquisition. For each of the one or more (reference) candidate cells as specified/defined herein in the present disclosure, the corresponding PDCCH order could also provide or comprise or indicate a CSI request field for requesting CSI/CSI acquisition of the corresponding candidate cell according to or following those specified herein in the present disclosure.
In one example, the one or more cell indicators as specified/defined herein in the present disclosure could be respectively provided or indicated by the one or more cell indicator fields in the PDCCH order (and therefore, the corresponding DCI format 1_0).
In another example, the one or more cell indicators as specified/defined herein in the present disclosure could be provided or indicated by a single field (e.g., a new dedicated DCI field or a repurposed existing DCI field) in the PDCCH order (and therefore, the corresponding DCI format 1_0).
In another example, the one or more cell indicators as specified/defined herein in the present disclosure could be provided or indicated by one or more codepoints/bits of one or more existing DCI fields (e.g., by/via repurposing) in the PDCCH order (and therefore, the corresponding DCI format 1_0).

For each of the one or more (reference) candidate cells provided/indicated in a/the PDCCH order mentioned herein—denoted by a/the reference candidate cell thereafter, the UE could be provided or configured or indicated by the network, e.g., via/by/in higher layer RRC signaling(s)/parameter(s) and/or MAC CE command(s) and/or dynamic DCI based L1 signaling(s) based on or according to a corresponding UE's capability or capability signaling, whether the PDCCH order (and therefore, the corresponding DCI format 1_0) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting, for/on the corresponding reference candidate cell.

A UE could be triggered a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a (reference) candidate cell by a PDCCH order that the UE receives on a serving cell and includes an indication of the (reference) candidate cell for the PRACH transmission and/or the CSI acquisition, and a CSI request field for requesting CSI/CSI acquisition of at least the (reference) candidate cell. In particular, if the CRC of the DCI format 1_0 is scrambled by C-RNTI and the “Frequency domain resource assignment” field are of ones, the DCI format 1_0 is for random access procedure initiated by a PDCCH order, and with the following two fields or values set for a/the (reference) candidate cell as follows:
Cell indicator: ┌log₂(C+1)┐ or ┌log₂(C)┐ bits indicating the cell for the corresponding PRACH transmission if the UE is configured with higher layer parameter Early UlSyncConfig, where C is the number of candidate cells configured with higher layer parameter EarlyUlSyncConfig and/or in a/the subset of candidate cell(s)/candidate cell ID(s) for CSI acquisition in LTM operation(s) as specified/defined herein in the present disclosure; 0 bit otherwise. The bit index 0 of the cell indicator or the bit field index 0 of the cell indicator field is mapped to the serving cell, and other bit indexes or bit field indexes are mapped to the candidate cells configured with higher layer parameter EarlyUlSyncConfig and/or in a/the subset of candidate cell(s)/candidate cell ID(s) for CSI acquisition in LTM operation(s) as specified/defined herein in the present disclosure according to an ascending order of a candidate identity configured by ltm-CandidateId, with the bit index or bit field index 1 mapped to the candidate cell with the smallest candidate identity.
CSI request: x bit(s), e.g., x=0, 1, 2, 3, 4, 5 or 6 bits determined by higher layer parameter reportTriggerSize.
   In one example, this field could be associated/corresponding/specific/mapped (based on network's configuration(s)/signalling(s)) to a Cell indicator or Cell indicator field. In this case, if the cell indicated by the Cell indicator or Cell indicator field is the (reference) candidate cell, this field could be applied to the (reference) candidate cell. If the cell indicated by the Cell indicator or Cell indicator field is a serving cell but not the (reference) candidate cell, in one example, this field could be reserved; in another example, this field could be applied to the serving cell.
   In another example, this field could be applied to the reference candidate cells indicated/provided by the Cell indicator(s) or Cell indicator field(s) in the PDCCH order (and therefore, the corresponding DCI format 1_0).
   In another example, this field could be applied to one or more of (based on network's configuration(s)/signalling(s)) the reference candidate cells indicated/provided by the Cell indicator(s) or Cell indicator field(s) in the PDCCH order (and therefore, the corresponding DCI format 1_0).
   In another example, this field could be applied to the reference candidate cell with the smallest candidate cell ID/index among the reference candidate cells indicated/provided by the Cell indicator(s) or Cell indicator field(s) in the PDCCH order (and therefore, the corresponding DCI format 1_0).

In this case, a UE could receive a PDCCH order (e.g., in DCI format 1_0) on a serving cell that includes Cell indicator(s)/Cell indicator field(s) and x-bit CSI request field(s)/indicator(s) for the one or more (reference) candidate cells provided/indicated in a/the PDCCH order according to or following those specified herein in the present disclosure, wherein x=0, 1, 2, 3, 4, 5, 6, . . . , and x could be less than or equal to x_max. For this design example, the UE could be provided or indicated by the network, e.g., via higher layer RRC signaling(s)/parameter(s) e.g. in/by LTM-Config, LTM-Candidate, LTM-CSI-ReportConfig, LTM-CSI-ResourceConfig, LTM-TCI-Info and/or etc., whether or not the x-bit CSI request field/indication is present in the PDCCH order (and therefore, the corresponding DCI format, e.g., 1_0). For instance, when/if a higher layer parameter csiRequestInPDCCHorder is provided/configured, e.g., in LTM-Config, LTM-Candidate, LTM-CSI-ReportConfig, LTM-CSI-ResourceConfig, LTM-TCI-Info and/or etc., and/or is set to ‘enabled’, the UE could expect to receive in the PDCCH order (and therefore, the corresponding DCI format e.g. 1_0) that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a reference candidate cell—e.g., indicated by a corresponding Cell indicator or Cell indicator field, the corresponding x-bit CSI request field with valid value(s), i.e., x would be greater than or equal to 1. Otherwise, i.e., when/if the higher layer parameter csiRequestInPDCCHorder is not present or provided/configured and/or is absent, e.g., in LTM-Config, LTM-Candidate, LTM-CSI-ReportConfig, LTM-CSI-ResourceConfig, LTM-TCI-Info and/or etc., and/or is present or provided/configured, e.g., in LTM-Config, LTM-Candidate, LTM-CSI-ReportConfig, LTM-CSI-ResourceConfig, LTM-TCI-Info and/or etc., and is set to ‘disabled’, the UE may not expect to receive in the PDCCH order that triggers a PRACH transmission and/or CSI acquisition on a reference candidate cell—e.g., indicated by a corresponding Cell indicator or Cell indicator field, a corresponding CSI request field with valid value(s), and/or the UE could expect that the corresponding CSI request field, if indicated or provided in the PDCCH order (and therefore, the corresponding DCI format, e.g., 1_0) for the reference candidate cell, is a 0-bit field, i.e., x=0, and/or the UE could expect that the CSI request field, if indicated or provided in the PDCCH order (and therefore, the corresponding DCI format 1_0) for the reference candidate cell, has value 0 or zero value. In this case, when/if the UE does not receive in the PDCCH order any CSI request field(s), and/or the UE receives in the PDCCH order 0-bit CSI request field(s) and/or zero-valued CSI request field(s), the UE could expect that CSI acquisition(s) including triggering(s) of CSI/beam measurement(s)/reporting(s), measurement(s) of CSI-RS(s) e.g. for beam management, for CSI-RS and/or for mobility and/or CSI/beam reporting(s) is not enabled or supported before and/or during and/or after the LTM cell switch (for RACH-based and/or RACH-less LTM cell switch), e.g., for/on the corresponding reference candidate cell(s), e.g., indicated by the corresponding Cell indicator(s) or Cell indicator field(s). The UE could determine or identify the value(s) of x and/or x_max according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s).
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's. For this design example, a trigger state could be initiated using a non-zero CSI request field in the PDCCH order (and therefore, the corresponding DCI format e.g. 1_0) received on a serving cell that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a reference candidate cell—e.g., indicated by a corresponding Cell indicator or Cell indicator field, and when the bits/codepoints of the CSI request field in the PDCCH order (and therefore, the corresponding DCI format e.g. 1_0) are set to zero(s), no CSI for LTM operation (e.g., before and/or during and/or after the LTM cell switch) is requested for the reference candidate cell, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding reference candidate cell—e.g., indicated by the corresponding Cell indicator or Cell indicator field. Alternatively or optionally, when/if the UE is not configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's, no CSI for LTM operation (e.g., before and/or during and/or after the LTM cell switch) is requested for a corresponding reference candidate cell, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding reference candidate cell indicated by the corresponding Cell indicator or Cell indicator field.
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of 2^{M}^{_{TS}}−1 trigger states provided by CSI-AperiodicTriggerStateList each associated to one or more CSI-ReportConfig's and/or one or more LTM-CSI-ReportConfig's. For this design example, when/if a non-zero CSI request field is provided or indicated in PDCCH order (and therefore the corresponding DCI format e.g. 1_0) that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) on a reference candidate cell—e.g., indicated by a corresponding Cell indicator or Cell indicator field, a trigger state could be initiated using a non-zero CSI request field in the PDCCH order (and therefore, the corresponding DCI format e.g. 1_0), and the CSI request field in the PDCCH order can directly indicate the trigger state, e.g., out of the 2^{M}^{_{TS}}−1 configured/provided trigger states in the CSI-AperiodicTriggerStateList. That is, in this case, the number of bits of/in the CSI request field (i.e., the x-bit CSI request field in the PDCCH order as specified/defined herein in the present disclosure) is x=M_{TS}. The UE could determine or identify the value(s) of M_{TS} according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of M_{TS} trigger states provided by CSI-AperiodicTriggerStateList each associated to one or more CSI-ReportConfig's and/or one or more LTM-CSI-ReportConfig's. For this design example, when/if a non-zero CSI request field is provided or indicated in a PDCCH order (and therefore, the corresponding DCI format e.g. 1_0) that triggers a PRACH transmission and/or CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch, on a reference candidate cell—e.g., indicated by a corresponding Cell indicator or Cell indicator field, a trigger state could be initiated using the non-zero CSI request field in the PDCCH order. For this design example,
   When the number of configured (CSI) trigger states in CSI-AperiodicTriggerStateList is greater than or equal to 2^{N}^{_{TS}}−1 (i.e., M_{TS}>2^{N}^{_{TS}}−1), where N_{TS} is the number of bits of/in the CSI request field, i.e., x=N_{TS} for the x-bit CSI request field in the PDCCH order (and therefore, the corresponding DCI format e.g. 1_0) as specified/defined herein in the present disclosure, the UE could receive a sub-selection MAC CE command/indication, used to map up to 2^{N}^{_{TS}}−1 trigger states to the bits/codepoints of the CSI request field in the PDCCH order (and therefore, the corresponding DCI format e.g. 1_0). Here, N_{TS} could be provided or configured by a higher layer parameter reportTriggerSize where e.g. N_{TS}∈{0, 1, 2, 3, 4, 5, 6} or N_{TS}∈{1, 2, 3, 4, 5, 6} or N_{TS}∈{0, . . . , x_max} or N_{TS}∈{1, . . . , x_max}. When the UE would transmit a PUCCH with HARQ-ACK information in slot n corresponding to the PDSCH carrying the sub-selection MAC CE command/indication, UE assumption on the mapping of the selected CSI trigger state(s) to the codepoint(s)/bit(s) of the CSI request field in the PDCCH order according to or following those specified herein in the present disclosure could be applied starting from the first slot that is after slot

$$n + 3 {N}_{slot}^{subframe , μ} + \frac{{2}^{μ}}{{2}^{{μ}_{K}} mac} \cdot {k}_{mac}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided.
   When the number of configured (CSI) trigger states in CSI-AperiodicTriggerStateList is less than or equal to 2^{N}^{_{TS}}−1 (i.e., M_{TS}≤2^{N}^{_{TS}}−1), where N_{TS} is the number of bits of/in the CSI request field, i.e., x=N_{TS} for the x-bit CSI request field in the PDCCH order (and therefore, the corresponding DCI format e.g. 1_0) as specified/defined herein in the present disclosure, the CSI request field in the PDCCH order can directly indicate the trigger state, e.g., out of the M_{TS} configured/provided trigger states in the CSI-AperiodicTriggerStateList.

According to or following those specified herein in the present disclosure, a UE could be triggered PRACH transmission(s) and/or CSI acquisition(s)—including triggering(s) of CSI/beam measurement(s)/reporting(s), measurement(s) of CSI-RS(s) e.g. for beam management, for CSI-RS and/or for mobility and/or CSI/beam reporting(s) for the LTM operation(s), e.g., before and/or during and/or after LTM cell switch—on one or more candidate cells (referred to as one or more reference candidate cells in the present disclosure) by a PDCCH order that the UE receives on a serving cell, wherein the PDCCH order (and therefore the corresponding DCI format 1_0) could include an indication of each of the reference candidate cells for a corresponding PRACH transmission and/or CSI acquisition, and a CSI request field for requesting CSI/CSI acquisition of the corresponding reference candidate cell according to or following those specified herein in the present disclosure. For each of the one or more reference candidate cells mentioned herein—denoted by a/the reference candidate cell, the UE could be provided or configured or indicated by the network, e.g., via/by/in higher layer RRC signaling(s)/parameter(s) and/or MAC CE command(s) and/or dynamic DCI based L1 signaling(s) based on or according to a corresponding UE's capability or capability signaling, whether the PDCCH order (and therefore, the corresponding DCI format 1_0) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting, for/on the corresponding reference candidate cell.
For example, the UE could be configured or provided by the network, e.g., in LTM-Config, LTM-Candidate, LTM-CSI-ReportConfig, LTM-CSI-ResourceConfig, LTM-TCI-Info and/or etc., a higher layer parameter ltmMeasureReport. When/if the higher layer parameter ltmMeasureReport is provided, configured or present and/or set to ‘enabled’ and/or ‘measure Only’, the UE could expect or assume that the PDCCH order (and therefore, the corresponding DCI format 1_0) could activate/trigger only (SP/AP) CSI-RS(s) for measurement on the corresponding reference candidate cell; when/if the higher layer parameter ltmMeasureReport is provided, configured or present and/or set to ‘enabled’ and/or ‘reportOnly’, the UE could expect or assume that the PDCCH order (and therefore, the corresponding DCI format 1_0) could activate/trigger only (SP/AP) CSI reporting on/for the corresponding reference candidate cell; and when/if the higher layer parameter ltmMeasureReport is provided, configured or present and/or set to ‘enabled’ and/or ‘bothMeasureReport’, the UE could expect or assume that the PDCCH order (and therefore, the corresponding DCI format 1_0) could activate/trigger both (SP/AP) CSI-RS(s) for measurement on the corresponding reference candidate cell and CSI reporting on/for the corresponding reference candidate cell. Optionally, when/if the higher layer parameter ltmMeasureReport is not provided or present or configured or is absent, or the higher layer parameter ltmMeasureReport is provided, configured or present but set to ‘disabled’, the UE could expect or assume that the PDCCH order (and therefore, the corresponding DCI format 1_0) could activate/trigger (i) only (SP/AP) CSI-RS(s) for measurement on the corresponding reference candidate cell, (ii) only (SP/AP) CSI reporting on/for the corresponding reference candidate cell, or (iii) both (SP/AP) CSI-RS(s) for measurement on the corresponding reference candidate cell and CSI reporting on/for the corresponding reference candidate cell, according to or based on (a) fixed value(s)/rule(s) in system specification(s) and/or per RRC (re-)configuration/setup, (b) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (c) UE's autonomous determination or selection, which could be further sent to the network via various UL channels/signals e.g. via/in part of beam/CSI report(s) and/or UE's capability signaling(s).
For another example, the PDCCH order (and therefore, the corresponding DCI format 1_0) could comprise or provide or include or contain a one-bit indicator; in this case, when/if the one-bit indicator is set to ‘1’ (or ‘0’), (the UE could expect or assume that) the PDCCH order (and therefore, the corresponding DCI format 1_0) could activate/trigger only (SP/AP) CSI-RS(s) for measurement on the corresponding reference candidate cell, otherwise, i.e., when/if the one-bit indicator is set to ‘0’ (‘1’), (the UE could assume or expect that) the PDCCH order (and therefore, the corresponding DCI format 1_0) could activate/trigger both (SP/AP) CSI-RS(s) for measurement on the corresponding reference candidate cell and CSI reporting on/for the corresponding reference candidate cell. Alternatively, when/if the one-bit indicator is set to ‘1’ (or ‘0’), (the UE could expect or assume that) the PDCCH order (and therefore, the corresponding DCI format 1_0) could activate/trigger only (SP/AP) CSI reporting on/for the corresponding reference candidate cell, otherwise, i.e., when/if the one-bit indicator is set to ‘0’ (‘1’), (the UE could assume or expect that) the PDCCH order (and therefore, the corresponding DCI format 1_0) could activate/trigger both (SP/AP) CSI-RS(s) for measurement on the corresponding reference candidate cell and CSI reporting on/for the corresponding reference candidate cell. Optionally, when/if the one-bit indicator is set to ‘1’ (or ‘0’), (the UE could expect or assume that) the PDCCH order (and therefore, the corresponding DCI format 1_0) could activate/trigger only (SP/AP) CSI-RS(s) for measurement on the corresponding reference candidate cell, otherwise, i.e., when/if the one-bit indicator is set to ‘0’ (‘1’), (the UE could assume or expect that) the PDCCH order (and therefore, the corresponding DCI format 1_0) could activate/trigger only (SP/AP) CSI reporting on/for the corresponding reference candidate cell. Whether the one-bit indicator is present or not (absent) in the PDCCH order (and therefore, the corresponding DCI format 1_0) could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one-bit indicator as specified/defined herein is present in the PDCCH order (and therefore, the corresponding DCI format 1_0) for the corresponding reference candidate cell; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one-bit indicator as specified/defined herein is not present or is absent in the PDCCH order (and therefore, the corresponding DCI format 1_0) for the corresponding reference candidate cell.
For another example, the PDCCH order (and therefore, the corresponding DCI format 1_0) could comprise or provide or include or contain a two-bit indicator; in this case, when/if the two-bit indicator is set to ‘00’ (or ‘01’ or ‘10’ or ‘11’), (the UE could expect or assume that) the PDCCH order (and therefore, the corresponding DCI format 1_0) could activate/trigger only (SP/AP) CSI-RS(s) for measurement on the corresponding reference candidate cell, when/if the two-bit indicator is set to ‘01’ (or ‘00’ or ‘10’ or ‘11’), (the UE could expect or assume that) the PDCCH order (and therefore, the corresponding DCI format 1_0) could activate/trigger only (SP/AP) CSI reporting on/for the corresponding reference candidate cell, and when/if the two-bit indicator is set to ‘10’ (or ‘00’ or ‘01’ or ‘11’), (the UE could assume or expect that) the PDCCH order (and therefore, the corresponding DCI format 1_0) could activate/trigger both (SP/AP) CSI-RS(s) for measurement on the corresponding reference candidate cell and CSI reporting on/for the corresponding reference candidate cell. Whether the two-bit indicator is present or not (absent) in the PDCCH order (and therefore, the corresponding DCI format 1_0) could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the two-bit indicator as specified/defined herein is present in the PDCCH order (and therefore, the corresponding DCI format 1_0) for the corresponding reference candidate cell; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the two-bit indicator as specified/defined herein is not present or is absent in the PDCCH order (and therefore, the corresponding DCI format 1_0) for the corresponding reference candidate cell.
For another example, when/if a PDCCH order (and therefore, the corresponding DCI format 1_0) comprises a CSI request field for a reference candidate cell according to or following those specified/defined herein in the present disclosure, and
   when/if the x-th codepoint of the CSI request field is indicated, (the UE (e.g., the UE 116) could assume or expect that) the PDCCH order (and therefore, the corresponding DCI format 1_0) could activate/trigger only (SP/AP) CSI-RS(s) for measurement on the corresponding reference candidate cell,
   when/if the y-th codepoint of the CSI request field is indicated, (the UE could assume or expect that) the PDCCH order (and therefore, the corresponding DCI format 1_0) could activate/trigger only (SP/AP) CSI reporting on/for the corresponding reference candidate cell, and
   when/if the z-th codepoint of the CSI request field is indicated, (the UE could assume or expect that) the PDCCH order (and therefore, the corresponding DCI format 1_0) could activate/trigger both (SP/AP) CSI-RS(s) for measurement on the corresponding reference candidate cell and CSI reporting on/for the corresponding reference candidate cell.

In this case, the UE could determine or identify whether (some codepoint(s) of) the CSI request field for a reference candidate cell can be used, applied or repurposed for indicating whether the PDCCH order (and therefore, the corresponding DCI format 1_0) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting for the corresponding reference candidate cell according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).
For another example, take into account an existing field in a PDCCH order (and therefore, the corresponding DCI format 1_0) for a reference candidate cell:
   when/if the x-th codepoint of the existing field is indicated, (the UE could assume or expect that) the PDCCH order (and therefore, the corresponding DCI format 1_0) could activate/trigger only (SP/AP) CSI-RS(s) for measurement on the corresponding reference candidate cell,
   when/if the y-th codepoint of the existing field is indicated, (the UE could assume or expect that) the PDCCH order (and therefore, the corresponding DCI format 1_0) could activate/trigger only (SP/AP) CSI reporting on/for the corresponding reference candidate cell, and
   when/if the z-th codepoint of the existing field is indicated, (the UE could assume or expect that) the PDCCH order (and therefore, the corresponding DCI format 1_0) could activate/trigger both (SP/AP) CSI-RS(s) for measurement on the corresponding candidate cell and CSI reporting on/for the corresponding reference candidate cell.

In this case, the UE could determine or identify whether (some codepoint(s) of) the existing field for a reference candidate cell can be used, applied or repurposed for indicating whether the PDCCH order (and therefore, the corresponding DCI format 1_0) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting for the corresponding reference candidate cell according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).

In one example, when/if the PDCCH order (and therefore, the corresponding DCI format 1_0) can trigger at least AP CSI-RS(s) for measurement on/for at least a reference candidate cell indicated therein according to or following those specified herein in the present disclosure, and the PDCCH order (and therefore, the corresponding DCI format 1_0) comprises a CSI request field for at least the reference candidate cell according to or following those specified herein in the present disclosure, wherein the UE could determine or identity the reference candidate cell here—e.g., out of or from the indicated reference candidate cell(s) in/by the PDCCH order—according to or based on: (1) fixed value(s)/rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s),
the UE could first identify or determine a trigger state according to the indicated codepoint of the CSI request field, wherein the trigger state could be associated/specific/corresponding/linked to the corresponding reference candidate cell; e.g., the trigger state could be from the list of trigger state(s)—provided by CSI-AperiodicTriggerStateList—associated/corresponding/linked/specific to the corresponding reference candidate cell, and/or selected based on or according to the aperiodic trigger state(s) sub-selection MAC CE command/indication according to or based on those specified herein in the present disclosure (e.g., the LTM CSC MAC CE and/or the Msg2 RAR) could also provide or indicate the trigger state(s) for sub-selection, i.e., they could act as or provide same functionalities as the aperiodic trigger state(s) sub-selection MAC CE) associated/corresponding/linked/specific to the corresponding reference candidate cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding reference candidate cell;
   Each of the identified or determined one or more CSI reporting settings/CSI report configurations associated to a reportConfigId could be associated or linked or corresponding to a resource set (e.g., a NZP CSI-RS resource set or a SSB resource set) index/ID;
   The resource set index/ID and the reportConfigId could be provided in a/the same higher layer RRC signaling/parameter, e.g., CSI-AssociatedReportConfigInfo/LTM-CSI-AssociatedReportConfigInfo;
   The resource set (e.g., the NZP CSI-RS resource set or the SSB resource set) and/or one or more RS resources (e.g., NZP CSI-RS resource(s) or SSB(s)) in the resource set could be associated/specific/corresponding/linked to the corresponding reference candidate cell;
the UE could identify or determine one or more CSI resource settings/CSI resource configurations—each provided by CSI-ResourceConfig or LTM-CSI-ResourceConfig—associated/specific/linked/corresponding to the identified or determined one or more CSI reporting settings/CSI report configurations, wherein the identified or determined one or more CSI resource settings/CSI resource configurations could be associated/specific/corresponding/linked to the corresponding reference candidate cell;
   The UE could identify or determine a list of RS resource sets (e.g., a list of NZP CSI-RS resource set(s) or SSB resource set(s)) each comprising one or more RS resources including NZP CSI-RS resource(s) or SSB(s)—from or according to each of the identified or determined one or more CSI resource settings/CSI resource configurations;
   The identified or determined list or one or more RS resource sets in the list or one or more RS resources in one or more RS resource sets in the list could be associated/specific/corresponding/linked to the corresponding reference candidate cell;
for a CSI reporting setting/CSI report configuration associated/specific/corresponding/linked to the trigger state according to or following those specified herein in the present disclosure, the UE would identify or determine a resource set ID/index associated/specific/linked/corresponding to the CSI reporting setting/CSI reporting configuration according to or following those specified herein in the present disclosure, and a list of RS resource sets associated/specific/linked/corresponding to the CSI reporting setting/CSI reporting configuration according to or following those specified herein in the present disclosure. In this case, the resource set ID/index could point to an entry—hence, a measurement resource set—from/in the list of RS resource sets, wherein the measurement resource set could be or could correspond to a NZP CSI-RS resource set or a SSB resource set;
the UE could then measure the RS(s) including CSI-RS(s) corresponding to the RS resource(s) including NZP CSI-RS resource(s) in the measurement resource set on/for the corresponding reference candidate cell by assuming/applying a CSI-RS triggering offset X slot(s), wherein the X slot(s) could be specific to the measurement RS resource set. In particular, the aperiodic triggering offset X could be between the slot containing the PDCCH order (and therefore, the corresponding DCI format 1_0) that triggers the measurement RS resource set on/for the corresponding reference candidate cell and the slot in which the corresponding measurement RS resource set is transmitted.

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by aperiodicTriggerOffset, e.g., in LTM-Config, LTM-Candidate, LTM-CSI-ReportConfig, LTM-CSI-ResourceConfig, LTM-TCI-Info and/or etc. The value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. When the field or the higher layer parameter aperiodicTriggerOffset is absent, the UE could apply the value 0 of X.
   For another example, the PDCCH order (and therefore, the corresponding DCI format 1_0) could provide, contain, include or comprise one or more indicators to indicate the value(s) of X, e.g., via one or more new fields in the PDCCH order (and therefore, the corresponding DCI format 1_0). In one example, the value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. In another example, the value x of X could correspond to x slot(s). Whether the one or more indicators could be present or not (absent) in the PDCCH order (and therefore, the corresponding DCI format 1_0) could be higher layer configured. For instance, when/if a higher layer parameter triggeringOffsetPresentInPDCCHorder is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the PDCCH order (and therefore, the corresponding DCI format 10); otherwise, i.e., when/if the higher layer parameter triggeringOffsetPresentInPDCCHorder is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter triggeringOffsetPresentInPDCCHorder is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the PDCCH order (and therefore, the corresponding DCI format 1_0). When the one or more indicators mentioned herein are absent from/in the PDCCH order (and therefore, the corresponding DCI format 10), the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

In one example, when/if the PDCCH order (and therefore, the corresponding DCI format 1_0) can at least trigger AP CSI reporting and/or SP CSI reporting over PUSCH(s) on/for at least a reference candidate cell according to or following those specified herein in the present disclosure, and the PDCCH order (and therefore, the corresponding DCI format 1_0) comprises a CSI request field for at least the reference candidate cell according to or following those specified herein in the present disclosure, wherein the UE could determine or identity the reference candidate cell here—e.g., out of or from the indicated reference candidate cell(s) in/by the PDCCH order—according to or based on: (1) fixed value(s)/rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s),
the UE could first identify or determine a trigger state according to the indicated codepoint of the CSI request field, wherein the trigger state could be associated/specific/corresponding/linked to the corresponding reference candidate cell; e.g., the trigger state could be from the list of trigger state(s)—provided by CSI-AperiodicTriggerStateList—associated/corresponding/linked/specific to the corresponding reference candidate cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the corresponding reference candidate cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding reference candidate cell; each of the identified or determined one or more CSI reporting settings/CSI report configurations associated to a reportConfigId could be associated or linked or corresponding to a list of report slot offset(s), e.g., provided by reportSlotOffsetList as specified/defined in [REF 6].

In this case, the UE could determine or identify the PUSCH resource(s) and the corresponding setting(s) for the PUSCH(s) to send or transmit or carry or convey the AP/SP CSI report(s) on/for the corresponding reference candidate cell according to the following procedure(s): when the UE could be scheduled to transmit a PUSCH with no transport block and/or with a CSI report(s) by a ‘CSI request’ field in the PDCCH order (and therefore, the corresponding DCI format 1_0) for at least the corresponding reference candidate cell as specified/defined herein in the present disclosure, the UE could be provided or indicated or configured by the network, e.g., via/in/by higher layer RRC signaling(s)/parameter(s) including LTM-Config, LTM-Candidate, LTM-CSI-ReportConfig, LTM-CSI-ResourceConfig, LTM-TCI-Info and/or etc. and/or MAC CE command(s) and/or dynamic DCI based L1 signaling(s) based on or according to a corresponding UE's capability or capability signaling, a value m providing a row index m+1 to the allocated table as defined in Clause 6.1.2.1.1 of [REF 4]. The indexed row defines the start and length indicator SLIV, or directly the start symbol S and the allocation length L, and the PUSCH mapping type to be applied in the PUSCH transmission and the K₂ value could be determined as

$${K}_{2} = {max}_{j} {Y}_{j} ( m + 1 ) ,$$

where Yⱼ for j=0, . . . , N_{Rep}−1 are the corresponding list entries of the list of report slot offset(s), e.g., provied y reportSlotOffsetList or reportSlotOffsetList-r17, associated/linked/specific/corresponding to the N_{Rep} determined or identified or triggered CSI reporting settings/CSI report configurations—e.g., in the corresponding higher layer parameter(s) CSI-ReportConfig(s) or LTM-CSI-ReportConfig(s), and Yⱼ(m+1) could correspond to the (m+1)-th entry of Y including the omitted CSI reporting settings/CSI report configurations triggered for non-active DL BWPs, where the UE may not expect that (m+1) is larger than 16. Here, the PDCCH order (and therefore, the corresponding DCI format 1_0) could comprise or provide or contain or include one or more fields to indicate the value m.
In one example, the value m could be provided or indicated by the time domain resource assignment (TDRA) field in the PDCCH order (and therefore, the corresponding DCI format 1_0) associated/corresponding/specific/mapped to the corresponding reference candidate cell.
In another example, the value m could be provided or indicated by a new field introduced in the PDCCH order (and therefore, the corresponding DCI format 1_0) dedicated for triggering AP CSI reporting and/or activating SP CSI reporting on/for the corresponding reference candidate cell.
In another example, the value m could be provided or indicated by repurposing one or more codepoints of one or more existing fields in the PDCCH order (and therefore, the corresponding DCI format 1_0) subject to network's configuration(s)/signaling(s) and/or UE's capability(s)/capability signaling(s).

In this case, the UE could start to apply or use the PUSCH resource(s) from or in (the first) slot(s) that is at least a number e.g., K₂ of slot(s) offset relative to or starting from or after the (first) slot that carries or provides or conveys the PDCCH order (and therefore, the corresponding DCI format 1_0) to carry or send or convey or transmit the AP/SP CSI report(s) for/on the corresponding reference candidate cell. The design examples/procedures related to the PDCCH order (and therefore, the corresponding DCI format 1_0) could be equally extended or applied to other DCI formats including DCI format(s) 0_0/0_1/0_2/0_3 and/or 1_1/1_2/1_3 by replacing the PDCCH order (and therefore the corresponding DCI format 1_0) in the design examples/procedures specified/defined herein in the present disclosure with/by a DCI format 0_0/0_1/0_2/0_3/1_1/1_2/1_3.

In one example, when/if the PDCCH order (and therefore, the corresponding DCI format 1_0) can at least trigger AP CSI reporting and/or SP CSI reporting over PUSCH(s) on/for at least a reference candidate cell according to or following those specified herein in the present disclosure, and the PDCCH order (and therefore, the corresponding DCI format 1_0) comprises a CSI request field for at least the reference candidate cell according to or following those specified herein in the present disclosure, wherein the UE could determine or identity the reference candidate cell here—e.g., out of or from the indicated reference candidate cell(s) in/by the PDCCH order—according to or based on: (1) fixed value(s)/rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s),

TABLE 2
Candidate cells indicator in DCI format
1_0 (PDCCH order)/0_3/1_3

| Bit field mapped | |
|---|---|
| to index | Scheduled cells |
| 0 | The candidate cells configured by the 1^{st} entry in |
| | candidateCellComboListDCI |
| 1 | The candidate cells configured by the 2^{nd} entry in |
| | candidateCellComboListDCI |
| 2 | The candidate cells configured by the 3^{rd} entry in |
| | candidateCellComboListDCI, if any |
| 3 | The candidate cells configured by the 4^{th} entry in |
| | candidateCellComboListDCI, if any |
| 4 | The candidate cells configured by the 5^{th} entry in |
| | candidateCellComboListDCI, if any |
| 5 | The candidate cells configured by the 6^{th} entry in |
| | candidateCellComboListDCI, if any |
| 6 | The candidate cells configured by the 7^{th} entry in |
| | candidateCellComboListDCI, if any |
| 7 | The candidate cells configured by the 8^{th} entry in |
| | candidateCellComboListDCI, if any |
| 8 | The candidate cells configured by the 9^{th} entry in |
| | candidateCellComboListDCI, if any |
| 9 | The candidate cells configured by the 10^{th} entry in |
| | candidateCellComboListDCI, if any |
| 10 | The candidate cells configured by the 11^{th} entry in |
| | candidateCellComboListDCI, if any |
| 11 | The candidate cells configured by the 12^{th} entry in |
| | candidateCellComboListDCI, if any |
| 12 | The candidate cells configured by the 13^{th} entry in |
| | candidateCellComboListDCI, if any |
| 13 | The candidate cells configured by the 14^{th} entry in |
| | candidateCellComboListDCI, if any |
| 14 | The candidate cells configured by the 15^{th} entry in |
| | candidateCellComboListDCI, if any |
| 15 | The candidate cells configured by the 16^{th} entry in |
| | candidateCellComboListDCI, if any |

A UE (e.g., the UE 116) could receive a DCI—e.g., a PDCCH order of DCI format 1_0 or a DCI format 0_3 or a DCI format 1_3—on a serving cell that includes a Candidate cells indicator and a x-bit CSI request field/indicator set as follows, wherein x=0, 1, 2, 3, 4, 5, 6, . . . , and x could be less than or equal to x_max:
Candidate cells indicator—number of bits determined by the following:
   0 bit if a/the higher layer parameter candidateCellComboListDCI is not configured; Otherwise ┌log₂(I+1)┐ or ┌log₂(I)┐ bits indicating the candidate cells (denoted by or referred to as reference candidate cells) in the candidate cell set, e.g., according to TABLE 2, where I is the number of entries in the higher layer parameter candidateCellComboListDCI, and/or each entry in the higher layer parameter candidateCellComboListDCI could (only) comprise candidate cells in a/the subset of candidate cell(s)/candidate cell ID(s) for CSI acquisition in LTM operation(s) as specified/defined herein in the present disclosure. If only one entry is configured in the higher layer parameter candidateCellComboListDCI, the candidate cells are the cells configured by the higher layer parameter candidateCellComboListDCI;
   Note here that each entry configured in the higher layer parameter candidateCellComboListDCI could comprise one or more candidate cells or candidate cell IDs or candidate cell indexes (e.g., corresponding to a candidate cell set), and the higher layer parameter candidateCellComboListDCI could have similar or even same structure and/or parameter(s) setting(s) to or as the higher layer parameter scheduledCellComboListDCI-0-3.
CSI request: x bit(s), e.g., x=0, 1, 2, 3, 4, 5 or 6 bits determined by higher layer parameter reportTriggerSize.
   In one example, this field could be applied to the reference candidate cells indicated by Candidate cells indicator field.
   In another example, this field could be applied to the reference candidate cell with the smallest candidate cell ID/index among the reference candidate cells indicated by Candidate cells indicator field.

When/if the received DCI mentioned herein is of DCI format 0_3, the Candidate cells indicator field here could correspond to or could be equivalent to or could be the same as the Scheduled cells indicator field; in this case, the CSI request field could be applied to the reference candidate cell (or cell) with the smallest candidate cell ID/index (or the smallest serving cell index) among the reference candidate cells (or the scheduled cells) indicated by Candidate cells indicator field (or Scheduled cells indicator field or Frequency domain resource assignment field) or the reference candidate cells (or the scheduled cells) indicated by Candidate cells indicator field (or Scheduled cells indicator field or Frequency domain resource assignment field). For this design example, the UE could be provided or indicated by the network, e.g., via higher layer RRC signaling(s)/parameter(s) e.g. in/by LTM-Config, LTM-Candidate, LTM-CSI-ReportConfig, LTM-CSI-ResourceConfig, LTM-TCI-Info and/or etc., whether or not the x-bit CSI request field/indication for one or more reference candidate cells as defined herein in the present disclosure is present in the DCI (e.g., a PDCCH order of DCI format 1_0 or a DCI format 0_3 or a DCI format 1_3). For instance, when/if a higher layer parameter csiRequestInDCI is provided/configured, e.g., in LTM-Config, LTM-Candidate, LTM-CSI-ReportConfig, LTM-CSI-ResourceConfig, LTM-TCI-Info and/or etc., and/or is set to ‘enabled’, the UE could expect to receive in the DCI (e.g., a PDCCH order of DCI format 1_0 or a DCI format 0_3 or a DCI format 1_3), the x-bit CSI request field for the one or more reference candidate cells as specified/defined herein in the present disclosure with valid value(s), i.e., x would be greater than or equal to 1. Otherwise, i.e., when/if the higher layer parameter csiRequestInDCI is not present or provided/configured and/or is absent, e.g., in LTM-Config, LTM-Candidate, LTM-CSI-ReportConfig, LTM-CSI-ResourceConfig, LTM-TCI-Info and/or etc., and/or is present or provided/configured, e.g., in LTM-Config, LTM-Candidate, LTM-CSI-ReportConfig, LTM-CSI-ResourceConfig, LTM-TCI-Info and/or etc., and is set to ‘disabled’, the UE may not expect to receive in the DCI (e.g., a PDCCH order of DCI format 1_0 or a DCI format 0_3 or a DCI format 13), a CSI request field for the one or more reference candidate cells with valid value(s), and/or the UE could expect that the CSI request field for the one or more reference candidate cells, if indicated or provided in the DCI (e.g., a PDCCH order of DCI format 1_0 or a DCI format 0_3 or a DCI format 13), is a 0-bit field, i.e., x=0, and/or the UE could expect that the CSI request field for the one or more reference candidate cells, if indicated or provided in the DCI (e.g., a PDCCH order of DCI format 1_0 or a DCI format 0_3 or a DCI format 1_3), has value 0 or zero value. In this case, when/if the UE does not receive in the DCI (e.g., a PDCCH order of DCI format 1_0 or a DCI format 0_3 or a DCI format 1_3) any CSI request field(s) for the one or more reference candidate cells, and/or the UE receives in the DCI (e.g., a PDCCH order of DCI format 1_0 or a DCI format 0_3 or a DCI format 1_3) a 0-bit CSI request field for the one or more reference candidate cells and/or a zero-valued CSI request field for the one or more reference candidate cells, the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for/on the corresponding one or more reference candidate cells, e.g., the reference candidate cell with the smallest candidate cell ID/index among the reference candidate cells indicated by the Candidate cells indicator field or the reference candidate cells indicated by the Candidate cells indicator field. The UE could determine or identify the value(s) of x and/or x_max according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's. For this design example, a trigger state could be initiated using the non-zero CSI request field for the one or more reference candidate cells in the DCI (e.g., a PDCCH order of DCI format 1_0 or a DCI format 0_3 or a DCI format 1_3) received on a serving cell, and when the bits/codepoints of the CSI request field for the one or more reference candidate cells in the DCI (e.g., a PDCCH order of DCI format 1_0 or a DCI format 0_3 or a DCI format 1_3) are set to zero(s), no CSI for LTM operation (e.g., before and/or during and/or after the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding one or more reference candidate cells. Alternatively or optionally, when/if the UE is not configured or provided by the network, e.g., in LTM-Config, LTM-Candidate, LTM-CSI-ReportConfig, LTM-CSI-ResourceConfig, LTM-TCI-Info and/or etc., a list of trigger states provided by CSI-AperiodicTriggerStateList each associated to one or more CSI-ReportConfig's and/or one or more LTM-CSI-ReportConfig's, no CSI for LTM operation (e.g., before and/or during and/or after the LTM cell switch) is requested, i.e., the UE could expect that CSI acquisition including triggering of CSI/beam measurement/reporting, measurement of CSI-RS (for beam management, for CSI-RS and/or for mobility) and/or CSI/beam reporting is not enabled or supported before and/or during and/or after the LTM cell switch (for RACH-based and/or RACH-less LTM cell switch), e.g., for the corresponding one or more reference candidate cells as defined herein in the present disclosure.
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of 2^{M}^{_{TS}}−1 trigger states provided by CSI-AperiodicTriggerStateList each associated to one or more CSI-ReportConfig's and/or one or more LTM-CSI-ReportConfig's. For this design example, when/if a non-zero CSI request field for the one or more reference candidate cells as defined herein in the present disclosure is provided or indicated in the DCI (e.g., a PDCCH order of DCI format 1_0 or a DCI format 0_3 or a DCI format 1_3), a trigger state could be initiated using the non-zero CSI request field for the one or more reference candidate cells in the DCI (e.g., a PDCCH order of DCI format 1_0 or a DCI format 0_3 or a DCI format 1_3), and the CSI request field for the one or more reference candidate cells in the DCI (e.g., a PDCCH order of DCI format 1_0 or a DCI format 0_3 or a DCI format 1_3) can directly indicate the trigger state, e.g., out of the 2^{M}^{_{TS}}−1 configured/provided trigger states in the CSI-AperiodicTriggerStateList. That is, in this case, the number of bits of/in the CSI request field (i.e., the x-bit CSI request field for the one or more reference candidate cells in the DCI (e.g., a PDCCH order of DCI format 1_0 or a DCI format 0_3 or a DCI format 1_3) as specified/defined herein in the present disclosure) is x=M_{TS}. The UE could determine or identify the value(s) of M_{TS} according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In one example, the UE could be first configured or provided by the network, e.g., in LTM-Config, LTM-Candidate, LTM-CSI-ReportConfig, LTM-CSI-ResourceConfig, LTM-TCI-Info and/or etc., a list of M_{TS} trigger states provided by CSI-AperiodicTriggerStateList each associated to one or more CSI-ReportConfig's and/or one or more LTM-CSI-ReportConfig's. For this design example, when/if a non-zero CSI request field for the one or more reference candidate cells is provided or indicated in the DCI (e.g., a PDCCH order of DCI format 1_0 or a DCI format 0_3 or a DCI format 1_3), a trigger state could be initiated using the non-zero CSI request field in the DCI (e.g., a PDCCH order of DCI format 1_0 or a DCI format 0_3 or a DCI format 1_3) for the one or more reference candidate cells as defined herein in the present disclosure. For this design example,
   When the number of configured (CSI) trigger states in CSI-AperiodicTriggerStateList is greater than or equal to 2^{N}^{_{TS}}−1 (i.e., M_{TS}>2^{N}^{_{TS}}−1), where N_{TS} is the number of bits of/in the CSI request field for the one or more reference candidate cells, i.e., x=N_{TS} for the x-bit CSI request field for the one or more reference candidate cells in the DCI (e.g., a PDCCH order of DCI format 1_0 or a DCI format 0_3 or a DCI format 1_3) as specified/defined herein in the present disclosure, the UE could receive a sub-selection MAC CE command/indication, used to map up to 2^{N}^{_{TS}}−1 trigger states to the bits/codepoints of the CSI request field for the one or more reference candidate cells in the DCI (e.g., a PDCCH order of DCI format 1_0 or a DCI format 0_3 or a DCI format 1_3). Here, N_{TS} could be provided or configured by a higher layer parameter reportTriggerSize where e.g. N_{TS}∈{0, 1, 2, 3, 4, 5, 6} or N_{TS}∈{1, 2, 3, 4, 5, 6} or N_{TS}∈{0, . . . , x_max} or N_{TS}∈{1, . . . , x_max}. When the UE would transmit a PUCCH with HARQ-ACK information in slot n corresponding to the PDSCH carrying the sub-selection MAC CE command/indication, UE assumption on the mapping of the selected CSI trigger state(s) to the codepoint(s)/bit(s) of the CSI request field for the one or more reference candidate cells in the DCI (e.g., a PDCCH order of DCI format 1_0 or a DCI format_3 or a DCI format 1_3) according to or following those specified herein in the present disclosure could be applied starting from the first slot that is after slot

$$n + 3 {N}_{slot}^{subframe , μ} + \frac{{2}^{μ}}{{2}^{{μ}_{K}} mac} \cdot {k}_{mac}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided.
When the number of configured (CSI) trigger states in CSI-AperiodicTriggerStateList is less than or equal to 2^{N}^{_{TS}}−1 (i.e., M_{TS}≤2^{N}^{_{TS}}−1), where N_{TS} is the number of bits of/in the CSI request field for the one or more reference candidate cells, i.e., x=N_{TS} for the x-bit CSI request field for the one or more reference candidate cells in the DCI (e.g., a PDCCH order of DCI format 1_0 or a DCI format 0_3 or a DCI format 1_3) as specified/defined herein in the present disclosure, the CSI request field for the one or more reference candidate cells in the DCI (e.g., a PDCCH order of DCI format 1_0 or a DCI format 0_3 or a DCI format 1_3) can directly indicate the trigger state, e.g., out of the M_{TS} configured/provided trigger states in the CSI-AperiodicTriggerStateList.

For a reference candidate cell among the reference candidate cells indicated by Candidate cells indicator field in the indication DCI (e.g., a PDCCH order of DCI format 1_0 or a DCI format 0_3 or a DCI format 13), the UE could be provided or configured or indicated by the network, e.g., via/by/in higher layer RRC signaling(s)/parameter(s) and/or MAC CE command(s) and/or dynamic DCI based L1 signaling(s) based on or according to a corresponding UE's capability or capability signaling, whether the indication DCI (e.g., a PDCCH order of DCI format 1_0 or a DCI format 0_3 or a DCI format 1_3) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting, for/on the corresponding reference candidate cell.
For example, the UE could be configured or provided by the network, e.g., in LTM-Config, LTM-Candidate, LTM-CSI-ReportConfig, LTM-CSI-ResourceConfig, LTM-TCI-Info and/or etc., a higher layer parameter ltmMeasureReport. When/if the higher layer parameter ltmMeasureReport is provided, configured or present and/or set to ‘enabled’ and/or ‘measureOnly’, the UE could expect or assume that the indication DCI (e.g., a PDCCH order of DCI format 1_0 or a DCI format 0_3 or a DCI format 1_3) could activate/trigger only (SP/AP) CSI-RS(s) for measurement on the corresponding reference candidate cell; when/if the higher layer parameter ltmMeasureReport is provided, configured or present and/or set to ‘enabled’ and/or ‘reportOnly’, the UE could expect or assume that the indication DCI (e.g., a PDCCH order of DCI format 1_0 or a DCI format 0_3 or a DCI format 1_3) could activate/trigger only (SP/AP) CSI reporting on/for the corresponding reference candidate cell; and when/if the higher layer parameter ltmMeasureReport is provided, configured or present and/or set to ‘enabled’ and/or ‘bothMeasureReport’, the UE could expect or assume that the indication DCI (e.g., a PDCCH order of DCI format 1_0 or a DCI format 0_3 or a DCI format 1_3) could activate/trigger both (SP/AP) CSI-RS(s) for measurement on the corresponding reference candidate cell and CSI reporting on/for the corresponding reference candidate cell. Optionally, when/if the higher layer parameter ltmMeasureReport is not provided or present or configured or is absent, or the higher layer parameter ltmMeasureReport is provided, configured or present but set to ‘disabled’, the UE could expect or assume that the indication DCI (e.g., a PDCCH order of DCI format 1_0 or a DCI format 0_3 or a DCI format 1_3) could activate/trigger (i) only (SP/AP) CSI-RS(s) for measurement on the corresponding reference candidate cell, (ii) only (SP/AP) CSI reporting on/for the corresponding reference candidate cell, or (iii) both (SP/AP) CSI-RS(s) for measurement on the corresponding reference candidate cell and CSI reporting on/for the corresponding reference candidate cell, according to or based on (a) fixed value(s)/rule(s) in system specification(s) and/or per RRC (re-)configuration/setup, (b) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (c) UE's autonomous determination or selection, which could be further sent to the network (e.g., the network 130) via various UL channels/signals e.g. via/in part of beam/CSI report(s) and/or UE's capability signaling(s).
For another example, the indication DCI (e.g., a PDCCH order of DCI format 1_0 or a DCI format 0_3 or a DCI format 1_3) could comprise or provide or include or contain a one-bit indicator; in this case, when/if the one-bit indicator is set to ‘1’ (or ‘0’), (the UE could expect or assume that) the indication DCI (e.g., a PDCCH order of DCI format 1_0 or a DCI format 0_3 or a DCI format 1_3) could activate/trigger only (SP/AP) CSI-RS(s) for measurement on the corresponding reference candidate cell, otherwise, i.e., when/if the one-bit indicator is set to ‘0’ (‘1’), (the UE could assume or expect that) the indication DCI (e.g., a PDCCH order of DCI format 1_0 or a DCI format 0_3 or a DCI format 1_3) could activate/trigger both (SP/AP) CSI-RS(s) for measurement on the corresponding reference candidate cell and CSI reporting on/for the corresponding reference candidate cell. Alternatively, when/if the one-bit indicator is set to ‘1’ (or ‘0’), (the UE could expect or assume that) the indication DCI (e.g., a PDCCH order of DCI format 1_0 or a DCI format 0_3 or a DCI format 1_3) could activate/trigger only (SP/AP) CSI reporting on/for the corresponding reference candidate cell, otherwise, i.e., when/if the one-bit indicator is set to ‘0’ (‘1’), (the UE could assume or expect that) the indication DCI (e.g., a PDCCH order of DCI format 1_0 or a DCI format 0_3 or a DCI format 1_3) could activate/trigger both (SP/AP) CSI-RS(s) for measurement on the corresponding reference candidate cell and CSI reporting on/for the corresponding reference candidate cell. Optionally, when/if the one-bit indicator is set to ‘1’ (or ‘0’), (the UE could expect or assume that) the indication DCI (e.g., a PDCCH order of DCI format 1_0 or a DCI format 0_3 or a DCI format 1_3) could activate/trigger only (SP/AP) CSI-RS(s) for measurement on the corresponding reference candidate cell, otherwise, i.e., when/if the one-bit indicator is set to ‘0’ (‘1’), (the UE could assume or expect that) the indication DCI (e.g., a PDCCH order of DCI format 1_0 or a DCI format 0_3 or a DCI format 1_3) could activate/trigger only (SP/AP) CSI reporting on/for the corresponding reference candidate cell. Whether the one-bit indicator is present or not (absent) in the indication DCI (e.g., a PDCCH order of DCI format 1_0 or a DCI format 0_3 or a DCI format 1_3) could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one-bit indicator as specified/defined herein is present in the indication DCI (e.g., a PDCCH order of DCI format 1_0 or a DCI format 0_3 or a DCI format 1_3) for the corresponding reference candidate cell; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one-bit indicator as specified/defined herein is not present or is absent in the indication DCI (e.g., a PDCCH order of DCI format 1_0 or a DCI format 0_3 or a DCI format 1_3) for the corresponding reference candidate cell.
For another example, the indication DCI (e.g., a PDCCH order of DCI format 1_0 or a DCI format 0_3 or a DCI format 1_3) could comprise or provide or include or contain a two-bit indicator; in this case, when/if the two-bit indicator is set to ‘00’ (or ‘01’ or ‘10’ or ‘11’), (the UE could expect or assume that) the indication DCI (e.g., a PDCCH order of DCI format 1_0 or a DCI format 0_3 or a DCI format 1_3) could activate/trigger only (SP/AP) CSI-RS(s) for measurement on the corresponding reference candidate cell, when/if the two-bit indicator is set to ‘01’ (or ‘00’ or ‘10’ or ‘11’), (the UE could expect or assume that) the indication DCI (e.g., a PDCCH order of DCI format 1_0 or a DCI format 0_3 or a DCI format 1_3) could activate/trigger only (SP/AP) CSI reporting on/for the corresponding reference candidate cell, and when/if the two-bit indicator is set to ‘10’ (or ‘00’ or ‘01’ or ‘11’), (the UE could assume or expect that) the indication DCI (e.g., a PDCCH order of DCI format 1_0 or a DCI format 0_3 or a DCI format 1_3) could activate/trigger both (SP/AP) CSI-RS(s) for measurement on the corresponding reference candidate cell and CSI reporting on/for the corresponding reference candidate cell. Whether the two-bit indicator is present or not (absent) in the indication DCI (e.g., a PDCCH order of DCI format 1_0 or a DCI format 0_3 or a DCI format 1_3) could be higher layer configured. For instance, when/if a higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the two-bit indicator as specified/defined herein is present in the indication DCI (e.g., a PDCCH order of DCI format 1_0 or a DCI format 0_3 or a DCI format 1_3) for the corresponding reference candidate cell; otherwise, i.e., when/if the higher layer parameter ltmMeasureReportPresence is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter ltmMeasureReportPresence is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the two-bit indicator as specified/defined herein is not present or is absent in the indication DCI (e.g., a PDCCH order of DCI format 1_0 or a DCI format 0_3 or a DCI format 1_3) for the corresponding reference candidate cell.
For another example, when/if an indication DCI (e.g., a PDCCH order of DCI format 1_0 or a DCI format 0_3 or a DCI format 1_3) comprises a CSI request field for a reference candidate cell according to or following those specified/defined herein in the present disclosure, and
   when/if the x-th codepoint of the CSI request field is indicated, (the UE could assume or expect that) the indication DCI (e.g., a PDCCH order of DCI format 1_0 or a DCI format 0_3 or a DCI format 1_3) could activate/trigger only (SP/AP) CSI-RS(s) for measurement on the corresponding reference candidate cell,
   when/if the y-th codepoint of the CSI request field is indicated, (the UE could assume or expect that) the indication DCI (e.g., a PDCCH order of DCI format 1_0 or a DCI format 0_3 or a DCI format 1_3) could activate/trigger only (SP/AP) CSI reporting on/for the corresponding reference candidate cell, and
   when/if the z-th codepoint of the CSI request field is indicated, (the UE could assume or expect that) the indication DCI (e.g., a PDCCH order of DCI format 1_0 or a DCI format 0_3 or a DCI format 1_3) could activate/trigger both (SP/AP) CSI-RS(s) for measurement on the corresponding reference candidate cell and CSI reporting on/for the corresponding reference candidate cell.

In this case, the UE could determine or identify whether (some codepoint(s) of) the CSI request field for a reference candidate cell can be used, applied or repurposed for indicating whether the indication DCI (e.g., a PDCCH order of DCI format 1_0 or a DCI format 0_3 or a DCI format 1_3) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting for the corresponding reference candidate cell according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).
For another example, take into account an existing field in an indication DCI (e.g., a PDCCH order of DCI format 1_0 or a DCI format 0_3 or a DCI format 1_3) for a reference candidate cell:
   when/if the x-th codepoint of the existing field is indicated, (the UE could assume or expect that) the indication DCI (e.g., a PDCCH order of DCI format 1_0 or a DCI format 0_3 or a DCI format 1_3) could activate/trigger only (SP/AP) CSI-RS(s) for measurement on the corresponding reference candidate cell,
   when/if the y-th codepoint of the existing field is indicated, (the UE could assume or expect that) the indication DCI (e.g., a PDCCH order of DCI format 1_0 or a DCI format 0_3 or a DCI format 1_3) could activate/trigger only (SP/AP) CSI reporting on/for the corresponding reference candidate cell, and
   when/if the z-th codepoint of the existing field is indicated, (the UE could assume or expect that) the indication DCI (e.g., a PDCCH order of DCI format 1_0 or a DCI format 0_3 or a DCI format 1_3) could activate/trigger both (SP/AP) CSI-RS(s) for measurement on the corresponding candidate cell and CSI reporting on/for the corresponding reference candidate cell.

In this case, the UE could determine or identify whether (some codepoint(s) of) the existing field for a reference candidate cell can be used, applied or repurposed for indicating whether the indication DCI (e.g., a PDCCH order of DCI format 1_0 or a DCI format 0_3 or a DCI format 1_3) can (1) activate/trigger only (SP/AP) CSI-RS(s) for measurement, (2) activate/trigger only (SP/AP) CSI reporting, or (3) activate/trigger both (SP/AP) CSI-RS(s) for measurement and (SP/AP) CSI reporting for the corresponding reference candidate cell according to or based on (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s). Furthermore, the UE (e.g., the UE 116) could determine or identify the value(s) of x, y and/or z according to or based on: (i) fixed value(s)/rule(s) in system specification(s) and/or per RRC (re-)configuration/setup, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection, which could be further sent to the network via various UL channels/signals e.g. via/in part of beam/CSI report(s) and/or UE's capability signaling(s).

In one example, when/if the indication DCI (e.g., a PDCCH order of DCI format 1_0 or a DCI format 0_3 or a DCI format 1_3) can trigger at least AP CSI-RS(s) for measurement on/for at least a reference candidate cell indicated therein according to or following those specified herein in the present disclosure, and the indication DCI (e.g., a PDCCH order of DCI format 1_0 or a DCI format 0_3 or a DCI format 1_3) comprises a CSI request field for at least the reference candidate cell according to or following those specified herein in the present disclosure, wherein the UE could determine or identity the reference candidate cell here—e.g., out of or from the indicated reference candidate cell(s) in/by the indication DCI—according to or based on: (1) fixed value(s)/rule(s) in system specification(s) and/or per RRC (re-)configuration/setup—e.g., the reference candidate cell with the smallest candidate cell ID/index among the reference candidate cells indicated by Candidate cells indicator field or the reference candidate cells indicated by Candidate cells indicator field, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s),
the UE could first identify or determine a trigger state according to the indicated codepoint of the CSI request field, wherein the trigger state could be associated/specific/corresponding/linked to the corresponding reference candidate cell; e.g., the trigger state could be from the list of trigger state(s)—provided by CSI-AperiodicTriggerStateList—associated/corresponding/linked/specific to the corresponding reference candidate cell, and/or selected based on or according to the aperiodic trigger state(s) sub-selection MAC CE command/indication according to or based on those specified herein in the present disclosure (e.g., the LTM CSC MAC CE and/or the Msg2 RAR) could also provide or indicate the trigger state(s) for sub-selection, i.e., they could act as or provide same functionalities as the aperiodic trigger state(s) sub-selection MAC CE) associated/corresponding/linked/specific to the corresponding reference candidate cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding reference candidate cell;
   Each of the identified or determined one or more CSI reporting settings/CSI report configurations associated to a reportConfigId could be associated or linked or corresponding to a resource set (e.g., a NZP CSI-RS resource set or a SSB resource set) index/ID;
   The resource set index/ID and the reportConfigId could be provided in a/the same higher layer RRC signaling/parameter, e.g., CSI-AssociatedReportConfigInfo/LTM-CSI-AssociatedReportConfigInfo;
   The resource set (e.g., the NZP CSI-RS resource set or the SSB resource set) and/or one or more RS resources (e.g., NZP CSI-RS resource(s) or SSB(s)) in the resource set could be associated/specific/corresponding/linked to the corresponding reference candidate cell;
the UE could identify or determine one or more CSI resource settings/CSI resource configurations—each provided by CSI-ResourceConfig or LTM-CSI-ResourceConfig—associated/specific/linked/corresponding to the identified or determined one or more CSI reporting settings/CSI report configurations, wherein the identified or determined one or more CSI resource settings/CSI resource configurations could be associated/specific/corresponding/linked to the corresponding reference candidate cell;
   The UE could identify or determine a list of RS resource sets (e.g., a list of NZP CSI-RS resource set(s) or SSB resource set(s)) each comprising one or more RS resources including NZP CSI-RS resource(s) or SSB(s)—from or according to each of the identified or determined one or more CSI resource settings/CSI resource configurations;
   The identified or determined list or one or more RS resource sets in the list or one or more RS resources in one or more RS resource sets in the list could be associated/specific/corresponding/linked to the corresponding reference candidate cell;
for a CSI reporting setting/CSI report configuration associated/specific/corresponding/linked to the trigger state according to or following those specified herein in the present disclosure, the UE would identify or determine a resource set ID/index associated/specific/linked/corresponding to the CSI reporting setting/CSI reporting configuration according to or following those specified herein in the present disclosure, and a list of RS resource sets associated/specific/linked/corresponding to the CSI reporting setting/CSI reporting configuration according to or following those specified herein in the present disclosure. In this case, the resource set ID/index could point to an entry—hence, a measurement resource set—from/in the list of RS resource sets, wherein the measurement resource set could be or could correspond to a NZP CSI-RS resource set or a SSB resource set;
the UE could then measure the RS(s) including CSI-RS(s) corresponding to the RS resource(s) including NZP CSI-RS resource(s) in the measurement resource set on/for the corresponding reference candidate cell by assuming/applying a CSI-RS triggering offset X slot(s), wherein the X slot(s) could be specific to the measurement RS resource set. In particular, the aperiodic triggering offset X could be between the slot containing the indication DCI (e.g., a PDCCH order of DCI format 1_0 or a DCI format 0_3 or a DCI format 1_3) that triggers the measurement RS resource set on/for the corresponding reference candidate cell and the slot in which the corresponding measurement RS resource set is transmitted.

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by aperiodicTriggerOffset, e.g., in LTM-Config, LTM-Candidate, LTM-CSI-ReportConfig, LTM-CSI-ResourceConfig, LTM-TCI-Info and/or etc. The value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. When the field or the higher layer parameter aperiodicTriggerOffset is absent, the UE could apply the value 0 of X.
   For another example, the indication DCI (e.g., a PDCCH order of DCI format 1_0 or a DCI format 0_3 or a DCI format 1_3) could provide, contain, include or comprise one or more indicators to indicate the value(s) of X, e.g., via one or more new fields in the indication DCI (e.g., a PDCCH order of DCI format 1_0 or a DCI format 0_3 or a DCI format 1_3). In one example, the value 0 of X could correspond to 0 slot, value 1 of X could correspond to 1 slot, value 2 of X could correspond to 2 slots, value 3 of X could correspond to 3 slots, value 4 of X could correspond to 4 slots, value 5 of X could correspond to 16 slots, value 6 of X could correspond to 24 slots. In another example, the value x of X could correspond to x slot(s). Whether the one or more indicators could be present or not (absent) in the indication DCI (e.g., a PDCCH order of DCI format 1_0 or a DCI format 0_3 or a DCI format 1_3) could be higher layer configured. For instance, when/if a higher layer parameter triggeringOffsetPresentInDCI is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the indication DCI (e.g., a PDCCH order of DCI format 1_0 or a DCI format 0_3 or a DCI format 1_3); otherwise, i.e., when/if the higher layer parameter triggeringOffsetPresentInDCI is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter triggeringOffsetPresentInDCI is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the indication DCI (e.g., a PDCCH order of DCI format 1_0 or a DCI format 0_3 or a DCI format 1_3). When the one or more indicators mentioned herein are absent from/in the indication DCI (e.g., a PDCCH order of DCI format 1_0 or a DCI format 0_3 or a DCI format 13), the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

In one example, when/if the indication DCI (e.g., a PDCCH order of DCI format 1_0 or a DCI format 0_3 or a DCI format 1_3) can at least trigger AP CSI reporting and/or activate SP CSI reporting over PUSCH(s) on/for at least a reference candidate cell according to or following those specified herein in the present disclosure, and the indication DCI (e.g., a PDCCH order of DCI format 1_0 or a DCI format 0_3 or a DCI format 1_3) comprises a CSI request field for at least the reference candidate cell according to or following those specified herein in the present disclosure, wherein the UE could determine or identity the reference candidate cell here—e.g., out of or from the indicated reference candidate cell(s) in/by the indication DCI—according to or based on: (1) fixed value(s)/rule(s) in system specification(s) and/or per RRC (re-)configuration/setup—e.g., the reference candidate cell with the smallest candidate cell ID/index among the reference candidate cells indicated by Candidate cells indicator field or the reference candidate cells indicated by Candidate cells indicator field, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s),
the UE could first identify or determine a trigger state according to the indicated codepoint of the CSI request field, wherein the trigger state could be associated/specific/corresponding/linked to the corresponding reference candidate cell; e.g., the trigger state could be from the list of trigger state(s)—provided by CSI-AperiodicTriggerStateList—associated/corresponding/linked/specific to the corresponding reference candidate cell, and/or selected based on or according to the aperiodic trigger state(s) sub-selection MAC CE command/indication according to or based on those specified herein in the present disclosure (e.g., the LTM CSC MAC CE and/or the Msg2 RAR could also provide or indicate the trigger state(s) for sub-selection, i.e., they could act as or provide same functionalities as the aperiodic trigger state(s) sub-selection MAC CE) associated/corresponding/linked/specific to the corresponding reference candidate cell;
the UE could identify or determine one or more CSI reporting settings/CSI report configurations—each provided by CSI-ReportConfig or LTM-CSI-ReportConfig—associated/specific/linked/corresponding to the trigger state, wherein the identified or determined one or more CSI reporting settings/CSI report configurations could be associated/specific/corresponding/linked to the corresponding reference candidate cell; each of the identified or determined one or more CSI reporting settings/CSI report configurations associated to a reportConfigId could be associated or linked or corresponding to a list of report slot offset(s), e.g., provided by reportSlotOffsetList as specified/defined in [REF 6].

In this case, the UE could determine or identify the PUSCH resource(s) and the corresponding setting(s) for the PUSCH(s) to send or transmit or carry or convey the AP CSI report(s) on/for the corresponding reference candidate cell according to the following procedure(s): when the UE could be scheduled to transmit a PUSCH with no transport block and/or with a CSI report(s) by a ‘CSI request’ field in the indication DCI (e.g., a PDCCH order of DCI format 1_0 or a DCI format 0_3 or a DCI format 1_3) for at least the corresponding reference candidate cell as specified/defined herein in the present disclosure, the UE could be provided or indicated or configured by the network, e.g., via/in/by higher layer RRC signaling(s)/parameter(s) including LTM-Config, LTM-Candidate, LTM-CSI-ReportConfig, LTM-CSI-ResourceConfig, LTM-TCI-Info and/or etc. and/or MAC CE command(s) and/or dynamic DCI based L1 signaling(s) based on or according to a corresponding UE's capability or capability signaling, a value m providing a row index m+1 to the allocated table as defined in Clause 6.1.2.1.1 of [REF 4]. The indexed row defines the start and length indicator SLIV, or directly the start symbol S and the allocation length L, and the PUSCH mapping type to be applied in the PUSCH transmission and the K₂ value could be determined as

$${K}_{2} = {max}_{j} {Y}_{j} ( m + 1 ) ,$$

where Yⱼ for j=0, . . . , N_{Rep}−1 are the corresponding list entries of the list of report slot offset(s), e.g., provided by reportSlotOffsetList or reportSlotOffsetList-r17, associated/linked/specific/corresponding to the N_{Rep} determined or identified or triggered CSI reporting settings/CSI report configurations—e.g., in the corresponding higher layer parameter(s) CSI-ReportConfig(s) or LTM-CSI-ReportConfig(s), and Yⱼ(m+1) could correspond to the (m+1)-th entry of Yⱼ including the omitted CSI reporting settings/CSI report configurations triggered for non-active DL BWPs, where the UE may not expect that (m+1) is larger than 16. Here, the indication DCI (e.g., a PDCCH order of DCI format 1_0 or a DCI format 0_3 or a DCI format 1_3) could comprise or provide or contain or include one or more fields to indicate the value m.
In one example, the value m could be provided or indicated by the time domain resource assignment (TDRA) field in the indication DCI (e.g., a PDCCH order of DCI format 1_0 or a DCI format 0_3 or a DCI format 13), e.g., associated/corresponding/specific/mapped to the corresponding reference candidate cell.
In another example, the value m could be provided or indicated by a new field introduced in the indication DCI (e.g., a PDCCH order of DCI format 1_0 or a DCI format 0_3 or a DCI format 1_3) dedicated for triggering AP CSI reporting and/or activating SP CSI reporting on/for the corresponding reference candidate cell.
In another example, the value m could be provided or indicated by repurposing one or more codepoints of one or more existing fields in the indication DCI (e.g., a PDCCH order of DCI format 1_0 or a DCI format 0_3 or a DCI format 13) subject to network's configuration(s)/signaling(s) and/or UE's capability(s)/capability signaling(s).

In this case, the UE could start to apply or use the PUSCH resource(s) from or in (the first) slot(s) that is at least a number e.g., K₂ of slot(s) offset relative to or starting from or after the (first) slot that carries or provides or conveys the indication DCI (e.g., a PDCCH order of DCI format 1_0 or a DCI format 0_3 or a DCI format 1_3) to carry or send or convey or transmit the AP/SP CSI report(s) for/on the corresponding reference candidate cell. The design examples/procedures related to the indication DCI (e.g., a PDCCH order of DCI format 1_0 or a DCI format 0_3 or a DCI format 1_3) could be equally extended or applied to other DCI formats including DCI format(s) 0_0/0_1/0_2/0_3 and/or 1_1/1_2/1_3 by replacing the indication DCI (e.g., a PDCCH order of DCI format 1_0 or a DCI format 0_3 or a DCI format 1_3) in the design examples/procedures specified/defined herein in the present disclosure with/by a DCI format 0_0/0_1/0_2/0_3/1_1/1_2/1_3.

Furthermore, throughout the present disclosure, a/the corresponding reference candidate cell can also be referred to as or replaced by/with one or more reference candidate cells or the reference candidate cells or one or more of the reference candidate cells. And, the design examples/procedures related to or for a/the corresponding reference candidate cell can also be extended or applied to one or more reference candidate cells or the reference candidate cells or one or more of the reference candidate cells.

For the (aforementioned) design examples specified/described herein in the present disclosure, a non-zero codepoint/bit of the CSI request field in the PDCCH order (and therefore, the corresponding DCI format e.g. 1_0) or DCI format 0_3/1_3 could be mapped to a (CSI) triggering/trigger state according to the order of the associated positions of the (e.g., up to 2^{N}^{_{TS}}−1) trigger states in CSI-AperiodicTriggerStateList with codepoint/bit ‘1’ mapped to the trigger/triggering state in the first position.

Before or during or after the LTM cell switch as specified/defined herein in the present disclosure, the SP CSI-RS/CSI-IM Resource Set Activation/Deactivation MAC CE can be used to activate SP CSI-RS(s) for measurement on/for one or more candidate cells.
In one example, the SP CSI-RS/CSI-IM Resource Set Activation/Deactivation MAC CE could provide, comprise, contain, include or indicate a candidate cell ID. The field (new or repurposed via ‘R’ field(s)) used in the SP CSI-RS/CSI-IM Resource Set Activation/Deactivation MAC CE to indicate the candidate cell ID could be set to ┌log₂(C+1)┐ or ┌log₂(C)┐ bits, where C is the number of candidate cells configured/provided in the list/set/pool of candidate cells for LTM operation(s) as specified/defined herein in the present disclosure and/or in a/the subset of candidate cell(s)/candidate cell ID(s) for CSI acquisition in LTM operation(s) as specified/defined herein in the present disclosure. For this design example, the UE could perform measurement(s) on the SP CSI-RS(s)/CSI-RS resource set(s)—associated/specific/linked/corresponding to or configured/provided for the candidate cell indicated therein provided or indicated in the SP CSI-RS/CSI-IM Resource Set Activation/Deactivation MAC CE starting from the first slot that is after slot

$$n + 3 {N}_{slot}^{frame , μ} + X$$

when the UE would transmit a PUCCH with HARQ-ACK information in slot n corresponding to the PDSCH carrying the SP CSI-RS/CSI-IM Resource Set Activation/Deactivation MAC CE, where μ is the SCS configuration for the PUSCH(s), and

$${N}_{slot}^{frame , μ}$$

is the number of slots in a frame. The UE could determine or identify the value(s) of X (e.g., in slot(s)) according to or based on: (1) fixed value(s), e.g., 0, in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s).
In another example, the SP CSI-RS/CSI-IM Resource Set Activation/Deactivation MAC CE could provide, comprise, contain, include or indicate one or more (e.g., K≥1) candidate cell IDs.
   For example, the SP CSI-RS/CSI-IM Resource Set Activation/Deactivation MAC CE could provide, comprise, contain or include K field(s)—new or repurposed via ‘R’ field(s)—each indicating a candidate cell ID with ┌log₂(C+1)┐ or ┌log₂(C)┐ bits, where C is the number of candidate cells configured/provided in the list/set/pool of candidate cells for LTM operation(s) as specified/defined herein in the present disclosure and/or in a/the subset of candidate cell(s)/candidate cell ID(s) for CSI acquisition in LTM operation(s) as specified/defined herein in the present disclosure.
   For another example, the SP CSI-RS/CSI-IM Resource Set Activation/Deactivation MAC CE could provide, comprise, contain or include a candidate cells indicator with ┌log₂(I+1)┐ or ┌log₂(I)┐ bits indicating the K candidate cells (denoted by or referred to as K reference candidate cells) in the candidate cell set, e.g., according to TABLE 2, where I is the number of entries in a higher layer parameter candidateCellComboList, and/or each entry in the higher layer parameter candidateCellComboList could (only) comprise candidate cells in a/the subset of candidate cell(s)/candidate cell ID(s) for CSI acquisition in LTM operation(s) as specified/defined herein in the present disclosure.

For this design example, the UE could perform measurement(s) on the SP CSI-RS(s)/CSI-RS resource set(s)—associated/specific/linked/corresponding to or configured/provided for the one or more (e.g., K≥1) candidate cells indicated therein—provided or indicated in the SP CSI-RS/CSI-IM Resource Set Activation/Deactivation MAC CE starting from the first slot that is after slot

$$n + 3 {N}_{slot}^{frame , μ} + X$$

when the UE would transmit a PUCCH with HARQ-ACK information in slot n corresponding to the PDSCH carrying the SP CSI-RS/CSI-IM Resource Set Activation/Deactivation MAC CE, where μ is the SCS configuration for the PUSCH(s), and

$${N}_{slot}^{frame , μ}$$

is the number of slots in a frame. The UE could determine or identify the value(s) of X (e.g., in slot(s)) according to or based on: (1) fixed value(s), e.g., 0, in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

Before or during or after the LTM cell switch as specified/defined herein in the present disclosure, the SP CSI reporting on PUCCH Activation/Deactivation MAC CE can be used to activate SP CSI reporting(s) over PUCCH(s) for/on one or more candidate cells.
In one example, the SP CSI reporting on PUCCH Activation/Deactivation MAC CE could provide, comprise, contain, include or indicate a candidate cell ID. The field (new or repurposed via ‘R’ field(s)) used in the SP CSI reporting on PUCCH Activation/Deactivation MAC CE to indicate the candidate cell ID could be set to ┌log₂(C+1)┐ or ┌log₂(C)┐ bits, where C is the number of candidate cells configured/provided in the list/set/pool of candidate cells for LTM operation(s) as specified/defined herein in the present disclosure and/or in a/the subset of candidate cell(s)/candidate cell ID(s) for CSI acquisition in LTM operation(s) as specified/defined herein in the present disclosure. For this design example, the UE could perform SP CSI reporting on the PUCCH(s) on/for the corresponding candidate cell applied starting from the first slot that is after slot

$$n + 3 {N}_{slot}^{frame , μ} + X$$

when the UE would transmit a PUCCH with HARQ-ACK information in slot n corresponding to the PDSCH carrying the SP CSI reporting on PUCCH Activation/Deactivation MAC CE, where μ is the SCS configuration for the PUCCH(s), and

$${N}_{slot}^{frame , μ}$$

is the number of slots in a frame. The UE could determine or identify the value(s) of X (e.g., in slot(s) according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In another example, the SP CSI reporting on PUCCH Activation/Deactivation MAC CE could provide, comprise, contain, include or indicate one or more (e.g., K≥1) candidate cell IDs.
   For example, the SP CSI reporting on PUCCH Activation/Deactivation MAC CE could provide, comprise, contain or include K field(s)—new or repurposed via ‘R’ field(s)—each indicating a candidate cell ID with ┌log₂(C+1)┐ or ┌log₂(C)┐ bits, where C is the number of candidate cells configured/provided in the list/set/pool of candidate cells for LTM operation(s) as specified/defined herein in the present disclosure and/or in a/the subset of candidate cell(s)/candidate cell ID(s) for CSI acquisition in LTM operation(s) as specified/defined herein in the present disclosure.
   For another example, the SP CSI reporting on PUCCH Activation/Deactivation MAC CE could provide, comprise, contain or include a candidate cells indicator with ┌log₂(I+1)┐ or ┌log₂(I)┐ bits indicating the K candidate cells (denoted by or referred to as K reference candidate cells) in the candidate cell set, e.g., according to TABLE 2, where I is the number of entries in a higher layer parameter candidateCellComboList, and/or each entry in the higher layer parameter candidateCellComboList could (only) comprise candidate cells in a/the subset of candidate cell(s)/candidate cell ID(s) for CSI acquisition in LTM operation(s) as specified/defined herein in the present disclosure.

For this design example, the UE (e.g., the UE 116) could perform SP CSI reporting(s) on the PUCCH(s) on/for the one or more (e.g., K≥1) candidate cells applied starting from the first slot that is after slot

$$n + 3 {N}_{slot}^{frame , μ} + X$$

when the UE would transmit a PUCCH with HARQ-ACK information in slot n corresponding to the PDSCH carrying the SP CSI reporting on PUCCH Activation/Deactivation MAC CE, where μ is the SCS configuration for the PUCCH(s), and

$${N}_{slot}^{frame , μ}$$

is the number of slots in a frame. The UE could determine or identify the value(s) of X (e.g., in slot(s)) according to or based on: (1) fixed value(s), e.g., 0, in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

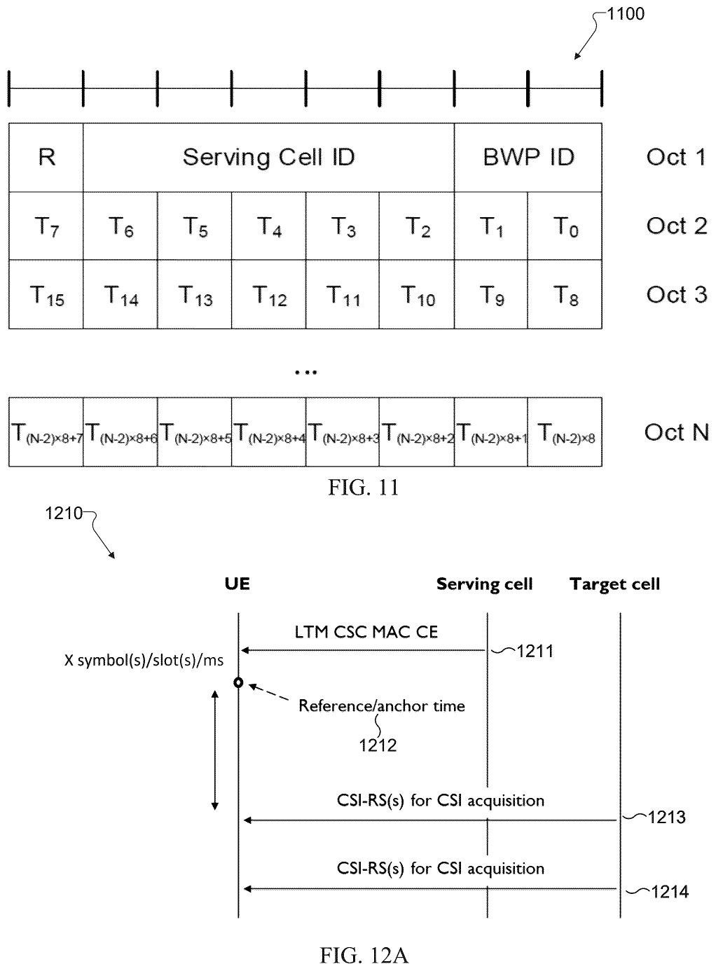

FIG. 11 illustrates an example MAC CE 1100 that sub-selects aperiodic CSI trigger states for CSI measurement reporting in LTM according to embodiments of the present disclosure. For example, MAC CE 1100 can be received by any of the UEs 111-116 of FIG. 1, such as the UE 116. This example is for illustration only and other embodiments can be used without departing from the scope of the present disclosure.

Optionally, the LTM CSC MAC CE command and/or the Msg2 RAR can also be used/applied to map up to 2^{N}^{_{TS}}−1 trigger states to the bits/codepoints of the CSI request field(s) indicated in the LTM CSC MAC CE command, the Msg2 RAR (RAR UL grant), the PDCCH order (of DCI format 1_0) and/or the DCI format mentioned herein (e.g., DCI format 0_3 and/or DCI format 13) according to or following those specified herein in the present disclosure. For instance, the LTM CSC MAC CE command and/or the Msg2 RAR could also comprise the Tᵢ's field(s) as shown in FIG. 11, wherein each of the Tᵢ's fields could indicate the selection status of the aperiodic (CSI) trigger states configured within CSI-AperiodicTriggerStateList. In particular, To refers to the first trigger state within the list, Tᵢ to the second one and so on. If the list does not contain entry with index i, the MAC entity may ignore the Tᵢ field. The Tᵢ field could be set to 1 to indicate that the aperiodic (CSI) trigger state i could be mapped to the bit/codepoint of the CSI request field(s)—e.g., indicated in the LTM CSC MAC CE command, the Msg2 RAR (RAR UL grant), the PDCCH order (of DCI format 1_0) and/or the DCI format mentioned herein (e.g., DCI format 0_3 and/or DCI format 1_3) according to or following those specified herein in the present disclosure. The bit/codepoint to which the aperiodic (CSI) trigger state is mapped is determined by its ordinal position among the aperiodic (CSI) trigger states with Tᵢ field set to 1, i.e., the first aperiodic (CSI) trigger state with Tᵢ field set to 1 could be mapped to the bit/codepoint value 1, the second aperiodic (CSI) trigger state with Tᵢ field set to 1 could be mapped to the bit/codepoint value 2 and so on.

A UE could determine or identify, based on or according to a one-bit indicator field in the LTM CSC MAC CE command, the Msg2 RAR (e.g., the RAR UL grant), the PDCCH order (of DCI format 1_0) and/or the DCI format mentioned herein (e.g., DCI format 0_3 and/or 1_3) associated/specific/corresponding to a candidate cell/candidate cell ID as specified/defined herein in the present disclosure, whether or not CSI acquisition including triggering of CSI/beam measurement/reporting, measurement of CSI-RS (for beam management, for CSI-RS and/or for mobility) and/or CSI/beam reporting is enabled or supported for the candidate cell/candidate cell ID (e.g., before and/or during the LTM cell switch, and/or for RACH-based and/or RACH-less LTM cell switch). For instance, when/if the one-bit indicator is set to ‘1’ (or ‘0’) or ‘true’ (or ‘false’), the UE could identify that the CSI acquisition as specified/defined herein in the present disclosure is supported and/or enabled for the corresponding candidate cell; otherwise, i.e., when/if the one-bit indicator is set to ‘0’ (or ‘1’) or ‘false’ (or ‘true’), the UE could identify that the CSI acquisition is not supported and/or enabled for the corresponding candidate cell.
In one example, the one-bit indicator field could be a new and dedicated field, e.g., denoted by csiAcquisitionEnabler′, in the corresponding LTM CSC MAC CE command, the Msg2 RAR (e.g., the RAR UL grant), the PDCCH order (of DCI format 1_0) and/or the DCI format mentioned herein (e.g., DCI format 0_3 and/or 1_3).
In another example, the one-bit indicator (field) could be realized, implemented and/or signaled by repurposing one or more bits/codepoints of one or more existing fields in the corresponding LTM CSC MAC CE command, the Msg2 RAR (e.g., the RAR UL grant), the PDCCH order (of DCI format 1_0) and/or the DCI format mentioned herein (e.g., DCI format 0_3 and/or 1_3). For example, for the Msg2 RAR (e.g., the RAR UL grant), the one-bit indicator field here could correspond to the reserved one-bit CSI request field in the Msg2 RAR (the RAR UL grant). For another example, the one-bit indicator here could correspond to a bit/codepoint (e.g., the most significant bit (MSB) or least significant bit (LSB), and/or the lowest or highest codepoint) of an existing field (e.g., the CSI request field) in the LTM CSC MAC CE command, the Msg2 RAR (e.g., the RAR UL grant), the PDCCH order (of DCI format 1_0) and/or the DCI format mentioned herein (e.g., DCI format 0_3 and/or 13).
In another example, a reserved field (e.g., a ‘R’ field) in the corresponding LTM CSC MAC CE command, the Msg2 RAR (e.g., the RAR UL grant), the PDCCH order (of DCI format 1_0) and/or the DCI format mentioned herein (e.g., DCI format 0_3 and/or 1_3) could be used or applied to indicate the one-bit indicator (field).

Throughout the present disclosure, the Msg2 RAR can be replaced with/by a MsgB (success/fall back) RAR in a 2-step RACH procedure as described herein in the present disclosure. That is, the corresponding design procedure(s), UE's assumptions, behaviors and/or operations, and the network's indication(s)/configuration(s) related to the Msg2 RAR can be equally applied or extended to the MsgB (success/fall back) RAR in a 2-step RACH procedure. E.g., the MsgB (success/fall back) RAR could also indicate or provide a x-bit CSI request field (and other necessary information/field(s)) to trigger a CSI acquisition (including triggering of CSI/beam measurement/reporting, measurement of CSI-RS (for beam management, for CSI-RS and/or for mobility) and/or CSI/beam reporting for the LTM operation(s), e.g., before and/or during LTM cell switch) on a candidate cell.

Throughout the present disclosure, a CSI reporting configuration is equivalent to a CSI reporting setting, and a CSI resource configuration is equivalent to a CSI resource setting. Furthermore, the design examples/procedures and the corresponding signalling methods, UE behaviour/assumptions and/or etc. specified/defined herein in the present disclosure for a given carrier or component carrier (CC) or a cell could be extended/applied to multiple carriers/CCs/cells when/if a multi-carrier or multi-CC or multi-cell system or setting is configured or enabled. Furthermore, as specified/defined herein in the present disclosure, the beam/CSI report could comprise one or more report quantities including SSBRI(s)/CRI(s), L1-RSRP(s)/L1-SINR(s), CQI(s), RI(s), PMI(s) and/or etc. based on or according to network's configuration(s)/indication(s).

According to or following those specified herein in the present disclosure, before the LTM cell switch, i.e., before the UE could receive and/or apply a LTM CSC MAC CE, the UE could be activated and/or triggered by the network, e.g., via/by/in a PDCCH order (and therefore, the corresponding DCI format 1_0) and/or an indication DCI (e.g., a PDCCH order of DCI format 1_0 or a DCI format 0_3 or a DCI format 13), SP/AP CSI-RS(s) for measurement(s) on one or more reference candidate cells according to or following those specified herein in the present disclosure. During the LTM cell switch, i.e., after the UE has received and applied a LTM CSC MAC CE (but before the UE is actually handed over to the corresponding target cell—e.g., before the first UL transmission(s) towards the target cell), the UE could activated and/or triggered by the network, e.g., via/by/in the LTM CSC MAC CE and/or Msg2 RAR (e.g., for RACH-based LTM operation(s)), SP/AP CSI reporting(s) for/on the target cell according to or following those specified herein in the present disclosure, wherein the target cell could be from the one or more reference candidate cells—e.g., the target cell ID associated or corresponding or linked to the LTM CSC MAC CE (e.g., provided or indicated therein) or the Msg2 RAR (e.g., provided or indicated therein) could be selected or determined or identified from the candidate cell IDs of the one or more reference candidate cells.

Before the LTM cell switch as specified/defined herein in the present disclosure (i.e., before the UE could receive and/or apply a LTM CSC MAC CE), a PDCCH order (e.g., of DCI format 10), and/or an indication DCI (e.g., a PDCCH order of DCI format 1_0 or a DCI format 0_3 or a DCI format 13), and/or a SP CSI-RS/CSI-IM Resource Set Activation/Deactivation MAC CE could activate SP CSI-RS(s) and/or trigger AP CSI-RS(s) for measurement on one or more reference candidate cells according to or following those specified herein in the present disclosure.
In one example, during the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, the LTM CSC MAC CE, and/or Msg2 RAR (e.g., for the RACH-based LTM operation(s)), and/or SP CSI reporting on PUCCH Activation/Deactivation MAC CE could activate SP CSI reporting(s) over PUSCH(s)/PUCCH(s) on/for the target cell, and/or trigger AP CSI reporting(s) on/for the target cell, wherein the target cell could be determined or selected from the one or more reference candidate cells. For instance, denote the number of the one or more reference candidate cells by L, the bitwidth for indicating index/ID of the target cell, e.g., by/in the LTM CSC MAC CE and/or Msg2 RAR and/or SP CSI reporting on PUCCH Activation/Deactivation MAC CE, could be ┌log₂(L+1)┐ or ┌log₂(L)┐.
In another example, after the LTM cell switch as specified/defined herein in the present disclosure, i.e., after the UE has been handed over to the target cell and/or before/after the first UL transmission(s) towards the target cell, the activation/triggering DCI (e.g., DCI format(s) 0_1/0_2/0_3) and/or SP CSI reporting on PUCCH Activation/Deactivation MAC CE could activate SP CSI reporting(s) over PUSCH(s)/PUCCH(s) on/for the target cell, and/or trigger AP CSI reporting(s) on/for the target cell.

Before the LTM cell switch as specified/defined herein in the present disclosure (i.e., before the UE could receive and/or apply a LTM CSC MAC CE), a PDCCH order (e.g., of DCI format 10), and/or an indication DCI (e.g., a PDCCH order of DCI format 1_0 or a DCI format 0_3 or a DCI format 13), and/or SP CSI reporting on PUCCH Activation/Deactivation MAC CE could activate SP CSI reporting(s) over PUSCH(s)/PUCCH(s) on/for one or more reference candidate cells, and/or trigger AP CSI reporting(s) on/for one or more reference candidate cells according to or following those specified herein in the present disclosure.
In one example, during the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, the UE could perform the activated/triggered (before the LTM cell switch) SP/AP CSI reporting(s) over the corresponding PUCCH/PUSCH resource(s) on/for the target cell, wherein the target cell could be determined or selected from the one or more reference candidate cells. For instance, denote the number of the one or more reference candidate cells by L, the bitwidth for indicating index/ID of the target cell, e.g., by/in the LTM CSC MAC CE, could be ┌log₂(L+1)┐ or ┌log₂(L)┐.
In another example, after the LTM cell switch as specified/defined herein in the present disclosure, i.e., after the UE has been handed over to the target cell and/or before/after the first UL transmission(s) towards the target cell, the UE could perform the activated/triggered (before the LTM cell switch) SP/AP CSI reporting(s) over the corresponding PUCCH/PUSCH resource(s)—e.g., the first UL transmission(s)—on/for the target cell, wherein the target cell could be determined or selected from the one or more reference candidate cells. For instance, denote the number of the one or more reference candidate cells by L, the bitwidth for indicating index/ID of the target cell, e.g., by/in the LTM CSC MAC CE, could be ┌log₂(L+1)┐ or ┌log₂(L)┐.

During the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, the LTM CSC MAC CE, and/or Msg2 RAR (e.g., for the RACH-based LTM operation(s)), and/or SP CSI reporting on PUCCH Activation/Deactivation MAC CE could activate SP CSI reporting(s) over PUSCH(s)/PUCCH(s) on/for the target cell, and/or trigger AP CSI reporting(s) on/for the target cell. After the LTM cell switch as specified/defined herein in the present disclosure, i.e., after the UE has been handed over to the target cell and/or before/after the first UL transmission(s) towards the target cell, the UE could perform the activated/triggered (during the LTM cell switch) SP/AP CSI reporting(s) over the corresponding PUCCH/PUSCH resource(s)—e.g., the first UL transmission(s)—on/for the target cell.

The one or more candidate cells/candidate cell IDs—determine or identified in/from the list/set/pool of configured candidate cells/candidate cell IDs—enabled or used for CSI acquisition (including triggering of CSI/beam measurement/reporting, measurement of CSI-RS (for beam management, for CSI-RS and/or for mobility) and/or CSI/beam reporting for the LTM operation(s), e.g., before and/or during and/or after LTM cell switch) according to or following those specified herein in the present disclosure could be denoted by or referred to as a subset of candidate cell(s)/candidate cell ID(s) in LTM operation(s) for CSI acquisition, e.g., before and/or during and/or after the LTM cell switch. In the present disclosure, each candidate cell/candidate cell ID, e.g., provided or configured in the list/set/pool of candidate cell(s)/candidate cell ID(s), and/or determined or selected or identified from the subset of candidate cell(s)/cell ID(s) enabled for CSI acquisition in LTM operation(s), could be associated, corresponding, linked or specific to a resource set e.g. a NZP CSI-RS resource set or a SSB resource set provided or configured, e.g., for L1 measurement and reporting, and/or CSI acquisition, for the LTM operation(s).

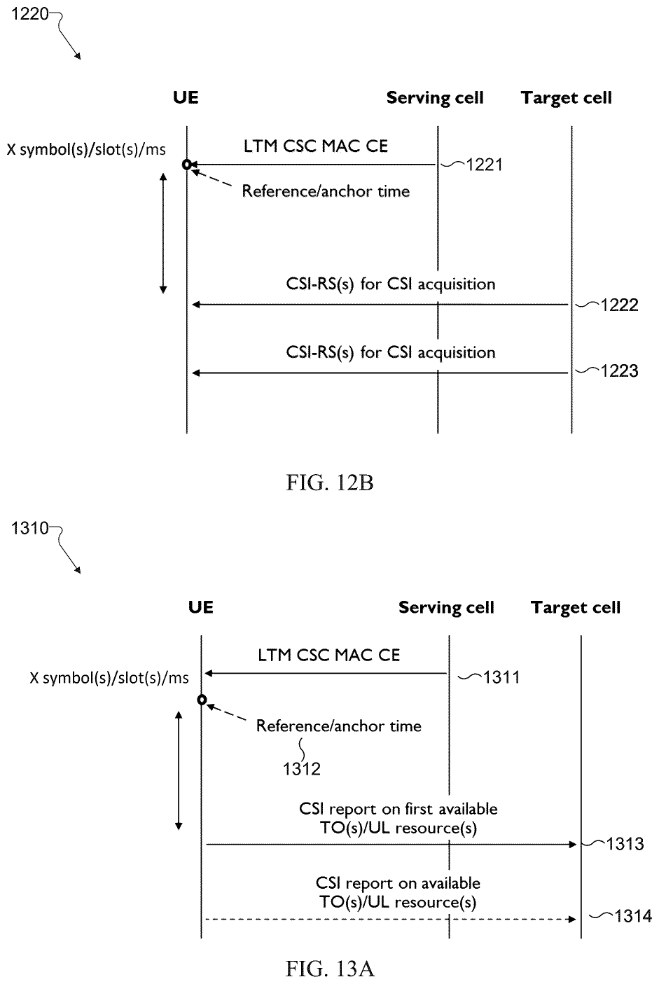

FIGS. 12A and 12B illustrate signal flows of an example procedure 1210 and 1220 for LTM cell switch according to embodiments of the present disclosure. For example, procedure 1210 and 1220 can be performed by the UE 116, the gNB 102 and/or the network 130, and the gNB 103 and/or network 130 in the wireless network 100 of FIG. 1. This example is for illustration only and other embodiments can be used without departing from the scope of the present disclosure.

The procedure 1210 begins in 1211, a serving cell transmits a LTM CSC MAC CE to a UE. In 1212, the UE determines/identifies a reference/anchor time. In 1213, a target cell transmits a CSI-RS(s) for CSI acquisition to the UE. In 1214, the target cell transmits a CSI-RS(s) for CSI acquisition to the UE.

The procedure 1220 begins in 1221, a serving cell transmits a LTM CSC MAC CE to a UE, and the UE determines/identifies a reference/anchor time. In 1222, a target cell transmits a CSI-RS(s) for CSI acquisition to the UE. In 1223, the target cell transmits a CSI-RS(s) for CSI acquisition to the UE.

In one example, a UE could be provided or configured by the network, e.g., by/in/via higher layer RRC signaling(s)/parameter(s) of LTM-Config, LTM-Candidate, LTM-CSI-ReportConfig, LTM-CSI-ResourceConfig, LTM-TCI-Info and/or etc., configuration(s), setting(s) and/or information of one or more periodic CSI-RS resources for CSI acquisition (e.g., provided or configured in a periodic CSI resource setting provided by CSI-ResourceConfig and/or LTM-CSI-ResourceConfig with resourceType set to ‘periodic’ and the corresponding reportConfigType set to ‘periodic’, ‘semiPersistentOnPUCCH’, ‘semiPersistentOnPUSCH’ or ‘aperiodic’) in a resource set (e.g., a NZP CSI-RS resource set provided by NZP-CSI-RS-ResourceSet) for or associated/specific/corresponding to a candidate cell/candidate cell ID, e.g., from the list/set/pool of configured candidate cell IDs or the subset of candidate cell ID(s) in LTM operation(s) for CSI acquisition as specified/defined herein in the present disclosure, wherein each of the one or more periodic CSI-RS resources for CSI acquisition in the resource set could be with a periodicity and an offset provided by CSI-ResourcePeriodicityAndOffset. For example, the one or more periodic CSI-RS resources for CSI acquisition could be transmitted in slots satisfying

$$( {N}_{slot}^{frame , μ} {n}_{f} + {n}_{s , f}^{μ} - {T}_{offset} ) mod {T}_{CSI - RS} = 0$$

where the periodicity T_{CSI-RS} (in slots) and slot offset T_{offset} are obtained from the higher-layer parameter CSI-ResourcePeriodicityAndOffset or slotConfig, and

$${N}_{slot}^{frame , μ}$$

is the number of slots in a frame, n_{f} represents the frame number, and

$${n}_{s , f}^{μ}$$

is the slot number within a frame. During the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, the UE could (start to) measure the (first or most recent or latest or earliest available in time) one or more periodic CSI-RS resources for CSI acquisition for or associated/specific/corresponding to the target cell (at least or no later than or no earlier than) X symbol(s) or slot(s) or ms after (or from) a reference or anchor time, wherein the UE could determine or identify the reference/anchor time according to or based on: (1) fixed value(s)/rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In one example, the reference/anchor time could correspond to the first (or last) slot or symbol of reception of the LTM CSC MAC CE and/or when the LTM CSC MAC CE is received or detected.
In another example, the reference/anchor time could correspond to the first (or last) slot or symbol when the LTM CSC MA CE is transmitted or sent or that carries or conveys the LTM CSC MAC CE.
In another example, the reference/anchor time could correspond to the first (or last) slot or symbol when the LTM CSC MAC CE has become applicable—the LTM CSC MAC CE application time as specified/defined herein in the present disclosure.
In another example, the reference/anchor time could correspond to the first (or last) slot or symbol when the TCI state(s) indicated in/by the LTM CSC MAC CE has become applicable—LTM beam application time as specified/defined herein in the present disclosure.
In another example, the reference/anchor time could correspond to the first (or last) slot or symbol when the Msg1 random access preamble (e.g., for the RACH-based LTM operation(s)) is transmitted or sent or that carries or conveys the Msg1 random access preamble (e.g., for the RACH-based LTM operation(s)).
In another example, the reference/anchor time could correspond to the first (or last) slot or symbol of reception of the Msg2 RAR (e.g., for the RACH-based LTM operation(s)) or when the Msg2 RAR (e.g., for the RACH-based LTM operation(s)) is received or detected.
In another example, the reference/anchor time could correspond to the first (or last) slot or symbol when the Msg3 (e.g., for the RACH-based LTM operation(s)) is transmitted or sent or that carries or conveys the Msg3 (e.g., for the RACH-based LTM operation(s)).

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by csiMeasOffset, e.g., in LTM-Config, LTM-Candidate, LTM-CSI-ReportConfig, LTM-CSI-ResourceConfig, LTM-TCI-Info and/or etc. The value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. When the field or the higher layer parameter csiMeasOffset is absent, the UE could apply the value 0 of X.
   For another example, the LTM CSC MAC CE could provide, contain, include or comprise one or more indicators to indicate the value(s) of X, e.g., via one or more new fields in the LTM CSC MAC CE. In one example, the value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. In another example, the value x of X could correspond to x slot(s)/symbol(s)/ms. Whether the one or more indicators could be present or not (absent) in the LTM CSC MAC CE could be higher layer configured. For instance, when/if a higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the LTM CSC MAC CE; otherwise, i.e., when/if the higher layer parameter csiMeasOffsetPresentInCSC is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the LTM CSC MAC CE. When the one or more indicators mentioned herein are absent from/in the LTM CSC MAC CE, the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

One conceptual example characterizing the described procedure(s) and signaling flow(s) herein are provided in FIG. 12. The UE could identify or determine whether or not the procedure(s) mentioned herein for measuring the CSI-RS resource(s) for CSI acquisition during the LTM cell switch for the target cell according to or following those specified herein in the present disclosure is enabled/disabled according to or based on:
fixed rule(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, a higher layer parameter csiMeasDuringLtmCellSwitch could be provided in higher layer parameter(s)/signaling(s) e.g., LTM-Config, LTM-Candidate, LTM-CSI-ReportConfig, LTM-CSI-ResourceConfig, LTM-TCI-Info and/or etc. that provide or configure necessary information and/or setting(s) for the LTM operation(s). For this design example, when/if the higher layer parameter csiMeasDuringLtmCellSwitch is provided, configured or present and/or is set to ‘enabled’, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when/if the higher layer parameter csiMeasDuringLtmCellSwitch is not provided, configured or present or is absent, and/or when/if the higher layer parameter csiMeasDuringLtmCellSwitch is provided, configured or present but is set to ‘disabled’, the UE could expect or assume that the procedure(s) mentioned herein for measuring the CSI-RS resource(s) for CSI acquisition during the LTM cell switch for the target cell according to or following those specified herein in the present disclosure is disabled.
   For another example, the LTM CSC MAC CE could provide, contain, include or comprise one or more indicators to indicate whether or not the procedure(s) mentioned herein for measuring the CSI-RS resource(s) for CSI acquisition during the LTM cell switch for the target cell according to or following those specified herein in the present disclosure is enabled/disabled. For instance, the LTM CSC MAC CE could comprise a field (a new or a repurposed ‘R’ field) providing or indicating a one-bit indicator. In this case, when/if the one-bit indicator is set to ‘1’ (or ‘0’), the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when/if the one-bit indicator is set to ‘0’ (or ‘1’), the UE could assume or expect that the procedure(s) mentioned herein for measuring the CSI-RS resource(s) for CSI acquisition during the LTM cell switch for the target cell according to or following those specified herein in the present disclosure is disabled.
   For another example, if the LTM CSC MAC CE could provide, contain, include or comprise one or more indicators to indicate the value(s) of X according to or following those specified herein in the present disclosure, and when the value(s) of X is non-zero and/or valid, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when the value(s) of X is zero or invalid, or the LTM CSC MAC CE does not provide or indicate or comprise any value(s) of X—or the value(s) of X is not present or is absent in the LTM CSC MAC CE, the UE could assume or expect that the procedure(s) mentioned herein for measuring the CSI-RS resource(s) for CSI acquisition during the LTM cell switch for the target cell according to or following those specified herein in the present disclosure is disabled.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

In one example, during the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, the UE (e.g., the UE 116) could receive a LTM CSC MAC CE providing, indicating, containing or including one or more fields each comprising a CSI-RS resource set ID and an A/D field. In particular, the A/D field could indicate whether or not measuring the CSI-RS resources(s) provided/configured in/by the CSI-RS resource set(s) indicated therein for CSI acquisition on the corresponding target cell is enabled—i.e., the field is set to ‘1’ to indicate enabling/enabled, otherwise (i.e., the field is set to ‘0’) it indicates disabling/disabled. Each of the field(s) that comprises a CSI-RS resource set ID could contain an index of NZP-CSI-RS-ResourceSet, containing NZP CSI-RS resources (with the corresponding resourceType set to ‘periodic’ or ‘semi-persistent’ or ‘aperiodic’ and reportConfigType set to ‘periodic’, ‘semiPersistentOnPUCCH’, ‘semiPersistentOnPUSCH’ or ‘aperiodic’), indicating the NZP CSI-RS resource set, which may need to be enabled or disabled for measurement/CSI acquisition (e.g., based on or according to the value of the A/D field) for/on the target cell, and the length of each of the field(s) could be of 6 bits. In this case, the UE could assume that the CSI-RS(s) enabled by the LTM CSC MAC CE for measurement/CSI acquisition on the target cell could be transmitted in slots satisfying

$$( {N}_{slot}^{frame , μ} {n}_{f} + {n}_{s , f}^{μ} - {T}_{offset} ) mod {T}_{CSI - RS} = 0$$

where the periodicity T_{CSI-RS} (in slots) and slot offset T_{offset} are obtained from the higher-layer parameter CSI-ResourcePeriodicityAndOffset or slotConfig, and

$${N}_{slot}^{frame , μ}$$

is the number of slots in a frame, n_{f} represents the frame number, and

$${n}_{s , f}^{μ}$$

is the slot number within a frame. In this case, the UE could (start to) measure the (first or most recent or latest or earliest available in time) CSI-RS(s) or CSI-RS resource(s) enabled by the LTM CSC MAC CE for measurement/CSI acquisition on the target cell (at least or no later than or no earlier than) X symbol(s) or slot(s) or ms after (or from) a reference or anchor time, wherein the UE could determine or identify the reference/anchor time according to or based on: (1) fixed value(s)/rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s).
In one example, the reference/anchor time could correspond to the first (or last) slot or symbol of reception of the LTM CSC MAC CE and/or when the LTM CSC MAC CE is received or detected.
In another example, the reference/anchor time could correspond to the first (or last) slot or symbol when the LTM CSC MA CE is transmitted or sent or that carries or conveys the LTM CSC MAC CE.
In another example, the reference/anchor time could correspond to the first (or last) slot or symbol when the LTM CSC MAC CE has become applicable—the LTM CSC MAC CE application time as specified/defined herein in the present disclosure.
In another example, the reference/anchor time could correspond to the first (or last) slot or symbol when the TCI state(s) indicated in/by the LTM CSC MAC CE has become applicable—LTM beam application time as specified/defined herein in the present disclosure.
In another example, the reference/anchor time could correspond to the first (or last) slot or symbol when the Msg1 random access preamble (e.g., for the RACH-based LTM operation(s)) is transmitted or sent or that carries or conveys the Msg1 random access preamble (e.g., for the RACH-based LTM operation(s)).
In another example, the reference/anchor time could correspond to the first (or last) slot or symbol of reception of the Msg2 RAR (e.g., for the RACH-based LTM operation(s)) or when the Msg2 RAR (e.g., for the RACH-based LTM operation(s)) is received or detected.
In another example, the reference/anchor time could correspond to the first (or last) slot or symbol when the Msg3 (e.g., for the RACH-based LTM operation(s)) is transmitted or sent or that carries or conveys the Msg3 (e.g., for the RACH-based LTM operation(s)).

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by csiMeasOffset, e.g., in LTM-Config, LTM-Candidate, LTM-CSI-ReportConfig, LTM-CSI-ResourceConfig, LTM-TCI-Info and/or etc. The value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. When the field or the higher layer parameter csiMeasOffset is absent, the UE could apply the value 0 of X.
   For another example, the LTM CSC MAC CE could provide, contain, include or comprise one or more indicators to indicate the value(s) of X, e.g., via one or more new fields in the LTM CSC MAC CE. In one example, the value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. In another example, the value x of X could correspond to x slot(s)/symbol(s)/ms. Whether the one or more indicators could be present or not (absent) in the LTM CSC MAC CE could be higher layer configured. For instance, when/if a higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the LTM CSC MAC CE; otherwise, i.e., when/if the higher layer parameter csiMeasOffsetPresentInCSC is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the LTM CSC MAC CE. When the one or more indicators mentioned herein are absent from/in the LTM CSC MAC CE, the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

The UE could identify or determine whether or not the procedure(s) mentioned herein for measuring the CSI-RS resource(s) for CSI acquisition during the LTM cell switch for the target cell according to or following those specified herein in the present disclosure is enabled/disabled according to or based on:
fixed rule(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, a higher layer parameter csiMeasDuringLtmCellSwitch could be provided in higher layer parameter(s)/signaling(s) e.g., LTM-Config, LTM-Candidate, LTM-CSI-ReportConfig, LTM-CSI-ResourceConfig, LTM-TCI-Info and/or etc. that provide or configure necessary information and/or setting(s) for the LTM operation(s). For this design example, when/if the higher layer parameter csiMeasDuringLtmCellSwitch is provided, configured or present and/or is set to ‘enabled’, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when/if the higher layer parameter csiMeasDuringLtmCellSwitch is not provided, configured or present or is absent, and/or when/if the higher layer parameter csiMeasDuringLtmCellSwitch is provided, configured or present but is set to ‘disabled’, the UE could expect or assume that the procedure(s) mentioned herein for measuring the CSI-RS resource(s) for CSI acquisition during the LTM cell switch for the target cell according to or following those specified herein in the present disclosure is disabled.
   For another example, the LTM CSC MAC CE could provide, contain, include or comprise one or more indicators to indicate whether or not the procedure(s) mentioned herein for measuring the CSI-RS resource(s) for CSI acquisition during the LTM cell switch for the target cell according to or following those specified herein in the present disclosure is enabled/disabled. For instance, the LTM CSC MAC CE could comprise a field (e.g., a new or a repurposed ‘R’ field) providing or indicating a one-bit indicator—e.g., the A/D field mentioned herein. In this case, when/if the one-bit indicator is set to ‘1’ (or ‘0’) and/or the A/D field is set to ‘1’, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when/if the one-bit indicator is set to ‘0’ (or ‘1’) and/or the A/D field is set to ‘0’, the UE could expect or assume that the procedure(s) mentioned herein for measuring the CSI-RS resource(s) for CSI acquisition during the LTM cell switch for the target cell according to or following those specified herein in the present disclosure is disabled.
   For another example, when/if the LTM CSC MAC CE provides, indicates, contains or includes at least a (valid) CSI-RS resource set ID, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when the LTM CSC MAC CE does not provide, indicate, contain or include any (valid) CSI-RS resource set ID(s)—or (valid) CSI-RS resource ID(s) is not present or is absent in the LTM CSC MAC CE, the UE could expect or assume that the procedure(s) mentioned herein for measuring the CSI-RS resource(s) for CSI acquisition during the LTM cell switch for the target cell according to or following those specified herein in the present disclosure is disabled.
   For another example, if the LTM CSC MAC CE could provide, contain, include or comprise one or more indicators to indicate the value(s) of X according to or following those specified herein in the present disclosure, and when the value(s) of X is non-zero and/or valid, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when the value(s) of X is zero or invalid, or the LTM CSC MAC CE does not provide or indicate or comprise any value(s) of X—or the value(s) of X is not present or is absent in the LTM CSC MAC CE, the UE could expect or assume that the procedure(s) mentioned herein for measuring the CSI-RS resource(s) for CSI acquisition during the LTM cell switch for the target cell according to or following those specified herein in the present disclosure is disabled.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

Furthermore, during the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, and for RACH-based LTM operation(s), the UE could receive a Msg2 RAR (UL grant RAR) providing, indicating, containing or including one or more fields each comprising a CSI-RS resource set ID and an A/D field. In particular, the A/D field could indicate whether or not measuring the CSI-RS resources(s) provided/configured in/by the CSI-RS resource set(s) indicated therein for CSI acquisition on the corresponding target cell is enabled—i.e., the field is set to ‘1’ to indicate enabling/enabled, otherwise (i.e., the field is set to ‘0’) it indicates disabling/disabled. Each of the field(s) that comprises a CSI-RS resource set ID could contain an index of NZP-CSI-RS-ResourceSet, containing NZP CSI-RS resources (with the corresponding resourceType set to ‘periodic’ or ‘semi-persistent’ or ‘aperiodic’ and reportConfigType set to ‘periodic’, ‘semiPersistentOnPUCCH’, ‘semiPersistentOnPUSCH’ or ‘aperiodic’), indicating the NZP CSI-RS resource set, which may need to be enabled or disabled for measurement/CSI acquisition (e.g., based on or according to the value of the A/D field) for/on the target cell, and the length of each of the field(s) could be of 6 bits. In this case, the UE could receive a LTM CSC MAC CE enabling (e.g., by setting the A/D field indicated therein to ‘1’) measuring CSI-RS resources(s) provided/configured in/by one or more first CSI-RS resource sets indicated in the LTM CSC MAC CE for CSI acquisition on the corresponding target cell, and/or receive a Msg2 RAR (e.g., an UL grant RAR) disabling (e.g., by setting the A/D field indicated therein to ‘0’) measuring CSI-RS resource(s) provided/configured in/by one or more second CSI-RS resource sets indicated in the Msg2 RAR for CSI acquisition on the corresponding target cell, wherein the one or more second CSI-RS resource sets could be a subset of the one or more first CSI-RS resource sets.

In one example, during the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, the UE could receive a LTM CSC MAC CE providing, indicating, containing or including one or more fields comprising one or more resource set (e.g., a NZP CSI-RS resource set or a SSB resource set) indexes/IDs and/or one or more reportConfigId's (e.g., each associated to a CSI reporting setting/CSI report configuration provided by CSI-ReportConfig and/or LTM-CSI-ReportConfig) associated/specific/corresponding/linked to the target cell.
the UE could first identify or determine one or more CSI reporting settings/CSI report configurations according to or based on the one or more (indicated) reportConfigId's. Each of the identified or determined one or more CSI reporting settings/CSI report configurations associated to a reportConfigId could be associated or linked or corresponding to a resource set (e.g., a NZP CSI-RS resource set or a SSB resource set) index/ID;
the UE could identify or determine one or more CSI resource settings/CSI resource configurations—each provided by CSI-ResourceConfig or LTM-CSI-ResourceConfig—associated/specific/linked/corresponding to the identified or determined one or more CSI reporting settings/CSI report configurations, wherein the identified or determined one or more CSI resource settings/CSI resource configurations could be associated/specific/corresponding/linked to the corresponding target cell (the LTM CSC MAC CE could also provide, indicate, contain or include one or more fields comprising one or more CSI-ResourceConfigId's (e.g., each associated to a CSI resource setting/CSI resource configuration provided by CSI-ReportConfig and/or LTM-CSI-ReportConfig) associated/specific/corresponding/linked to the corresponding target cell);
   The UE could identify or determine a list of RS resource sets (e.g., a list of NZP CSI-RS resource set(s) or SSB resource set(s)) each comprising one or more RS resources including NZP CSI-RS resource(s) or SSB(s)—from or according to each of the identified or determined one or more CSI resource settings/CSI resource configurations;
   The identified or determined list or one or more RS resource sets in the list or one or more RS resources in one or more RS resource sets in the list could be associated/specific/corresponding/linked to the corresponding target cell;
   the LTM CSC MAC CE could also provide, indicate, contain or include one or more fields each comprising a list of RS resource sets;
for an identified or determined CSI reporting setting/CSI report configuration, the UE would identify or determine a resource set ID/index associated/specific/linked/corresponding to the CSI reporting setting/CSI reporting configuration according to or following those specified herein in the present disclosure, and a list of RS resource sets associated/specific/linked/corresponding to the CSI reporting setting/CSI reporting configuration according to or following those specified herein in the present disclosure. In this case, the resource set ID/index could point to an entry—hence, a measurement resource set—from/in the list of RS resource sets, wherein the measurement resource set could be or could correspond to a NZP CSI-RS resource set or a SSB resource set; the UE could identify or determine one or more measurement resource sets mentioned herein based on one or more resource set IDs/indexes and one or more corresponding lists of RS resource sets according to or following those specified herein in the present disclosure.

In this case, the UE could (start to) measure the (first or most recent or latest or earliest available in time) RS resource(s) in the measurement resource set(s) mentioned herein (at least or no later than or no earlier than) X symbol(s) or slot(s) or ms after (or from) a reference or anchor time, wherein the UE could determine or identify the reference/anchor time according to or based on: (1) fixed value(s)/rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).
In one example, the reference/anchor time could correspond to the first (or last) slot or symbol of reception of the LTM CSC MAC CE and/or when the LTM CSC MAC CE is received or detected.
In another example, the reference/anchor time could correspond to the first (or last) slot or symbol when the LTM CSC MA CE is transmitted or sent or that carries or conveys the LTM CSC MAC CE.
In another example, the reference/anchor time could correspond to the first (or last) slot or symbol when the LTM CSC MAC CE has become applicable—the LTM CSC MAC CE application time as specified/defined herein in the present disclosure.
In another example, the reference/anchor time could correspond to the first (or last) slot or symbol when the TCI state(s) indicated in/by the LTM CSC MAC CE has become applicable—LTM beam application time as specified/defined herein in the present disclosure.
In another example, the reference/anchor time could correspond to the first (or last) slot or symbol when the Msg1 random access preamble (e.g., for the RACH-based LTM operation(s)) is transmitted or sent or that carries or conveys the Msg1 random access preamble (e.g., for the RACH-based LTM operation(s)).
In another example, the reference/anchor time could correspond to the first (or last) slot or symbol of reception of the Msg2 RAR (e.g., for the RACH-based LTM operation(s)) or when the Msg2 RAR (e.g., for the RACH-based LTM operation(s)) is received or detected.
In another example, the reference/anchor time could correspond to the first (or last) slot or symbol when the Msg3 (e.g., for the RACH-based LTM operation(s)) is transmitted or sent or that carries or conveys the Msg3 (e.g., for the RACH-based LTM operation(s)).

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by csiMeasOffset, e.g., in LTM-Config, LTM-Candidate, LTM-CSI-ReportConfig, LTM-CSI-ResourceConfig, LTM-TCI-Info and/or etc. The value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. When the field or the higher layer parameter csiMeasOffset is absent, the UE could apply the value 0 of X.
   For another example, the LTM CSC MAC CE could provide, contain, include or comprise one or more indicators to indicate the value(s) of X, e.g., via one or more new fields in the LTM CSC MAC CE. In one example, the value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. In another example, the value x of X could correspond to x slot(s)/symbol(s)/ms. Whether the one or more indicators could be present or not (absent) in the LTM CSC MAC CE could be higher layer configured. For instance, when/if a higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the LTM CSC MAC CE; otherwise, i.e., when/if the higher layer parameter csiMeasOffsetPresentInCSC is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the LTM CSC MAC CE. When the one or more indicators mentioned herein are absent from/in the LTM CSC MAC CE, the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

The UE could identify or determine whether or not the procedure(s) mentioned herein for measuring the CSI-RS resource(s) for CSI acquisition during the LTM cell switch for the target cell according to or following those specified herein in the present disclosure is enabled/disabled according to or based on:
fixed rule(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
For example, a higher layer parameter csiMeasDuringLtmCellSwitch could be provided in higher layer parameter(s)/signaling(s) e.g., LTM-Config, LTM-Candidate, LTM-CSI-ReportConfig, LTM-CSI-ResourceConfig, LTM-TCI-Info and/or etc. that provide or configure necessary information and/or setting(s) for the LTM operation(s). For this design example, when/if the higher layer parameter csiMeasDuringLtmCellSwitch is provided, configured or present and/or is set to ‘enabled’, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when/if the higher layer parameter csiMeasDuringLtmCellSwitch is not provided, configured or present or is absent, and/or when/if the higher layer parameter csiMeasDuringLtmCellSwitch is provided, configured or present but is set to ‘disabled’, the UE could expect or assume that the procedure(s) mentioned herein for measuring the CSI-RS resource(s) for CSI acquisition during the LTM cell switch for the target cell according to or following those specified herein in the present disclosure is disabled.
For another example, the LTM CSC MAC CE could provide, contain, include or comprise one or more indicators to indicate whether or not the procedure(s) mentioned herein for measuring the CSI-RS resource(s) for CSI acquisition during the LTM cell switch for the target cell according to or following those specified herein in the present disclosure is enabled/disabled. For instance, the LTM CSC MAC CE could comprise a field (e.g., a new or a repurposed ‘R’ field) providing or indicating a one-bit indicator. In this case, when/if the one-bit indicator is set to ‘1’ (or ‘0’), the UE (e.g., the UE 116) could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when/if the one-bit indicator is set to ‘0’ (or ‘1’), the UE could expect or assume that the procedure(s) mentioned herein for measuring the CSI-RS resource(s) for CSI acquisition during the LTM cell switch for the target cell according to or following those specified herein in the present disclosure is disabled.
For another example, when/if the LTM CSC MAC CE provides, indicates, contains or includes at least a (valid) resource set index/ID and/or a (valid) reportConfigId and/or a (valid) CSI-ResourceConfigId and/or a (valid) list of RS resource sets, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when the LTM CSC MAC CE does not provide, indicate, contain or include any (valid) resource set index(es)/ID(s) and/or reportConfigId(s) and/or CSI-ResourceConfigId(s) and/or list(s) of RS resource sets—or (valid) resource set index(es)/ID(s) and/or reportConfigId(s) and/or CSI-ResourceConfigId(s) and/or list(s) of RS resource sets is not present or is absent in the LTM CSC MAC CE, the UE could expect or assume that the procedure(s) mentioned herein for measuring the CSI-RS resource(s) for CSI acquisition during the LTM cell switch for the target cell according to or following those specified herein in the present disclosure is disabled.
For another example, if the LTM CSC MAC CE could provide, contain, include or comprise one or more indicators to indicate the value(s) of X according to or following those specified herein in the present disclosure, and when the value(s) of X is non-zero and/or valid, the UE could expect or assume that the procedure(s) mentioned herein for measuring the CSI-RS resource(s) for CSI acquisition during the LTM cell switch for the target cell according to or following those specified herein in the present disclosure is enabled. Otherwise, e.g., when the value(s) of X is zero or invalid, or the LTM CSC MAC CE does not provide or indicate or comprise any value(s) of X—or the value(s) of X is not present or is absent in the LTM CSC MAC CE, the UE could expect or assume that the procedure(s) mentioned herein for measuring the CSI-RS resource(s) for CSI acquisition during the LTM cell switch for the target cell according to or following those specified herein in the present disclosure is disabled.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

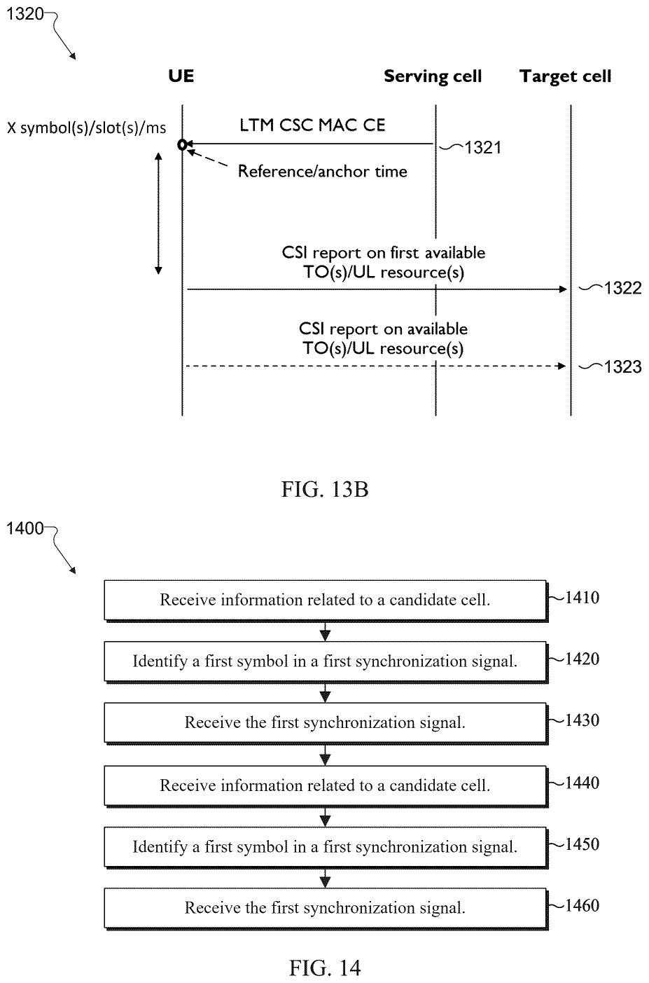

FIGS. 13A and 13B illustrate signal flows of an example procedure 1310 and 1320 for LTM cell switch according to embodiments of the present disclosure. For example, procedure 1310 and 1320 can be performed by the UE 116, the gNB 103 and/or the network 130, and the gNB 102 and/or network 130 in the wireless network 100 of FIG. 1. This example is for illustration only and other embodiments can be used without departing from the scope of the present disclosure.

The procedure 1310 begins in 1311, a serving cell transmits a LTM CSC MAC CE to a UE. In 1312, the UE identifies/determines a reference/anchor time. In 1313, the UE transmits a CSI report on first available TO(s)/UL resource(s) to a target cell. In 1314, the UE may transmit a CSI report on available TO(s)/UL resource(s) to the target cell.

The procedure 1320 begins in in 1321, a serving cell transmits a LTM CSC MAC CE to a UE, and the UE identifies/determines a reference/anchor time. In 1322, the UE transmits a CSI report on first available TO(s)/UL resource(s) to a target cell. In 1323, the UE may transmit a CSI report on available TO(s)/UL resource(s) to the target cell.

In one example, during the LTM cell switch as specified/defined herein in the present disclosure, i.e., after the UE has received and applied a LTM CSC MAC CE for a target cell but before the UE is actually handed over to the corresponding target cell—e.g., before the first UL transmission(s) towards the target cell, the UE could transmit or send one or more (periodic, semi-persistent or aperiodic) CSI reports for the target cell over/on one or more transmission occasions (TOs)/UL resource(s) of an UL channel associated or specific or corresponding or linked to the target cell starting from a (first or most recent or latest or earliest available in time) transmission occasion/UL resource of the UL channel (at least or no later than or no earlier than) X symbol(s) or slot(s) or ms after (or from) a reference or anchor time, wherein the UE could determine or identify the reference/anchor time according to or based on: (1) fixed value(s)/rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s).
In one example, the reference/anchor time could correspond to the first (or last) slot or symbol of reception of the LTM CSC MAC CE and/or when the LTM CSC MAC CE is received or detected.
In another example, the reference/anchor time could correspond to the first (or last) slot or symbol when the LTM CSC MA CE is transmitted or sent or that carries or conveys the LTM CSC MAC CE.
In another example, the reference/anchor time could correspond to the first (or last) slot or symbol when the LTM CSC MAC CE has become applicable—the LTM CSC MAC CE application time as specified/defined herein in the present disclosure.
In another example, the reference/anchor time could correspond to the first (or last) slot or symbol when the TCI state(s) indicated in/by the LTM CSC MAC CE has become applicable—LTM beam application time as specified/defined herein in the present disclosure.
In another example, the reference/anchor time could correspond to the first (or last) slot or symbol when the Msg1 random access preamble (e.g., for the RACH-based LTM operation(s)) is transmitted or sent or that carries or conveys the Msg1 random access preamble (e.g., for the RACH-based LTM operation(s)).
In another example, the reference/anchor time could correspond to the first (or last) slot or symbol of reception of the Msg2 RAR (e.g., for the RACH-based LTM operation(s)) or when the Msg2 RAR (e.g., for the RACH-based LTM operation(s)) is received or detected.
In another example, the reference/anchor time could correspond to the first (or last) slot or symbol when the Msg3 (e.g., for the RACH-based LTM operation(s)) is transmitted or sent or that carries or conveys the Msg3 (e.g., for the RACH-based LTM operation(s)).
In another example, the reference/anchor time could correspond to the CSI reference resource associated with CSI resource setting(s)/CSI resource configuration(s) associated/specific/corresponding/linked to the target cell according to or following those specified herein in the present disclosure.

The UE could identify or determine the value(s) of X according to or based on:
fixed value(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, the value(s) of X could be provided by a higher layer parameter denoted by csiMeasOffset, e.g., in LTM-Config, LTM-Candidate, LTM-CSI-ReportConfig, LTM-CSI-ResourceConfig, LTM-TCI-Info and/or etc. The value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. When the field or the higher layer parameter csiMeasOffset is absent, the UE could apply the value 0 of X.
   For another example, the LTM CSC MAC CE could provide, contain, include or comprise one or more indicators to indicate the value(s) of X, e.g., via one or more new fields in the LTM CSC MAC CE. In one example, the value 0 of X could correspond to 0 slot/symbol/ms, value 1 of X could correspond to 1 slot/symbol/ms, value 2 of X could correspond to 2 slots/symbols/ms, value 3 of X could correspond to 3 slots/symbols/ms, value 4 of X could correspond to 4 slots/symbols/ms, value 5 of X could correspond to 16 slots/symbols/ms, value 6 of X could correspond to 24 slots/symbols/ms. In another example, the value x of X could correspond to x slot(s)/symbol(s)/ms. Whether the one or more indicators could be present or not (absent) in the LTM CSC MAC CE could be higher layer configured. For instance, when/if a higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., and/or set to ‘enabled’, the UE could expect/assume that the one or more indicators to indicate the value(s) of X as specified/defined herein is present in the LTM CSC MAC CE; otherwise, i.e., when/if the higher layer parameter csiMeasOffsetPresentInCSC is not provided or configured or present or is absent, e.g., in LTM-Config, LTM-Candidate, LTM-CSI-ReportConfig, LTM-CSI-ResourceConfig, LTM-TCI-Info and/or etc., and/or when/if the higher layer parameter csiMeasOffsetPresentInCSC is provided or configured or present, e.g., in LTM-Config, LTM-Candidate, LTM-CSI-ReportConfig, LTM-CSI-ResourceConfig, LTM-TCI-Info and/or etc., but set to ‘disabled’, the UE could expect/assume that the one or more indicators that indicates the value(s) of X as specified/defined herein is not present or is absent in the LTM CSC MAC CE. When the one or more indicators mentioned herein are absent from/in the LTM CSC MAC CE, the UE could apply the value 0 of X.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

In this case, the UE could determine or identify the one or more transmission occasions/UL resources of the UL channel from or according to or based on or more of:
Transmission occasions(s)/UL resource(s) of the first UL transmission(s)—that includes the RRC LTM cell switch complete message—comprising, e.g., one or more DG PUSCH resources and/or one or more CG PUSCH resources (e.g., Type1 CG PUSCH resources)
Msg3 or the PUSCH resource(s) scheduled by the RAR UL grant (Msg2) for the RACH-based LTM operation(s)
One or more CG PUSCH resources, e.g., Type1 CG PUSCH resources, provided or configured—e.g., via/in/by higher layer parameter(s) in LTM-Config, LTM-Candidate, LTM-CSI-ReportConfig, LTM-CSI-ResourceConfig, LTM-TCI-Info and/or etc.—for the target cell to transmit or send the CSI report(s)
One or more DG PUSCH resources, wherein the DG PUSCH resource(s) could be provided, assigned, indicated, allocated or assigned by one or more indicators of one or more fields (e.g., new field(s) and/or repurposed ‘R’ field(s)) in the LTM CSC MAC CE
   according to or based on: (1) fixed rule(s)/value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). One conceptual example characterizing the described procedure(s) and signaling flow(s) herein are provided in FIG. 13. The UE could identify or determine whether or not the procedure(s) mentioned herein for CSI reporting during the LTM cell switch for the target cell according to or following those specified herein in the present disclosure is enabled/disabled according to or based on:
fixed rule(s) in system specification(s) and/or per RRC (re-)configuration;
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling.
   For example, a higher layer parameter csiReportDuringLtmCellSwitch could be provided in higher layer parameter(s)/signaling(s) e.g., LTM-Config, LTM-Candidate, LTM-CSI-ReportConfig, LTM-CSI-ResourceConfig, LTM-TCI-Info and/or etc. that provide or configure necessary information and/or setting(s) for the LTM operation(s). For this design example, when/if the higher layer parameter csiReportDuringLtmCellSwitch is provided, configured or present and/or is set to ‘enabled’, the UE could expect or assume that the procedure(s) mentioned herein for CSI reporting during the LTM cell switch for the target cell according to or following those specified herein in the present disclosure is enabled. Otherwise, e.g., when/if the higher layer parameter csiReportDuringLtmCellSwitch is not provided, configured or present or is absent, and/or when/if the higher layer parameter csiReportDuringLtmCellSwitch is provided, configured or present but is set to ‘disabled’, the UE could expect or assume that the procedure(s) mentioned herein for CSI reporting during the LTM cell switch for the target cell according to or following those specified herein in the present disclosure is disabled.
   For another example, the LTM CSC MAC CE could provide, contain, include or comprise one or more indicators to indicate whether or not the procedure(s) mentioned herein for CSI reporting during the LTM cell switch for the target cell according to or following those specified herein in the present disclosure is enabled/disabled. For instance, the LTM CSC MAC CE could comprise a field (e.g., a new or a repurposed ‘R’ field) providing or indicating a one-bit indicator. In this case, when/if the one-bit indicator is set to ‘1’ (or ‘0’), the UE could expect or assume that the procedure(s) mentioned herein for CSI reporting during the LTM cell switch for the target cell according to or following those specified herein in the present disclosure is enabled. Otherwise, e.g., when/if the one-bit indicator is set to ‘0’ (or ‘1’), the UE could expect or assume that the procedure(s) mentioned herein for CSI reporting during the LTM cell switch for the target cell according to or following those specified herein in the present disclosure is disabled.
   For another example, if the LTM CSC MAC CE could provide, contain, include or comprise one or more indicators to indicate the value(s) of X according to or following those specified herein in the present disclosure, and when the value(s) of X is non-zero and/or valid, the UE could expect or assume that the procedure(s) mentioned herein for CSI reporting during the LTM cell switch for the target cell according to or following those specified herein in the present disclosure is enabled. Otherwise, e.g., when the value(s) of X is zero or invalid, or the LTM CSC MAC CE does not provide or indicate or comprise any value(s) of X—or the value(s) of X is not present or is absent in the LTM CSC MAC CE, the UE could expect or assume that the procedure(s) mentioned herein for CSI reporting during the LTM cell switch for the target cell according to or following those specified herein in the present disclosure is disabled.
UE's autonomous determination or selection, which could be further sent to the network, e.g., in similar/same form(s) to/as the one or more indicators as described/specified herein, via various UL channels/signals e.g. via/in part of beam/CSI report(s) and/or UE's capability signaling(s).

The design examples/procedures specified or described throughout the present disclosure for CSI acquisition (including CSI-RS(s) measurement(s) and/or CSI reporting) based on or according to LTM CSC MAC CE could be equally applied or extended to CSI acquisition (including CSI-RS(s) measurement(s) and/or CSI reporting) based on or according to Msg2 RAR (e.g., for RACH-based LTM operation(s)). Furthermore, throughout the present disclosure, a CSI-RS resource set or a SSB resource set could be referred to as a CSI resource set, which could be provided or configured in higher layer parameter(s)/signaling(s) LTM-Config, LTM-Candidate, LTM-CSI-ReportConfig, LTM-CSI-ResourceConfig, LTM-TCI-Info and/or etc. and associated, specific, corresponding or linked to a candidate cell/candidate cell ID.

Throughout the present disclosure, a candidate cell/candidate cell ID from/in the list/set/pool of configured candidate cells/candidate cell IDs could be configured with higher layer parameter EarlyUlSyncConfig. Furthermore, a candidate cell/candidate cell ID in a/the subset of candidate cell(s)/candidate cell ID(s) for CSI acquisition in LTM operation(s) as specified/defined herein in the present disclosure could be configured with higher layer parameter EarlyUlSyncConfig.

FIG. 14 illustrates an example method 1400 performed by a UE in a wireless communication system according to embodiments of the present disclosure. The method 1400 of FIG. 14 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1400 is for illustration only and other embodiments can be used without departing from the scope of the present disclosure.

The method 1400 begins with the UE receiving information related to a candidate cell (1410). The UE then receives a CSC MAC CE indicating the candidate cell (1420). The UE then determines, based on the information, whether CSI acquisition is enabled for the candidate cell (1430).

The UE then, when CSI acquisition is enabled for the candidate cell, measures one or more RS resources configured for the candidate cell (1440). In various embodiments, the information includes a reporting setting configured with reportQuantity set to ‘cri-RI-PMI-CQI’ for the candidate cell. The UE may also determine, a resource setting associated with the reporting setting, where the resource setting comprises a resource set for CSI acquisition, and determine, from the resource set, the one or more RS resources. In various embodiments, the UE measures the one or more RS resources no earlier than a time offset after reception of the CSC MAC CE, where the time offset is configured by a higher layer.

The UE then determines, based on the measurement, a CSI report for the candidate cell (1450). The UE then transmits the CSI report in an UL resource (1460). In various embodiments, the UE transmits the CSI report no earlier than a time offset after reception of the CSC MA CE, where the time offset is configured by a higher layer. In various embodiments, the UL resource is a PUSCH resource corresponding to a DG or a CG. In various embodiments, for RACH based cell switch, the UL resource is a PUSCH resource scheduled by a RAR UL grant or a Msg2.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive information related to a candidate cell, and
receive a cell switching command (CSC) medium access control (MAC) control element (CE) indicating the candidate cell; and
a processor operably coupled with the transceiver, the processor configured to:
determine, based on the information, whether channel state information (CSI) acquisition is enabled for the candidate cell;
when CSI acquisition is enabled for the candidate cell, measure one or more reference signal (RS) resources configured for the candidate cell; and
determine, based on the measurement, a CSI report for the candidate cell,
wherein the transceiver is further configured to transmit the CSI report in an uplink (UL) resource.

2. The UE of claim 1, wherein the information includes a reporting setting configured with reportQuantity set to ‘cri-RI-PMI-CQI’ for the candidate cell.

3. The UE of claim 2, wherein the processor is further configured to:
determine, a resource setting associated with the reporting setting, wherein the resource setting comprises a resource set for CSI acquisition, and
determine, from the resource set, the one or more RS resources.

4. The UE of claim 1, wherein:
the processor is further configured to measure the one or more RS resources no earlier than a time offset after reception of the CSC MAC CE, and
the time offset is configured by higher layer.

5. The UE of claim 1, wherein:
the transceiver is further configured to transmit the CSI report no earlier than a time offset after reception of the CSC MA CE, and
the time offset is configured by higher layer.

6. The UE of claim 1, wherein the UL resource is a physical uplink shared channel (PUSCH) resource corresponding to a dynamic grant (DG) or a configured grant (CG).

7. The UE of claim 1, wherein for random access channel (RACH) based cell switch, the UL resource is a physical uplink shared channel (PUSCH) resource scheduled by a random access response (RAR) UL grant or a message 2 (Msg2).

8. A base station (BS), comprising:
a processor; and
a transceiver operably coupled with the processor, the transceiver configured to:
transmit information related to a candidate cell, wherein the information indicates whether channel state information (CSI) acquisition is enabled for the candidate cell; and
transmit a cell switching command (CSC) medium access control (MAC) control element (CE) indicating the candidate cell; and
receive the CSI report in an uplink (UL) resource,
wherein CSI acquisition is enabled for the candidate cell, and
wherein the CSI report is based on one or more reference signal (RS) resources configured for the candidate cell.

9. The BS of claim 8, wherein the information includes a reporting setting configured with reportQuantity set to ‘cri-RI-PMI-CQI’ for the candidate cell.

10. The BS of claim 9, wherein:
a resource setting is associated with the reporting setting,
the resource setting comprises a resource set for CSI acquisition, and
the one or more RS resources are from the resource set.

11. The BS of claim 8, wherein:
the one or more RS resources are those no earlier than a time offset after transmission of the CSC MAC CE, and
the time offset is configured by higher layer.

12. The BS of claim 8, wherein:
the transceiver is further configured to receive the CSI report no earlier than a time offset after reception of the CSC MA CE, and
the time offset is configured by higher layer.

13. The BS of claim 8, wherein the UL resource is a physical uplink shared channel (PUSCH) resource corresponding to a dynamic grant (DG) or a configured grant (CG).

14. The BS of claim 8, wherein for random access channel (RACH) based cell switch, the UL resource is a physical uplink shared channel (PUSCH) resource scheduled by a random access response (RAR) UL grant or a message 2 (Msg2).

15. A method performed by a user equipment (UE), the method comprising:
receiving information related to a candidate cell;
receiving a cell switching command (CSC) medium access control (MAC) control element (CE) indicating the candidate cell;
determining, based on the information, whether channel state information (CSI) acquisition is enabled for the candidate cell;
when CSI acquisition is enabled for the candidate cell, measuring one or more reference signal (RS) resources configured for the candidate cell;
determining, based on the measurement, a CSI report for the candidate cell; and
transmitting the CSI report in an uplink (UL) resource.

16. The method of claim 15, wherein the information includes a reporting setting configured with reportQuantity set to ‘cri-RI-PMI-CQI’ for the candidate cell.

17. The method of claim 16, further comprising:
determining, a resource setting associated with the reporting setting, wherein the resource setting comprises a resource set for CSI acquisition, and
determining, from the resource set, the one or more RS resources.

18. The method of claim 15, wherein:
measuring the one or more RS resources further comprises measuring the one or more RS resources no earlier than a time offset after reception of the CSC MAC CE, and
the time offset is configured by higher layer.

19. The method of claim 15, wherein:
transmitting the CSI report further comprises transmitting the CSI report no earlier than a time offset after reception of the CSC MA CE, and
the time offset is configured by higher layer.

20. The method of claim 15, wherein the UL resource is a physical uplink shared channel (PUSCH) resource corresponding to a dynamic grant (DG) or a configured grant (CG).
